(19) United States
(12) Patent Application Publication
(10) Pub. No.: US 2020/0382496 A9
(43) Pub. Date: Dec. 3, 2020

(54) Domain-based Isolated Mailboxes

(71) Applicant: VIRUTHAGIRI THIRUMAVALAVAN, ARIYALUR (IN)

(72) Inventor: VIRUTHAGIRI THIRUMAVALAVAN, ARIYALUR (IN)

(21) Appl. No.: 16/544,941

(22) Filed: Aug. 20, 2019

Related U.S. Application Data
(60) Provisional application No. 62/720,681, filed on Aug. 21, 2018.
(60) Provisional application No. 62/805,862, filed on Feb. 14, 2019.

(51) Int. Cl. H04L 29/06; H04L 12/58

(52) U.S. Cl. CPC H04L 63/0869; H04L 63/0414; H04L 51/046; H04L 51/22

(57) ABSTRACT

Systems and methods are provided for reducing email spam without wasting network bandwidth. The system contains two groups of boxes. Domboxes and Mailboxes. (a) Domboxes should be used only for non-conversational mails. E.g. website/app mails. Each Dombox has a disposable email address and associated with a primary domain. The primary domain can authorize additional domains in the DNS. We primarily rely on the SPF record for validating Dombox mails. (b) Mailboxes are designed to accept only conversational mails. Conversational Mails can be termed as Human-to-Human, Mailbox-to-Mailbox or MX-to-MX mails. We pull the MX record from the Envelope Domain and verify whether it's really originating from one of the MX servers. Spammer is a Human. Since we accept only MX record verified mails, spammers need registered domains to send spam. Additional checks can be performed with the help of Domain registration date, Spam Filters, Challenge/Response etc.

### CROSS-REFERENCE TO RELATED APPLICATIONS

This application claims priority to U.S. Provisional Patent Application Ser. No. 62/720,681, titled “Domain-based Isolated Mailbox” filed on Aug. 21, 2018 and to U.S. Provisional Patent Application Ser. No. 62/805,862, titled “Domain-based Isolated Mailbox” filed on Feb. 14, 2019, each of which being incorporated herein by reference in their entireties for all purposes.

### TECHNICAL FIELD

The present invention relates generally to electronic mail. More particularly, relates to systems and methods for reducing email spam without wasting network bandwidth.

### BACKGROUND

1. Problem Summary

Email Spam is what's known as the Tragedy of the Commons. Spam email degrades the usefulness of the email system and increases the cost for all users of the Internet while providing a benefit to only a tiny number of individuals. First spam mail was sent in 1978. So it's a 40 year old problem that's not solved yet. 281 Billion Emails are being sent every day. That's around 102 Trillion emails in a year. 60% of them are spam as of 2017. So almost 60 Trillion spam emails are being transmitted every year. More than half of the Internet bandwidth is being wasted on carrying spam emails. Spam also started to play an important role in Politics. e.g. Fake News, Hilary Clinton email leaks etc.

2. Spam Damages

(i) Productivity—No amount of money can give you back the time you lost. When computers get affected by malware emails, it would take many days (even weeks) to clean up the mess. (ii) Scamming—Many innocent people still being a victim of scam emails. e.g. Phishing, Malware, Scamming (Lottery scam, Employment scam, Nigerian scam, Romance scam etc.) (iii) Network bandwidth—More than half of the Internet bandwidth is being wasted on carrying spam emails. (iv) Storage—Money is being wasted on storing spam emails. (v) Spam Laws—Almost 40 countries are wasting their money on enforcing spam laws. (v) Political—Spam started to play an important role in Politics. e.g. Fake News, Hilary Clinton mails. John Podesta account got hacked via a Phishing Mail. (vi) 2009 research says, The estimate for the cost of spam mails in terms of lost productivity, energy costs and increased equipment cost is $130 Billion worldwide every year.

3. How Spammers Get Your Mail Address?

(i) Leaked Databases—Account databases leaked by a hacker in public forums. This is their primary source. (ii) Bad websites that sell your data for money—e.g. After you unsubscribe from their newsletters, your email address becomes useless to them. So they sell your data for some extra money. (iii) Good websites that have been a victim of hackers—e.g. Back in 2013, 150 Adobe accounts were hacked. Even recently Reddit became a Victim of Hackers. (iv) Crawling—By crawling the web for the @ sign. (v) Brute-force/Dictionary/Combinations—By trying multiple combinations of a name. For example, if your name is John Smith, then the spammer might try the following addresses. john@gmail.com, smith@gmail.com, johnsmith@gmail.com, jsmith@gmail.com etc.

4. Why Spam is Still a Tough Nut to Crack?

(i) Internet-wide—For Facebook, spam is a platform-wide problem. If you spam in Facebook, they can ban your account. But when it comes to email, the mail can be transferred from any internet domain and IP. So it's very hard to differentiate spammers from genuine senders. So email spam is an Internet-wide problem. (ii) Design—You don't own google.com. But you can actually send emails from an address like @google.com. This is because the email protocol (SMTP) is designed exactly like our good old postal mail system. aka. snail mail. Mail can be handed over to multiple servers before reaching the recipient. So you can't ban a domain even if the spam emails are coming from that domain. You can ban only the spammer's IP address. (iii) Cost—Sending spam emails literally costs nothing. Computing power is way cheaper now than before. So a spammer can rent a server for a few dollars and send out millions of spam emails. (v) Botnets—Many naive users fall for the scammer's emails, install malicious software found in the email attachment and become part of a bot network (aka.Botnet). Some botnets are capable of sending up to 92 billion mails/day. When a computer becomes part of a botnet, it is called as “Bot”. The “Bot” act like a slave. It waits for the botmaster's command and does that job. It can be anything. Sending spam emails to make money for the botmaster, Spread malicious attachment emails to more users and bring them to be part of the bot network, perform DDoS attacks, bitcoin mining etc. Stopping the spammers in this case is very hard. You need to either remove the malicious software from all the slave computers found in the bot network or find the botmaster and put him/her in jail. Banning IP address is not effective in the Botnet case. Because the botmaster got nothing to lose.

5. Internet Privacy Issues

In our opinion, the current internet lacks privacy. The word “Privacy” may sound like a “Rich” people problem, but the truth is “Normal” people don't quite understand the importance of it. Allow us to explain why current internet lacks privacy with an Example.

5.1. Gravatar

Have you ever heard of a site called Gravatar? It is one of the most popular avatar services on the internet. Gravatar stands for “Globally Recognized Avatar”. Before the inception of Gravatar, you need to upload your avatar manually in every website you sign up. But after Gravatar, it's all “one” avatar. According to their stats, they are serving the avatars over 8.6 billion times a day.

WordPress is a popular open source software. More than 60 million websites you see on the internet powered by that software. This software comes with Gravatar by default. So more than 60 million websites today supports Gravatar. Even many of the major professional websites like StackOverflow, Github etc depends on the Gravatar service for avatars. This is how Gravatar works. You go to gravatar.com, signup with your email address and upload an avatar. This avatar is now linked to your email address. Gravatar uses the email hash to build the avatar URL. This is how your avatar image URL looks like. https://secure.gravatar.com/avatar/{MD5 email hash goes here}. Now if you signup to any third party websites or post a comment with your email address, then the Gravatar will be displayed if the site support it. Although Gravatar solved a major issue, it created two more major issues. Let us explain in simple words.

5.2. Entropy

In a nutshell, Entropy is the “Degree of Unpredictability”. You know what is the most common password on the internet? Its “123456”. Now a hacker's first try would be trying that password. So entropy of that password is “literally zero”. Because the hacker cracked the password in the first attempt. To increase the Entropy, you need to pick a very strong password. If we give you a “Hash” of an email address and ask you to find the real email address, you would be completely lost. Right? e.g. 503A8F0B2D11DA49A27150C868A5EEB5=>?????????@????????. Because there are Gazillion possibilities. The Entropy is very high. The value of this entropy depends on the possible email address combinations. So you have no idea where to start. But if we give you the “Name” too, then it's going to make your job much easier. A man whose name “Donald Trump” definitely not gonna have an email address that looks like “barackobama@gmail.com”. Underline the word “definitely”. Although you still have no idea about the real email address, you are “sure” of something now. So you weakened the entropy.

Let us give you the “Name” and “Email Hash”. Name=>Jeff Bezos, Email Hash=>503A8F0B2D11DA49A27150C868A5EEB5. Lets try the following combinations. jeff@amazon.com=>27D637B6F491BCBEE2C87F13136B675E. bezos@amazon.com=>12B79F144DBF4AA7FEADFD71679A2F91. jbezos@amazon.com=>503A8F0B2D11DA49A27150C868A5EEB5.

There . . . we got the correct email hash in the last attempt. So one thing is clear in the last experiment. You can find “Valid Email Addresses”, if we give you “Name” and “Email Hash”. But If we give you the “Date” too, then you can find the “Active Email Addresses” easily right? For example, If a user post a comment within the past 6 months or 1 year, then most likely the user is an active email user. Email Hash+Name=Valid Email Addresses. Email Hash+Name+Date=Active Email Addresses. So Gravatar Major Issue 1: Email Brute-forcing

5.3. Email Brute-Forcing

In brute force method usually the spammers have to generate multiple email addresses and try sending an email to each generated email address. If the email get accepted then its a valid email address. The success rate of this method will be very low. Let's say the success rate is 5%, that means, 95 out of 100 emails are failing. In such cases popular mail services like Gmail, Outlook etc. usually block and blacklist spammers IP address. In Gravatar case, email brute-force/dictionary/combinations attacks are not going to be an issue. All you have to do now is generate email hash based on the name you see right next to avatar and compare with the avatar email hash. If it matches then you found a valid email address. A spammer can find a massive amount of Gravatar URLs by crawling the web.

5.3.1. Efficiency

Gravatar method is actually efficient too. Let's measure the efficiency. Total number of email users in the world: 3.8 Billion. Although some users may have multiple accounts, let's go with one mail address for each user. So we have 3.8 billion email addresses. An average consumer computer can generate hashes in Millions per second. A high-end gaming computer that has a graphics card can generate hashes in Billions per second. Application-Specific Integrated Circuit (ASIC) is a chip designed for specific applications. For example, an ASIC designed for Bitcoin usually has a huge hash rate. AntMiner S9 can generate up to 14 Trillion Hashes per second. If you try 1000 name combinations for each email address, you would use only 3.8 Trillion hashes for 3.8 Billion email addresses. So you have used roughly a quarter of a 1 second to try all the email addresses available in the world. That's definitely more efficient than sending emails to services like Gmail to validate email addresses.

5.4. Privacy

Gravatar means globally recognised avatar right? If you signup to any website that supports gravatar, then your avatar url going to be the same and that is the problem here. Let us explain clearly. Let's say you have a website example.com and you would like to support Gravatar. There is no API for Gravatar. All you have to do is just take your user's email address and generate email hash. Now just load the following URL for the image. That's it. https://secure.gravatar.com/avatar/{your user's MD5 email hash goes here}. If you can do that, then everyone in the world can do that too right? That is the problem here. In Internet sex sells. There are plenty of people out there who use the same email address for everything from professional use to signing up for porn websites. Even if a porn site doesn't support Gravatar today, there is no guarantee it won't support in the future. To be quite honest, we are less concerned about the porn websites. There are things that require more privacy. e.g. A person from a suppressed country who protest under a pen name now can be traced back. We can even give you more examples. People who hide their sexuality in the real world but open about it on the Internet, People who seek discreet medical help on public forums etc. Government agencies can able to create full fledged scanning tool only for this purpose. The disturbing thing here is that It doesn't matter whether you have signed up for Gravatar or not. Keep in mind, the subject of our discussion here is “Gravatar url”. Not “Gravatar users”. If you have ever used your email address on a third party website for commenting or signing up, chances are your privacy is at risk. This is because, third party websites have no idea whether you had signed up for gravatar or not. So they need to build the avatar url for everyone. If there is an avatar linked to your email address, then that avatar will be displayed. Else a default avatar will be displayed. There may be around 10 million gravatar users. But you can find billions of gravatar urls on the Internet. For what it's worth, We are not blaming Gravatar for this. Because the problem they solved is completely different. We are just pointing out the flaws in their system. [Gravatar privacy issue applicable only for the public pages that can be crawled].

6. Current Solutions

6.1. Spam Filters

Spam filters are only silencing the problem. Not solving it. Here are some of the problems with spam filters.

(i) Keyword-based—Mails that contain words like “Viagra”, “Nigerian King”, “Penis Enlargement” etc most likely gonna get classified as Spam. (ii) False Positives—If a genuine mail contains spam keywords, there is a higher chance that the spam filter might classify that mail as spam. So Collateral Damage (iii) False Negatives—When spam emails are marked as Genuine mails. It's Annoying (iv) Not BulletProof—Experienced spammers know how to bypass the spam filters. If a spammer can figure out the spam algorithm/technique, then the spammer can able to bypass the spam filter by tricking the system.

6.2. Challenge/Response

In the early 2000s, Challenge/Response based spam solutions started to appear. Challenge/Response based spam solutions failed primarily due to backscatter attacks.

6.3. Disposable Email Addresses

Disposable email address is another failed spam solution. Disposable email addresses were first introduced in the late nineties. Spamgourmet, Trashmail, GuerrillaMail etc are some of the examples for Disposable email address services. Early version of disposable email addresses are nothing but random email addresses. But disposable email address design improved over time. Later versions of disposable email addresses, let the user to maintain an “allow list” and “deny list” for each disposable email address. This kind of system puts the burden on the shoulder of the end user. Asking the end users to build a whitelist for each and every disposable email address is a very horrible idea for the following reasons. (a) This kind of system may only work when the user know the other party. (b) It's getting complicated when a user tries to sign up to an unknown website. Because the user has no idea about the list of domains the website will use to send mails. For example, all facebook.com mails are originating from facebookmail.com. (c) It's a very daunting task for most non technical users.

For the aforementioned reasons, there is a need for a new, improved, but backward-compatible email system that addresses the problems found in the current solutions.

### BRIEF DESCRIPTION OF THE DRAWINGS

FIG. 1A illustrates the Normal Email 1.0 Mail System (Prior Art)

FIG. 1B illustrates the end result after completing the Isolation phase.

FIG. 1C illustrates the system before enabling Restricted Mode.

FIG. 1D illustrates the system after enabling Restricted Mode.

FIG. 2A illustrates the box groups.

FIG. 2B illustrates the box types.

FIG. 3A illustrates subdomain-based Dombox email address structure.

FIG. 3B illustrates dollar-based Dombox email address structure.

FIG. 3C illustrates Custom-TLD based Dombox email address structure.

FIG. 4A illustrates the Dombox mail system architecture.

FIG. 4B illustrates the mandatory pass layers for each box type.

FIG. 4C illustrates the incoming mail check layers.

FIG. 5A illustrates mail session structure.

FIG. 5B illustrates a simple SMTP conversation between two mail servers.

FIG. 5C is a table that shows where domains are extracted from.

FIG. 5D illustrates sample DNS record queries.

FIG. 6A illustrates the logical flow of TLS.

FIG. 6B illustrates the logical flow of Encryption layer check.

FIG. 7A illustrates the logical flow of SPF.

FIG. 7B illustrates the logical flow of Authorization layer check.

FIG. 8A illustrates SAD Direct Pass.

FIG. 8B illustrates SAD Indirect Pass.

FIG. 8C illustrates the logical flow of SAD.

FIG. 8D illustrates the logical flow of SAD record selection.

FIG. 8E illustrates the logical flow of Alias—Envelope layer—Fake Pass check.

FIG. 8F illustrates the logical flow of Alias—Envelope layer—Direct Pass check.

FIG. 8G illustrates the logical flow of Alias—Envelope layer—Indirect Pass check.

FIG. 8H illustrates the logical flow of Alias—Message layer—Fake Pass check.

FIG. 8I illustrates the logical flow of Alias—Message layer—Direct Pass check.

FIG. 8J illustrates the logical flow of Alias—Message layer—Indirect Pass check.

FIG. 9A illustrates the logical flow of DKIM.

FIG. 9B illustrates the logical flow of Authentication layer check.

FIG. 10A illustrates the logical flow of DMARC.

FIG. 10B illustrates the logical flow of Alignment layer check.

FIG. 11A illustrates the “Mail Inbox” page layout with mail score.

FIG. 11B illustrates the “View Mail” page layout.

FIG. 11C illustrates the “Mail Score—Encryption Info” page layout.

FIG. 11D illustrates the “Mail Score—Authorization Info” page layout.

FIG. 11E illustrates the “Mail Score—Alias Info” page layout.

FIG. 11F illustrates the “Mail Score—Authentication Info” page layout.

FIG. 11G illustrates the “Mail Score—Alignment Info” page layout.

FIG. 12A illustrates the “register page” page layout where the consumer can sign up for a Dombox mail account.

FIG. 13A illustrates the “All Mailboxes” page layout.

FIG. 13B illustrates the “View Mailbox” page layout.

FIG. 13C illustrates the “All Mailboxes” page layout after adding more mailboxes.

FIG. 14A illustrates the “All Extensions” page layout.

FIG. 14B illustrates the “set domkey” page layout.

FIG. 14C illustrates the “Add Dombox” page layout.

FIG. 14D illustrates the “All Domboxes” page layout.

FIG. 14E illustrates the logical flow of a “Dombox” creation.

FIG. 14F illustrates a “third party registration page” where Dombox email address can be used.

FIG. 15A illustrates the “View Dombox” page layout.

FIG. 15B illustrates the “View Dombox—Contacts” page layout.

FIG. 15C illustrates the “View Dombox—Files” page layout.

FIG. 15D illustrates the “View Dombox—Info” page layout.

FIG. 16A illustrates the Signup and Login buttons on the present Internet.

FIG. 16B illustrates the Teleport and Others buttons on the future Internet.

FIG. 16C illustrates the Popup when Others button clicked.

FIG. 17A illustrates the “Add Domain” page layout.

FIG. 17B illustrates the “Domain Verification” page layout.

FIG. 17C illustrates the “All Domains” page layout.

FIG. 17D illustrates the “Get Good Standing” page layout.

FIG. 18A illustrates the “Add Portal—Select Domain” page layout.

FIG. 18B illustrates the “Add Portal—Portal Info” page layout.

FIG. 18C illustrates the “Add Portal—Site Links” page layout.

FIG. 18D illustrates the “Non-Contracting Portal” page layout.

FIG. 18E illustrates the “Contracting Portal” page layout.

FIG. 18F illustrates the “Absolute End Date” selection.

FIG. 18G illustrates the “Required Data” page layout.

FIG. 18H illustrates the “Add Portal—Data—Yellow and Red Data” selection process.

FIG. 18I illustrates the “All Portals” page layout.

FIG. 18J illustrates the “View Portal” page layout.

FIG. 19A illustrates the “Portal Settings” page layout on a third party website.

FIG. 20A illustrates the “Register” page layout on a 3rd party website where “Teleport” button is displayed.

FIG. 20B illustrates the “Consent” page layout.

FIG. 20C illustrates the alternate version of “Consent” page with red and yellow data.

FIG. 20D illustrates the “Consent-Contract Terms-Relative End Date” page layout.

FIG. 20E illustrates the “Consent-Contract Terms-Absolute End Date” page layout.

FIG. 20F illustrates the “Consent-Contract Terms-Flexible End Type” page layout.

FIG. 20G illustrates the “Consent-Contract Terms-Portal Info” page layout.

FIG. 20H illustrates the “My Account” page layout on a 3rd party website.

FIG. 20I illustrates the “All Domboxes” page layout after buyfruits.in “Combox” creation.

FIG. 20J illustrates the “All Contracts” page layout.

FIG. 21A illustrates the “View Dombox” page for buyfruits.in “Combox”.

FIG. 22A illustrates the “View Contract—Info” page layout.

FIG. 22B illustrates the “View Contract—Green Data” page layout.

FIG. 22C illustrates the “View Contract—Yellow Data” page layout.

FIG. 22D illustrates the “View Contract—Red Data” page layout.

FIG. 22E illustrates the “View Portal—Contracts” page layout.

FIG. 23A illustrates the “Edit Profile—Green Data” page layout.

FIG. 23B illustrates the “Edit Profile—Yellow Data” page layout.

FIG. 23C illustrates the “Edit Profile—Red Data” page layout.

FIG. 24A illustrates the logical flow of Telescribe button display.

FIG. 24B illustrates the logical flow of Dombox creation via Telescribe button.

FIG. 25A illustrates the 3rd party website page where “Telescribe” button is displayed.

FIG. 25B illustrates the “All Domboxes” page where buyapples.in “Hybrid” Box can be viewed.

FIG. 25C illustrates the logical flow of Telescribe button domain selection.

FIG. 25D illustrates the logical flow of Telescribe unsubscribe process.

FIG. 25E illustrates the logical flow of Telescribe webhooks notification process.

FIG. 26A illustrates the “subscribers” extension activation process.

FIG. 26B illustrates the “All Subscribers” page layout.

FIG. 27A illustrates the “All Contacts” page layout.

FIG. 27B illustrates the “View Contact” page layout.

FIG. 27C illustrates the “View Contact—Files” page layout.

FIG. 27D illustrates the “View Contact—Info” page layout.

FIG. 28A illustrates the “All Files” page layout.

FIG. 28B illustrates the “View File” page layout.

FIG. 28C illustrates the “View File—Virus Scan” page layout.

FIG. 28D illustrates the “View File—Preview” page layout.

FIG. 28E illustrates the “View File—Info” page layout.

FIG. 29A illustrates the “All Mailboxes” page with “Restricted” mode enabled.

FIG. 29B illustrates the “View Mailbox” page with “Restricted” mode enabled.

FIG. 30A illustrates the “All Domboxes” page with “Greylisted” domains.

FIG. 30B illustrates the “View Dombox” page with “Greylisted” mode enabled.

FIG. 31A illustrates the logical flow of mail delivery when “Restricted” and “Greylisted” mode enabled.

FIG. 32A illustrates the chain of trust.

FIG. 33A illustrates the “CAPTCHA Challenge” Interface.

FIG. 33B illustrates the “Phone Number Validation” Interface.

FIG. 33C illustrates the “Attention Fee” Interface.

FIG. 34A illustrates the MX Record IP check for Self-Hosted mails.

FIG. 34B illustrates the MX Record IP check for Third-Party Hosted mails.

FIG. 34C illustrates the Strangers Classifications.

FIG. 35A illustrates the process for Verified Strangers.

FIG. 35B illustrates the process for Unverified Strangers.

FIG. 36A illustrates the Injected Mail.

FIG. 36B illustrates the “Beware of Strangers” warning message.

FIG. 36C illustrates the “Injection Receipt”.

FIG. 37A illustrates the dombox creation for a “Partner” website.

FIG. 37B illustrates the dombox creation for a “Incompatible” website.

FIG. 38A illustrates the box comparison.

### DETAILED DESCRIPTION

Various aspects of the invention will be described with reference to details discussed below, and the accompanying drawings will illustrate the various aspects. The following description and drawings are illustrative of the invention and are not to be construed as limiting the invention. Numerous specific details are described to provide a thorough understanding of various aspects of the present invention. However, in certain instances, well-known or conventional details are not described in order to provide a concise discussion of the present invention.

We believe, the only way to kill spam is to never accept the spam mail at all. i.e. The system should be able to reject the spam mail instantly.

From the Receiver's Perspective, The problem with spam filters is that, it has no idea about what's going on OUTSIDE the email system. i.e. A spam filter may mark an incoming mail as genuine if the sender's email address found in the Address Book. But for others, it has to rely on machine learning algorithms to detect mail genuineness.

From the Sender's Perspective, Spammers have no idea what's going on INSIDE the email system. i.e. A spammer have no idea whether his mail is marked as spam or not. Let's pretend that you are a budding film director. You would like to bring Johnny Depp on board for your new film. So you send him an email. If you don't hear anything from him for a while, then you are gonna write a follow-up mail. Now, what if your first mail get rejected with an error message like “Unauthorized Sender”? Would you still write your follow-up mail? No . . . right? That's because you know it's a dead end. Now apply this scenario to spammers. Spammers are living with hope. They are hoping at least one of their receivers gonna read their mails and buy whatever they are selling. A 2008 study shows that spammers get only One response per 12,500,000 emails, yet that's still profitable for them. Spammers send millions of spam mails to unknown people. They are wasting their time and resources if they go after invalid and inactive email addresses. Also note that many spammers buy targeted email lists from other spammers. Thus, they need to maintain fresh and active email addresses in order to sell it to other spammers. So when emails get rejected with an error message, spammers gonna remove your email address from their email list. That's because your email address is a dead end for them.

Rejecting spam mails comes with a big complication. A system must be able to clearly identify the spammers. If you reject mails that are from Genuine Senders, then your system is completely flawed. You don't wanna lose mails from handful of Genuine Senders. That's the whole purpose of having spam filters, right? Our system presents a way to clearly identify the spammers.

1. Email Overview

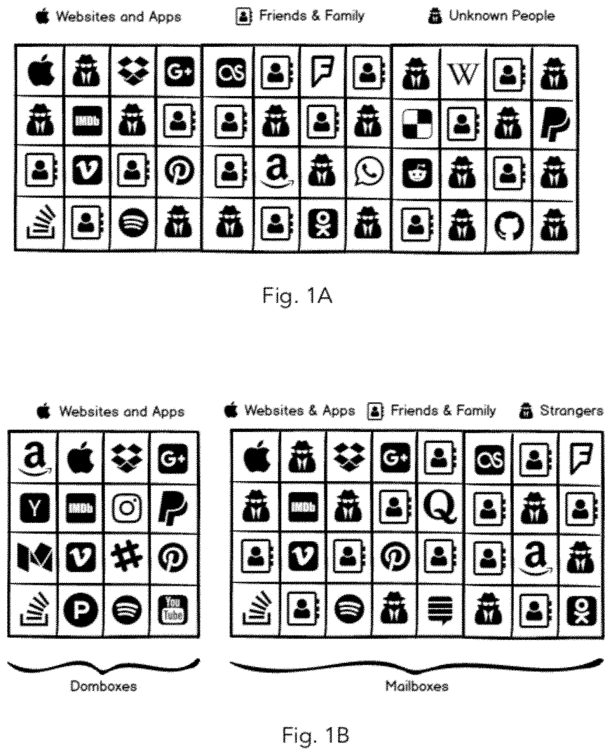

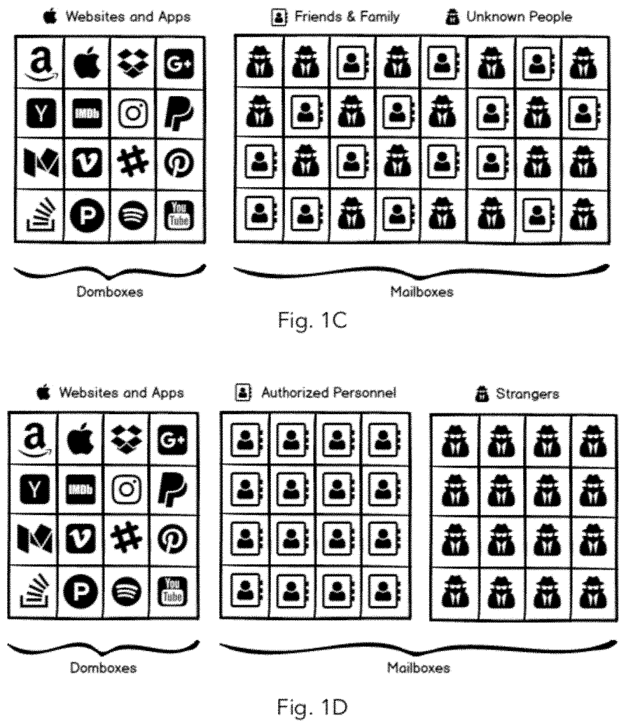

The term “Email 1.0” refers to the current email system. E.g. Gmail. The term “Email 2.0” refers to the email system described in this specification. FIG. 1A illustrates the Normal Email 1.0 Mail System.

1.1. Mail Classifications

Mails are classified into three major categories. Conversational Mails, Transactional Mails and Promotional Mails

1.1.1. Conversational Mails

Conversational mails are all about you versus another human. If the person who is sending you mail is a human, then such mails go under conversational mails. You can add reply to these mails and will be read by a human on the other end. Small businesses sometimes depend on third-party mail hosting services for hosting their conversational mails for security reasons. e.g. Gmail for Business, Zoho Mail wtc.

1.1.2. Transactional Mails

Transactional emails are all about you versus the website/app server. These mails are automatically triggered when you interact with the website/app. Think of it as a transaction between you and the website/app. The transaction can be money or data. You need to be notified for the transaction. Transactional emails are usually sent out from the original website servers. i.e. Without depending on any third-party services. However, there are third-party transactional email API services available too. e.g. AmazonSES, Mailgun, Postmark etc. If you are the only recipient of a mail sent by a website, then most likely it's a transactional mail. The following are some of the examples for Transactional Mail. Mails triggered when you sign up to a website. Mails triggered when you reset passwords. Mails triggered when you place an order. Mails triggered when you update your profile on a website. Mails triggered during certain website events. (Monthly Invoices, New friend request, New Facebook Likes, New Twitter Follower etc.). Confirmation Emails, Welcome Emails, Product Shipping Notices. Purchase Receipts etc.

1.1.3. Promotional Mails

Promotional mails are very different from transactional emails. When it comes to promotional mails, you are not the only recipient. So promotional mails are all about website marketing team versus their users. Since you are one of their users, that includes you too. Marketing team drafts the mail and then send it to all users in bulk. Promotional mails usually contain tracking links. Small businesses usually depend on third-party newsletter services like mailchimp to send out promotional emails. This is because third-party services offer better tracking tools. e.g. how many people opened your emails, how many people clicked the links, how many people unsubscribed etc. As per law, promotional emails require unsubscribe links. Transactional emails are not.

Notes: Both Transactional Mails and Promotional Mails are related to websites. So let's group them as “website related mails”. Keep in mind, You don't need a website to send Transactional Mails and Promotional Mails. e.g. A mobile app can send Transactional Mails with the help of third-party transactional mail services (e.g. AmazonSES) and they can send Promotional Mails via third-party newsletter services (e.g. MailChimp). For better understanding, we use the term “website related mails” to refer both Transactional Mails and Promotional Mails. This content on this patent specification mainly focuses on web platform to explain the concepts better. It should be noted, the current invention can also be used without utilising the web platform. For example, Google Play store contains more than 2 million Android apps. They can implement our system without utilising the web platform.

The term “Service” generally refers to an application that collects email addresses from users and communicate with the users by sending one or more emails to the collected email addresses. e.g. web app, mobile app, desktop app, apps on gaming consoles, apps on smart watches, apps on smart televisions etc. The service may use APIs to collect email addresses. E.g. OAuth apps

The term “Service Mails” generally refers to one or more mail sent by the “Service”. More often than not “Service Mails” falls under the Transactional Mails and Promotional Mails category. “Service Mails” is a broader term for “website related mails”.

The term “Service Owner”, “Business Owner” and “Service Administrator” generally refers to the person who has the management privileges for the service. E.g. Editing DNS records, Perform domain verification, Register client applications etc.

The term “Service Provider” generally refers to an entity that provides one or more services. The entity can be a company or a natural person. For example, Facebook,Inc. is the “Service Provider” of “Facebook”, “Instagram”, “WhatsApp” etc. An individual can be an app developer of one or more mobile apps.

The term “Service Domain” generally refers to the “Primary Domain” associated with the service. E.g. Instagram may have the domain “instagram.com” for the web app. Angry Birds mobile app may be associated with “angrybirds.com”. In some cases, a service may not have any “Service Domain”. E.g. A mobile app created by a student.

The term “Service Provider Domain” refers to the “Primary Domain” associated with the service provider. E.g. Facebook may have the domain “facebook.com”. In some cases, “Service Domain” and “Service Provider Domain” will be the same. E.g. Quora.com, Stripe.com etc.

The term “Platform” refers to the software environment where one or more services can be installed or hosted. Websites are hosted on web platform. Mobile apps are installed on Android, iOS platforms. Desktop applications can be installed in Windows platform, MacOS platform etc.

The term “Service ID” and “Service Identifier” generally refers to the unique identifier that identifies the app in that particular platform. For example, web apps are identified via domain names. So “acme.com” is an example “Service ID” for a web app. Mobile and Desktop apps can be identified via “App ID”

The term “Transactional mail Service” refers to the third-party application that lets the service to send Transactional emails. E.g. AmazonSES, Mandrill, Mailgun etc.

The term “Promotional mail Service” refers to the third-party application that lets the service to send Promotional emails. E.g. Mailchimp, AWeber etc. These third-party applications also referred as “Third-party newsletter service”, “Email marketing newsletter service” etc.

The term “User” and “Consumer” generally refers to the person who use our mail system.

The term “Business” generally refers to the “Service”. Businesses usually owns at least one domain. Businesses usually send mails from these domains to the user rather than using free mail addresses like Gmail.

The term “Identity provider” refers to the system that create, maintain and manage identity information of users and provide authentication of such users to other service (e.g., websites, mobile apps, desktop apps etc.). “Sign in with Facebook” and “Sign in with Google” are the two most popular identity providers on the present internet.

The term “box” refers to any mailbox that has the capability of receiving emails.

An email can originate from any external source. Service and Service Providers would like to whitelist only a certain computers on the network to send mails. These computers can be identified using Email address, domain or IP address. Email Address, Domain or IP address can also be provided as hashes.

The term “Source Identifier” refers to any of the following.

(1) domain e.g. acme.com, test.example.com etc.

(2) IP address. E.g. 172.16.254.1, 2001:db8:0:1234:0:567:8:1 etc.

(3) Email Address e.g. johndoe@gmail.com

(4) domain hash e.g. 1f7a882ba1548f4541515fddd70d8f58

(5) IP address hash. E.g. d77c51bbe41116c5d4fe2f75347bee8a

(6) Email Address Hash. e.g. 29a1df4646cb3417c19994a59a3e022a

1.2. Email Parts

An email can be divided into two parts. (i) Envelope Part—This part is intended for mail handling servers. (ii) Message Part—This is the part that gets displayed to the user.

1.3. Sample SMTP Chat

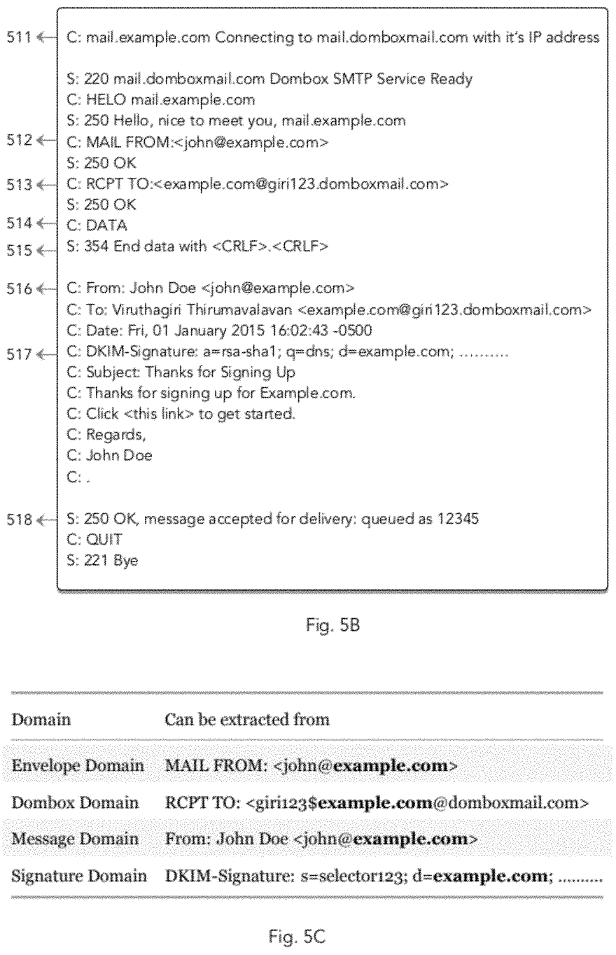

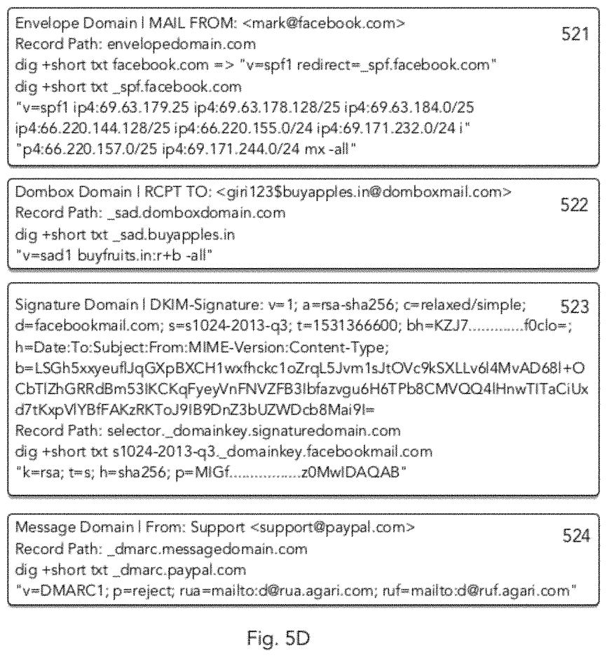

FIG. 5B illustrates a simple SMTP conversation between two mail servers. The content found between the code “354” 515 and “250” 518 is called “Message Part”

1.4. The Four Domains

Our system deals with the following 4 domains. Envelope Domain, Dombox Domain, Signature Domain, Message Domain. FIG. 5C is a table that shows where those 4 domains are extracted from.

1.5. The Three Domains

“Dombox Domain” is something we are introducing and it's applicable only to our system. All other email systems on the internet deal with only the other three domains. i.e. Envelope Domain, Message Domain and Signature Domain. Just for the sake of this specification, let's classify the mails into three types. Excellent Mails, Normal Mails, Abnormal Mails. We can call a mail as “excellent” when all three domains are the same. We can call a mail as “normal” if only the “Envelope Domain” is different. The “Envelope Domain” can be different when third party services used for sending emails. So we consider such emails as Normal. e.g. Mailchimp, Sendgrid, AmazonSES. We can call a mail as “abnormal” when the “Signature Domain” doesn't match the “Message Domain”. The whole purpose of the signature is to make sure the message has not been modified in transit. Thus it should be signed by the “Message Author”. i.e. Where it originates=>The “Message From” domain. When the “Signature Domain” doesn't match the “Message Domain”, Gmail adds a “via” text when displaying “Message From” header. So the end user can understand that the message has not been modified in transit, but someone else signed the message.

2. Box Groups

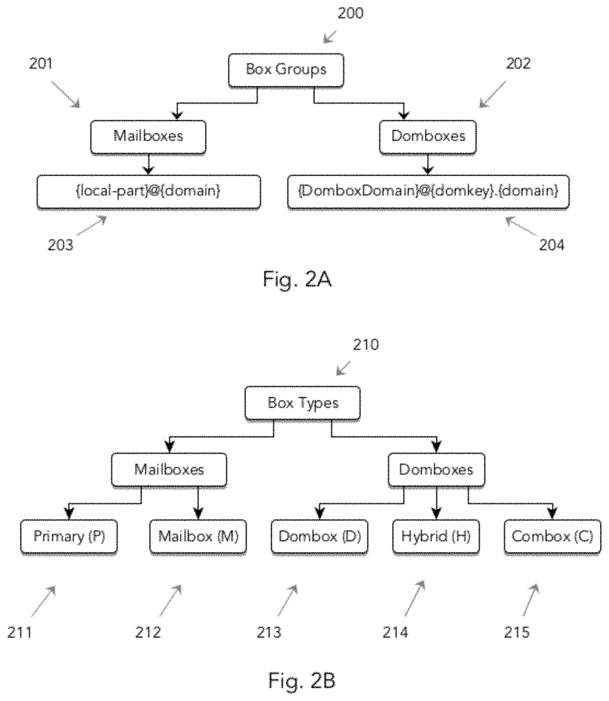

FIG. 2A illustrates the box groups. The boxes are divided into two groups. Mailboxes 201 and Domboxes 202. Mailboxes 201 refers to “Normal Mailboxes”. Domboxes 202 refers to “Isolated Mailboxes”

2.1. Normal Mailboxes Aka. Mailboxes

These boxes works exactly like the mailbox found in other mail services. e.g. Gmail. When a user signup to our mail service, the user will get one normal mailbox for free. This “one normal mailbox” is called “Primary (P)” Mailbox in our system. A “box” found in Mailboxes 201 group is called “Mailbox”. The term “Mailbox” generally refers to any box found in “Mailboxes” group unless or otherwise specified. The boxes found in this group can accept mails from anyone including spammers. In our system “Normal Mailboxes” should be used only for “Conversational Mails”. Address structure: local-part@domain 203. e.g. johndoe@domboxmail.com. The addresses found in this category are called “email address” or “e-mail address”. These addresses are also known as “Mailbox Address”.

2.2. Isolated Mailboxes Aka. Domboxes

A “box” found in Domboxes group 202 is called “Dombox”. The term “Dombox” always refers to any box in “Domboxes” group unless or otherwise specified. Dombox is the short form for “Domain-based Isolated Mailbox”. Users are gonna create a separate mailbox for each domain. Each of this separated (i.e. Isolated) mailbox is called Dombox. Normal Mailboxes are nothing but “Shared” Mailboxes. Domboxes are “Dedicated” Mailboxes. The boxes found in this group can accept mail only from the “Dombox Domain” and its “SAD domains”. The term “Dombox Domain” and “SAD Domains” will be explained in a later section. Isolated Mailboxes should be used only for Transactional and Promotional Mails. The addresses found in this category are called “imail address” or “i-mail address” which stands for “isolated mail address”. These addresses are also known as “Dombox Address”. A user can have unlimited Domboxes. All emails you receive from websites usually fall under either Transactional or Promotional Mails category. The internet has 332 million domains as of 2018. But the user is gonna create Domboxes only for the site he/she about to sign up. If the user signup to 1 website every week, that will be around 52 websites every year. Domboxes doesn't have to be created manually. A Dombox can be created in many ways. Manually, Via Teleport button, Via Telescribe button, Via browser extensions, Via a mobile or desktop client etc. Dombox email address structure splits the “local-part” into two parts via Dollar symbol and the Dollar symbol is a perfectly valid character in the local-part. Domkey is required to generate a Dombox. A Dombox is a property of both the User identified by Domkey and the Dombox Domain. Only the “Dombox Domain” and it's “SAD Domains” can write emails to the “Isolated Mailbox”. Only the consumer can read and delete emails from the “Isolated Mailbox”.

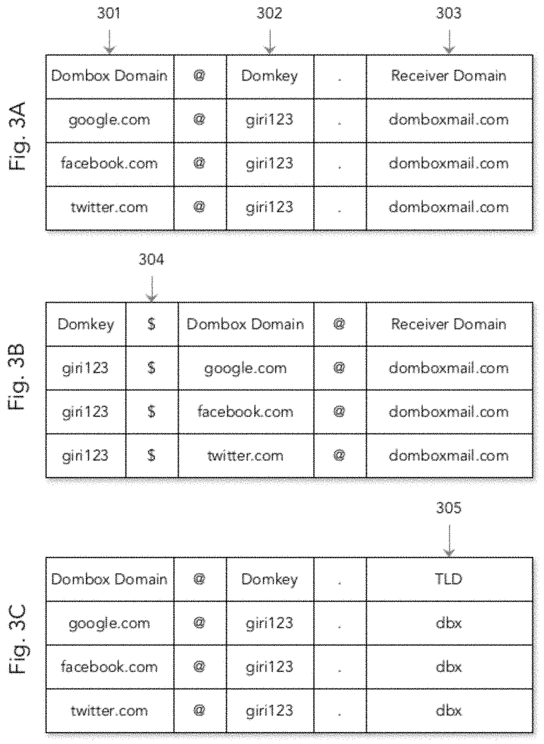

Isolated Mailbox (i.e. Dombox) has three different address structures. FIG. 3A illustrates subdomain-based Dombox email address structure. FIG. 3B illustrates Dollar-based Dombox email address structure. FIG. 3C illustrates Custom-TLD based Dombox email address structure.

Dombox email address structure contains of the following things. Dombox Domain, Domkey and Receiver Domain

The term “Dombox Domain” 301 refers to the “Service Domain”. A Dombox is created for only that particular “Dombox Domain”. By default only the “Dombox Domain” is authorized to send mails to that particular Dombox. “Dombox Domain” can be found between the “$” symbol and “@” symbol in the dollar-based Dombox email address structure. The whole “local-part” in the sub-domain based dombox address structure and the whole “local-part” in the Custom-TLD based dombox address structure contains the “Dombox Domain”. The term “Dombox Domain” applicable only to the boxes found in “Domboxes” group. Some people may be confused with our official domain “domboxmail.com”. In such situations, the term “Box Domain” or “Service Domain” should be used instead of “Dombox Domain”. In other words, “Box Domain”, “Dombox Domain” and “Service Domain” refers to the same thing. Only the “main domain” is allowed in “Dombox Domain”. e.g. example.com. All subdomains are converted into main domain. e.g. If a user tries to create a box for https://del.icio.us, then the box will be created for “icio.us” because that's the main domain.

The term “Domkey” 302 refers to the short form “Dombox Global Keyword”. Domkey should be a unique string just like username. Domkey should be an alphanumeric string. Domkey can be set only once for an account and cannot be changed later. e.g. giri123. Throughout this document “giri123” refers to a Domkey. Domkey should be set before creating the first “Dombox”. Domkey is same for all user created Domboxes. Domkey cannot be one of user's “Normal Mailbox” local-part. i.e. If a user has an email address like johndoe@domboxmail.com, then the user can't have “johndoe” as value for Domkey.

The term “Receiver Domain” 303 refers to the mail receiving domain. Throughout this document domboxmail.com is used as receiver domain.

FIG. 3A illustrates subdomain-based Dombox email address structure and its examples.

Address Structure: {Dombox Domain}@{Domkey}.{Receiver Domain} 204. e.g. example.com@giri123.domboxmail.com. Domkey 302 acts as a subdomain in FIG. 3A

FIG. 3B illustrates dollar-based Dombox email address structure and its examples.

Address Structure: {Domkey } {Separator} {Dombox Domain}@{Receiver Domain}. e.g. giri123$example.com@domboxmail.com. In dollar-based Dombox email address structure, local-part is divided into three parts. Domkey, Separator 304 and Dombox Domain.

The term “Separator” 304 is a special character that separates “Domkey” and the “Dombox Domain”. The separator should be same and consistent for all dombox addresses. The separator should be a valid special character allowed in email address local-part. e.g. $ (Dollar symbol). Throughout this specification $ symbol being used as Separator.

FIG. 3C illustrates Custom-TLD based Dombox email address structure and its examples Address Structure: {Dombox Domain}@{Domkey}.{TLD}. e.g. example.com@giri123.dbx

“dbx” 305, is an example custom TLD created to provide Dombox mail service. In this example “Second Level Domain” is considered as “Domkey”

This specification uses both Dollar-based and Subdomain-based address structures interchangeably in examples and illustrations.

Our Dombox address structures explicitly shows “Dombox Domain” and Domkey on the email addresses. “Dombox Domain” is the service identifier. Domkey is the user identifier. A system can also go for implicit method. I.e. Service Identifier, User identifier etc. mapped indirectly using a database. E.g. Table rows on the database may have a structure like this for the Dombox Addresses.

Dombox Address: abc@domboxmail.com, Service Identifier: example.com, User Identifier: giri123, Alias Domains: example.net, example.org

Dombox Address: xyz@domboxmail.com, Service Identifier: 12345, User Identifier: giri123, Allowed Domains: example.net, example.org

Both abc@domboxmail.com and xyz@domboxmail.com looks like normal mailbox addresses, but they are actually isolated mailbox addresses since mapped using a database. Using Hashes (e.g. MD5, SHA1, SHA256) to identify domain is another indirect approach

The reason we use “Dombox Domain” explicitly because we want third-party newsletter services like mailchimp identify the service easily. For example, quora.com@giri123.domboxmail.com address belongs to quora.com. Mailchimp can ask the logged in user to verify quora.com So spammers can't abuse third party newsletter services to send spam. This kind of explicit address structures saves a lot of bandwidth and computing power on both sides.

3. Architecture

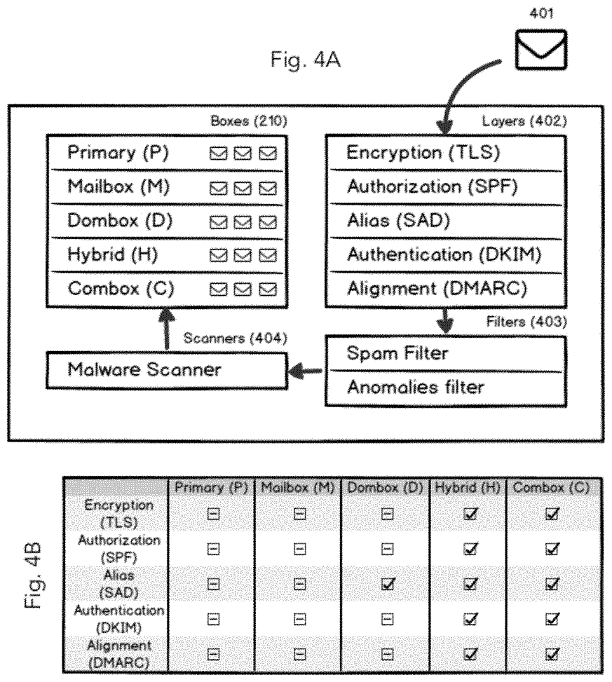

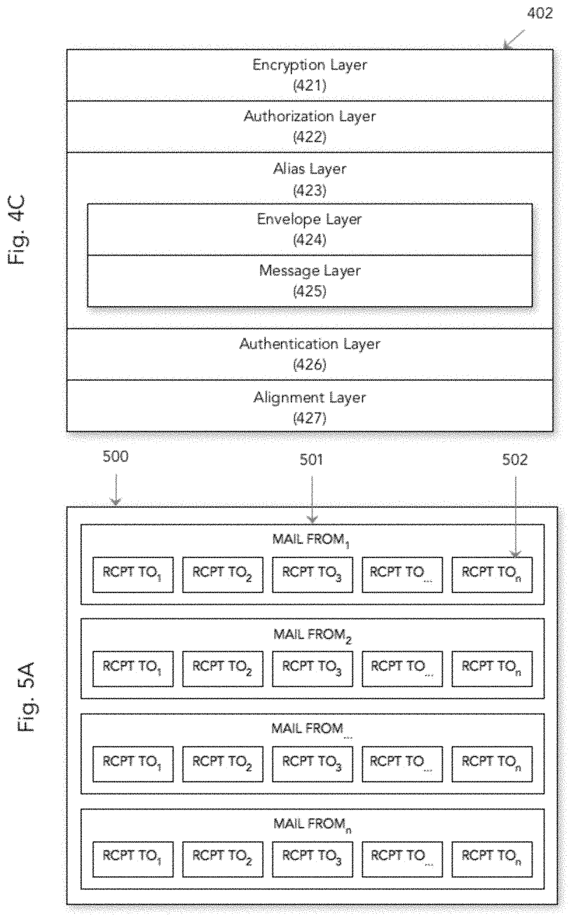

FIG. 4A illustrates the Dombox mail system architecture. Our system contains 4 major components. Layers 402, Filters 403, Scanners 404 and Boxes 210. Layers 402 component contains 5 layers. Spam mails usually get caught in one of these layers. Filters 403 component contains 2 Filters. Spam Filter & Anomalies Filter. Spam Filter is the normal spam filter. Anomalies Filter is a less aggressive spam filter and it's primarily targets Phishing and Malware mails. Scanners 404 component contains virus and malware scanners. Boxes 210 component contains 5 types of boxes. Each box type is designed for a different purpose.

FIG. 4C illustrates the layers. Each and every incoming mail has to go through five layers of checks. Those five layers are Encryption Layer 421, Authorization Layer 422, Alias Layer 423, Authentication Layer 426 and Alignment Layer 427. Alias Layer contains two sub layers. Envelope Layer 424 and Message Layer 425. Spam mails usually get caught in one of these 5 layers. So the mail will be rejected instantly.

4. Layers

FIG. 5A illustrates a mail session structure. A mail session can have unlimited messages 501. Each message can have unlimited recipients 502. MAIL FROM1 to MAIL FROMn 501 command represents the beginning of each message. RCPT TO1 to RCPT TOn 502 command represent recipients of that particular message.

FIG. 5B illustrates a simple SMTP conversation between two mail servers. mail.example.com is connecting to mail.domboxmail.com with its IP address 511. This process known as TCP handshake. The “Client IP” (Mail Sending Server IP) address is extracted from here. The C letter in FIG. 5B represents the Client (Mail Sending Server). In our case this is mail. example.com. The S letter in FIG. 5B represents the Server (Mail Receiving Server). In our case this is mail.domboxmail.com. The Server responds with 220 code if the server is ready. The Client issues the HELO command to identify itself. The Server responds with 250 code to acknowledge. The Client issues the MAIL FROM 512 command to specify the sender. This command tells that a new mail transaction is being started. The email address provided by the MAIL FROM command is also known as Envelope From, Return Path, RFC.5321 From and Bounce Address. The Server responds with 250 code when there is no problem with the MAIL FROM address. The Client issues the RCPT TO 513 command to specify the receiver mail address. The mail will be delivered to the email address provided in this command. The Client may issue RCPT TO command multiple times to deliver the mail to more than one recipient. The Server responds with 250 code for each RCPT TO command if the recipient is valid. The Client issues the DATA 514 command to transfer the message contents (body text, attachments etc). The Server responds with 354 code to proceed to transfer the message contents. The Client transfers the message contents (mail headers, body text, attachments etc). The whole contents transferred here is called “Message Part”. The headers found in the message contents are called “Message Headers”. The “From” email address 516 found in the message header is called “Message From”. It is also known as “RFC.5322 From” and “Display From”. The Server responds with 250 code and queue the message for delivery 518. The Client issues the MAIL FROM command again if there are more mails to transfer, otherwise it issues the QUIT command to close the connection. The Server responds with 221 code and closes the connection.

4.1. Layer Purpose

Each layer serves a different purpose.

(i) Encryption Layer—Checks whether the mail is encrypted. (ii) Authorization Layer—Checks whether the “Sending IP/Client IP” is authorized to send mails for the “Envelope Domain”. (iii) Alias Layer—Checks whether the “Envelope Domain and/or Message Domain” is an alias for the “Dombox Domain”. (iv) Authentication Layer—Checks whether the mail is digitally signed and the digital signature valid. (v) Alignment Layer—Checks whether the “Envelope Domain and/or Signature Domain” is aligned with “Message Domain”

4.2. Primary Subject

(i) Encryption Layer—None (ii) Authorization Layer—Envelope Domain (iii) Alias Layer—Dombox Domain (iv) Authentication Layer—Signature Domain (v) Alignment Layer—Message Domain

4.3. Record Path

(i) Encryption Layer—None (ii) Authorization Layer—dig TXT envelopedomain.com (iii) Alias Layer—dig TXT _sad.domboxdomain.com (iv) Authentication Layer—dig TXT selector._domainkey.signaturedomain.com (v) Alignment Layer—dig TXT _dmarc.messagedomain.com

4.4. Technical Names

(i) Encryption Layer—Transport Layer Security (TLS) (ii) Authorization Layer—Sender Policy Framework (SPF) (iii) Alias Layer—Sender Alias Domains (SAD) (iv) Authentication Layer—DomainKeys Identified Mail (DKIM) (v) Alignment Layer—Domain-based Message Authentication, Reporting and Conformance (DMARC)

4.5. Encryption Layer

Checks whether the mail is encrypted. Technical Name: Transport Layer Security (TLS). Possible Results: Pass or Fail. Pass—Encrypted. Fail—Not Encrypted

4.5.1. Encryption Layer Flow

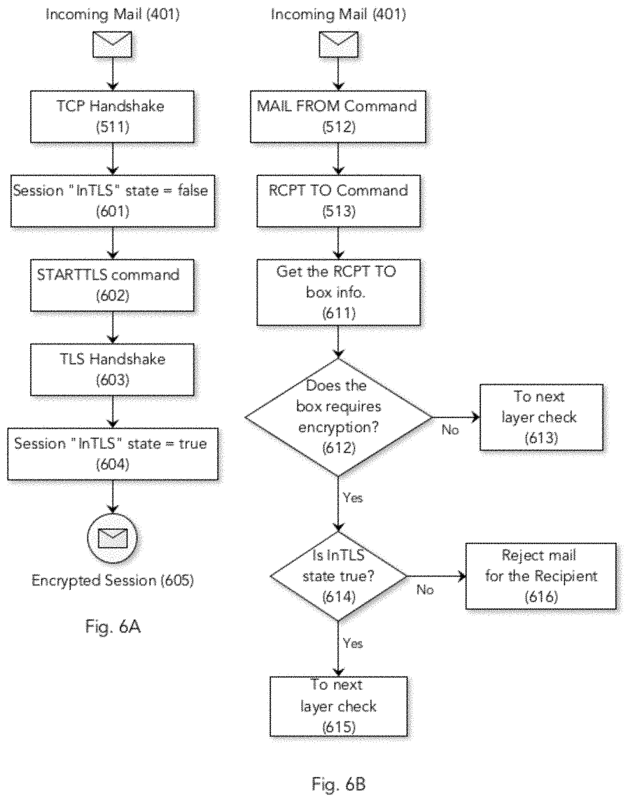

FIG. 6A illustrates the logical flow of TLS upgrade. An incoming mail 401 from the Mail sending server (Client) begins the TCP handshake 511 first. Once this is done, a new SMTP session is created. In this SMTP session we have a global boolean variable called “InTLS”. By default InTLS state is set to false 601. Mail sending server (Client) issues the EHLO command. The Mail receiving server (Server) responds with 250 code. The server also provides list of supported SMTP extensions. e.g 250—SIZE, 250—PIPELINING, 250—STARTTLS etc. If STARTTLS extension found in the supported SMTP extensions, then the server supports encryption. So the Mail sending server (Client) issues the STARTTLS 602 command to encrypt the conversation. The Mail receiving server (Server) responds with 220 code to go ahead. Both Mail sending server (Client) and Mail receiving server (Server) negotiates the TLS 603 and then upgrades the current connection to a secure connection. Session “InTLS” state is set to true 604. The rest of the SMTP conversations are now encrypted 605.

FIG. 6B illustrates the logical flow of Encryption layer check. This layer checks whether the mail is encrypted or not. An incoming mail 401 from the sender begins the MAIL FROM 512 command. At this stage “InTLS” state can be either true or false. If the mail session is upgraded to TLS, then the “InTLS” state is true. The logical flow of upgrading the connection to a secure connection already illustrated in FIG. 6A. Mail Sending Server (Client) issues the RCPT TO 513 command. e.g. RCPT TO:<example.com@giri123.domboxmail.com>513. At this stage, we pull the box type for the RCPT TO email address 611. In our case, we pull the “example.com@giri123.domboxmail.com” address box type. If the box type of that address is either Hybrid (H) or Combox (C), then this box requires “mandatory pass” for Encryption layer. In other words “InTLS” state must be “true” to proceed. So at this stage, we check whether the box requires encryption or not 612. If the box doesn't require encryption, then we can proceed to other layer checks 613. If the box require encryption, then we check the “InTLS” state 614. If the state is “true”, then the Encryption layer check is passed. So we proceed to other layer checks 615. If the state is “false”, that means the current mail is being transferred as unencrypted plain text. At this point we reject the mail for that recipient 616. If there is more than one recipient, we repeat the same encryption layer check for every RCPT TO command. i.e. For each and every mail Recipient.

4.6. Authorization Layer

Checks whether the “Sending IP/Client IP” is authorized to send mails for the “Envelope Domain”. Technical Name: Sender Policy Framework (SPF). Possible Results: Pass or Neutral or Fail. Pass—Authorized. Neutral—Not Configured. So neither Authorized nor Unauthorized. Fail—Unauthorized.

Note: We use SPF in our authorization layer because it is the popular standard. There are alternatives available too. Like Microsoft Sender ID. So it has to be noted, authorization layer deals with authorized IP addresses of the Envelope Domain. SPF is one of the implementations.

4.6.1. Sample SPF Record Query

The SPF record will be fetched from the “Envelope Domain”. Sample SPF record query 521 illustrated in FIG. 5D

4.6.2. Authorization Layer Flowcharts

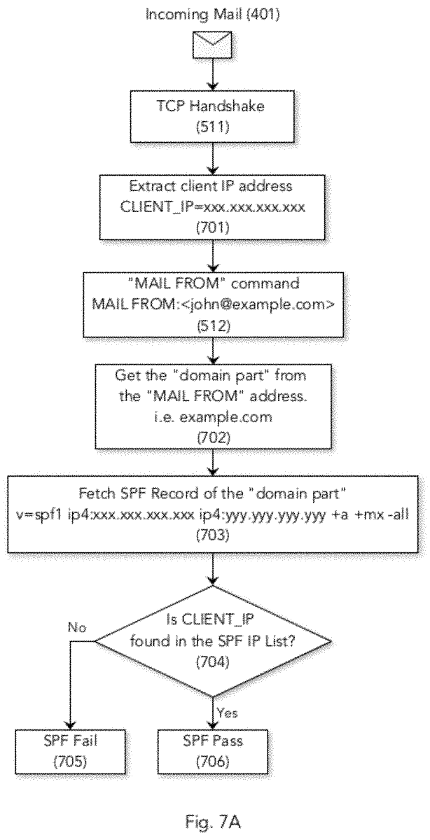

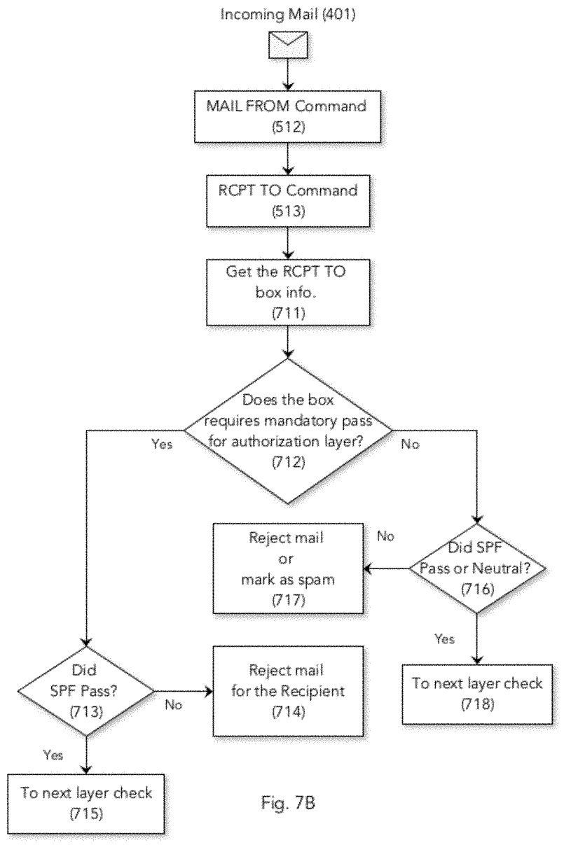

FIG. 7A illustrates the logical flow of SPF. This layer checks whether the mail sending server (Client) is authorized to send mail for the Envelope Domain. This check is processed for each and every MAIL FROM 501 command. An incoming mail 401 from the sender begins the TCP handshake 511. Mail sending server IP address (Client IP) is extracted at this stage and stored in a global session variable called CLIENT_IP 701. e.g CLIENT_IP=xxx.xxxx.xxx.xxx. Mail Sending Server (Client) issues the MAIL FROM 512 command. e.g. MAIL FROM:<john@example.com>. Get the “domain part” from the MAIL FROM address 702. In our case this is example.com. This is called “Envelope Domain”. Fetch SPF Record from the “Envelope Domain” DNS 703. In our case example.com DNS server. The record returned from the DNS would look something like this. “v=spf1 ip4:xxx.xxx.xxx.xxx ip4:yyy.yyy.yyy.yyy+a+mx-all”. If there is no SPF Record on the DNS, that means the domain owner have not configured any SPF. In this case SPF result is NEUTRAL. If there is an SPF Record on the DNS, then we check whether the CLIENT_IP found in the list of IP addresses provided by the SPF record 704. If the CLIENT_IP found in the list of authorized IP addresses, that means “SPF Pass”. 706. If the CLIENT_IP not found in the list of authorized IP addresses, that means “SPF Fail”. 705.

FIG. 7B illustrates the logical flow of Authorization layer check. An incoming mail 401 from the sender begins the MAIL FROM 512 command. At this stage SPF is checked and the result is stored in a global variable for that particular message 501. Mail Sending Server (Client) issues the RCPT TO 513 command. e.g. RCPT TO:<example.com@giri123.domboxmail.com>. At this stage, we pull the box type for the RCPT TO email address 711. In our case, we pull the “example.com@giri123.domboxmail.com” address box type. If the box type of that address is either Hybrid (H) or Combox (C), then this box requires “mandatory pass” for Authorization layer 422. So at this stage, we check whether the box requires mandatory pass or not for authorization layer 712. If the box require “mandatory pass” for authorization layer, then we check whether SPF has passed or not 713. If SPF has passed then we can proceed to the next layer check 715. If SPF has not passed then we reject the mail for the recipient 714. If the box doesn't require “mandatory pass” for authorization layer, then we check whether SPF has passed or neutral 716. If SPF has passed or Neutral then we can proceed to the next layer check 718. If SPF has failed then we can either reject mail or mark the mail as spam 717.

4.7. Alias Layer

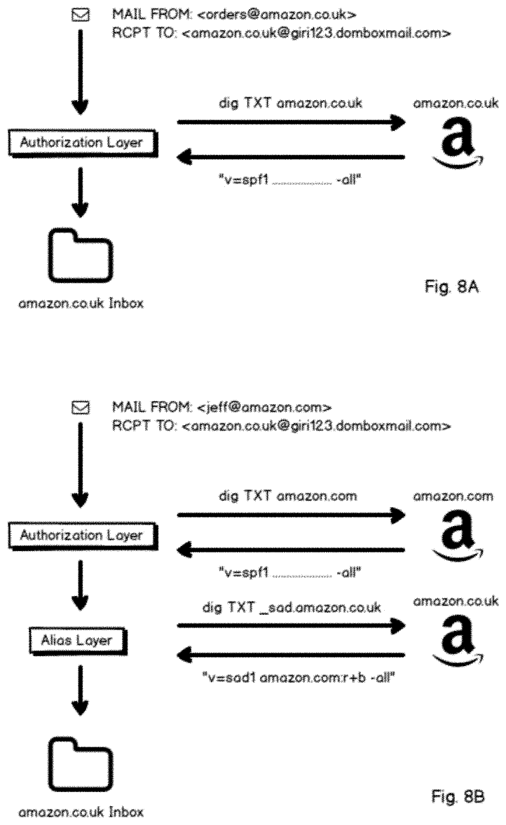

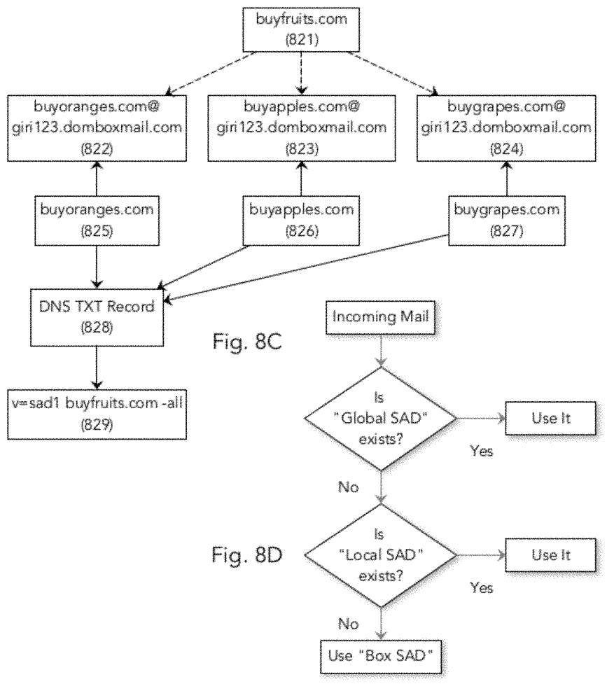

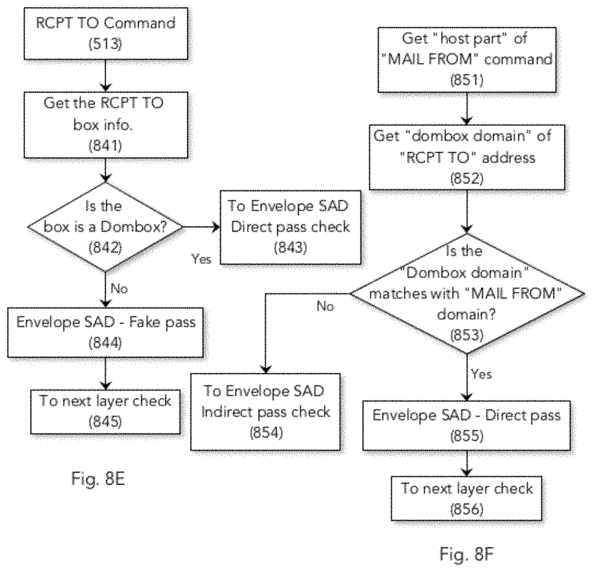

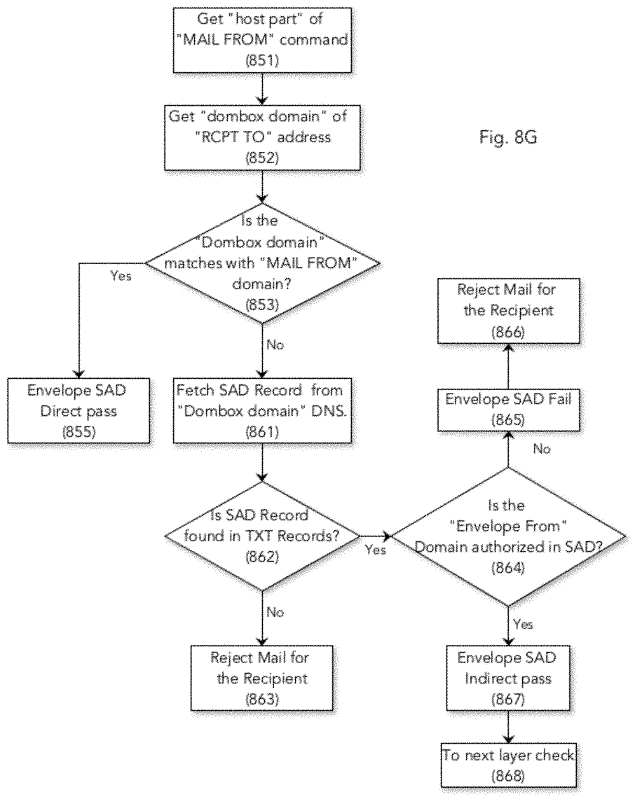

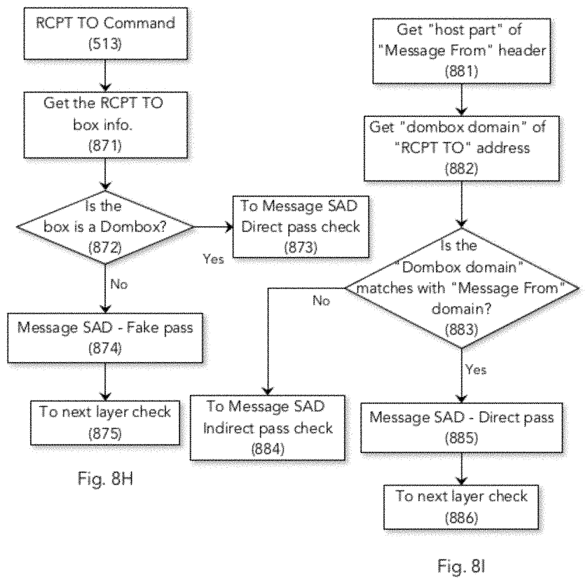

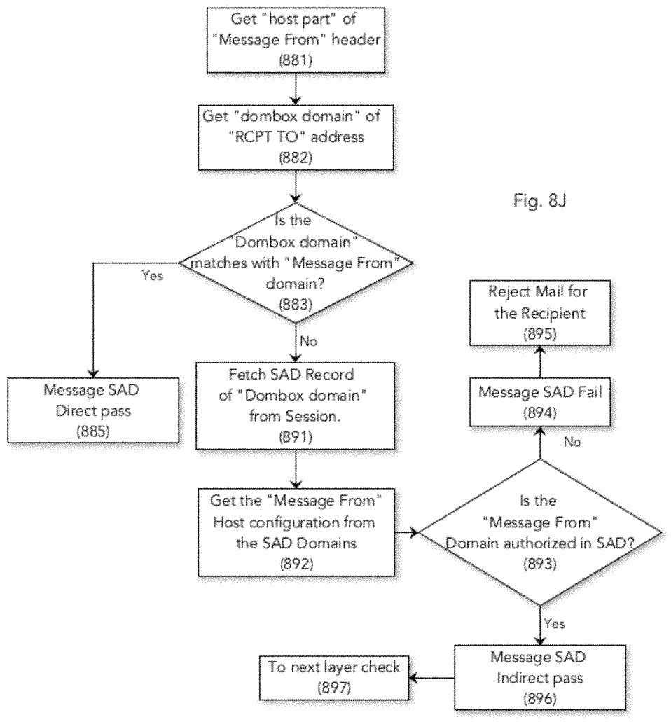

Checks whether “Envelope and/or Message Domain” is an alias for the “Dombox Domain”. Technical Name: Sender Alias Domains (SAD). Possible Results: Pass (FakePass, DirectPass, IndirectPass). (i) FakePass—Alias Layer applicable only for “Domboxes”. So if the incoming mail is to the boxes found in “Mailboxes” group, then the result is set to “FakePass” for consistency {Refer “Mail Score” in a Later section}. (ii) DirectPass—When the “Envelope and Message Domain” are the same as “Dombox Domain”. FIG. 8A illustrates Direct Pass. (iii) IndirectPass—When the “Envelope and/or Message Domain” are not the same as “Dombox Domain”, but passed via SAD record. FIG. 8B illustrates Indirect Pass. Note: If the Alias Layer result is “Fail”, then the mail will be rejected. So the only possible result for “Alias Layer” is “Pass”.

Alias layer is divided into two sub layers. (i) Envelope Layer—Checks whether the “Envelope Domain” is an alias for the “Dombox Domain”. (ii) Message Layer—Checks whether the “Message Domain” is an alias for the “Dombox Domain”

Alias Layer is all about 3 domains. Dombox Domain (Primary Subject) compares itself with “Envelope Domain” and “Message Domain”. Keep in mind, this layer contains two checks. One for the “Envelope Layer” and One for the “Message Layer”. Even if one Layer result is “Fail”, then the mail will be rejected.

4.7.1. Sender Alias Domains (SAD)

SAD is similar to SPF. SPF deals with “authorized IP addresses”. SPF record is provided by the “Envelope Domain”. In SPF, We check whether the “Client IP” is found in the list of “authorized IP addresses” provided by the “Envelope Domain”.

SAD on the other hand, deals with “authorized domains”. SAD record is provided by the “Dombox Domain”. In SAD, We check whether the “Dombox Domain” found in the list of “authorized domains” provided by the “Dombox Domain”.

For example, A user created an isolated mailbox for amazon.in and the box address looks like this =>giri123$amazon.in@domboxmail.com. This box can accept mail only from amazon.in by default. To allow mail from jeff@amazon.com to amazon.in box, amazon.in should have the following SAD record in _sad.amazon.in. “v=sad1 amazon.com:r+b example.com:s+e-all”. Note: We always check the SAD record in the “Dombox Domain”. The “Dombox Domain” can be extracted from the Isolated Mailbox address. giri123$amazon.in@domboxmail.com=>amazon.in

4.7.2. SAD Configuration

A SAD record can have multiple domains and each domain can have a configuration.

{Domain}:{Relaxed or Strict}+{Envelope Mode or Message Mode or Both}

(i) Relaxed (r)—Exact domain and its subdomains are allowed (Default).

(ii) Strict (s)—Exact domain only allowed.

(iii) Envelope Mode (e)—Domain is allowed only in the “Envelope From” (Default).

(iv) Message Mode (m)—Domain is allowed only in the “Message From”.

(v) Both Mode (b)—Domain is allowed in “Envelope From” as well as “Message From”.

So, “v=sad1 example.com-all” is equivalent to “v=sad1 example.com:r+e-all”

4.7.3. SAD Examples

ED=Envelope Domain, MD=Message Domain, DD=Dombox Domain

Box created for facebook.com (DD), mails are carried by third-party newsletter service mailchimp.com (ED) for the domain facebook.com (MD). In this case, add the following record in “Dombox Domain” DNS.

_sad.facebook.com=>“v=sad1 mailchimp.com-all”

Box created for facebook.com (DD), mails are carried by facebook.com (ED) for one of their product instagram.com (MD). In this case, add the following record in “Dombox Domain” DNS.

_sad.facebook.com=>“v=sad1 instagram.com:r+m-all”

Box created for facebook.com (DD), mails are carried by third-party newsletter service mailchimp.com (ED) for one of Facebook product instagram.com (MD). In this case, add the following record in “Dombox Domain” DNS.

_sad.facebook.com=>“v=sad1 mailchimp.com instagram.com:r+m-all”

4.7.4. SAD Types

Three kinds of SAD available: (1) Box SAD (2) Local SAD (3) Global SAD

4.7.4.1. Box SAD

Problem: A system would fail when it expects immediate total cooperation from everybody at once. We cannot expect the websites to support SAD record in our early years. On the other hand, we cannot just assume that the websites gonna use only their “Dombox Domain” to send mails. For example, Facebook always sends their notification mails from facebookmail.com. So, If you create a box for “facebook.com”, it won't accept those notification mails from facebookmail.com unless SAD configured.

Solution 1: Let the box learn from its initial users. e.g. 100 Users. We are gonna give unrestricted access to the box for X days for the first X users who create the box. e.g. 30 days.

Example: You created an isolated mailbox for randomdomain.com and you are one of the first 100 Users. For the first 30 days the box gonna work like a Normal Mailbox. i.e. It can accept mails from any domain. The box aggregates and generates a SAD record from those first 100 Users. Pros: After 100 Users we have enough data for SAD. Cons: First 100 users can abuse the system by creating duplicate accounts in 3rd party websites. We should have maximum SAD Domains to minimize such abuse. e.g. 10

Solution 2: Collect SAD data from user other mail account mails. e.g. @gmail.com, @outlook.com

Solution 3: Purchase the SAD data from data mining companies. Since SAD record contains only non sensitive public data, this is totally ethical.

Message Domain=>Array of Envelope Domain.=>Total Mails and Total Users for each Envelope Domain. e.g. acme.com=>array(“mailchimp.com”=>“found 573 mails in 33 user accounts”, “sendgrid.net”=>“found 273 mails in 13 user accounts”)

The SAD in this section can be termed as “System authorized SAD”.

4.7.4.2. Local SAD

This is the SAD Record added by our company staff for the notable domains. We should have a threshold for a domain to be considered as a notable domain. e.g. 10 million users. Our staff would collect the data from various sources and then define the SAD Record. This may sound like a tedious process, but it actually is not due to the following reasons.

(i) Unlike SPF (which deal with IP addresses), we are dealing with only the “domain names” in SAD. So the data is a stable one since rarely it get changed. Once a SAD record added by our staff, no need to intervene until there is a problem. (ii) We can cover most of these notable domains if we process old emails from Gmail, YahooMail etc. So we can ask our users to import their old emails. (iii) We can contact these notable sites directly and collect the data from them. (iv) All these notable sites, usually have their own mail server setup and do not depend on third party mailing services to send out mails. So they usually use the “reject” policy in DMARC record. Which means there won't be any SAD Domains for such sites except in rare cases like Facebook. [We can discuss this part in Alignment Layer section]

The SAD in this section can be termed as “Staff authorized SAD”. The staff is a natural person.

4.7.4.3. Global SAD

This is the SAD record defined in the “Dombox Domain” DNS by the domain owner in this path. _sad.domboxdomain.com

Sender Alias Domains (SAD) and the “Alias Layer” is applicable only to our dombox mail system. Although we recommend SAD record to be placed in a DNS server, there are other ways to achieve the same result too. For instance, Google has thousands of domains. It's really not possible to place these thousands of domains in the DNS due to the limitation. So the SAD record that contains these thousands of domains can be placed in an HTTP or HTTPS server (i.e. web server) as a txt file. For example google.com can provide their SAD record by placing it in path like http://google.com/sad.txt or https://google.com/sad.txt.

However, it is also possible to ask the domain owners to create an account on our system and verify their domains and then ask them to provide their SAD domains by displaying an HTML form input field. This kind of system offers benefits to only one entity and it's really impossible to ask all 332 million domains to create an account, verify their domains and provide the SAD domains. The SAD in this section can be termed as “Service authorized SAD”. More Specifically it's authorized by a “Service Administrator” or “Service Owner”. The “Service Administrator” and “Service Owner” are humans.

4.7.4.4. User SAD

A user can authorize one or more domains to send mails to the particular dombox. But users can abuse this kind of system. Also it's a daunting task for non technical users. For that reason, we do not support “User authorized SAD” at the moment.

FIG. 8D illustrates the logical flow of SAD record selection.

4.7.5. Notes For Bulk Mailers

The SAD record will be checked when you issue RCPT TO 513 command. When you issue multiple RCPT TO commands (i.e. multiple recipients) make sure they are all related to the same “Dombox Domain” for better results. To prevent DDoS attacks, we allow up to 10 SAD record failures. The whole session will be terminated with an error message like “Too many SAD Failures” if there are more than 10 SAD record failures. If the Alias Layer is Fail for a “Dombox Domain”, then all consecutive RCPT TO commands related to that “Dombox Domain” will result in Failure too. So if you get a response like “Alias Layer Failure”, then either terminate the session or move on to the next “Dombox Domain”. Avoid sending mails to more than 100 different “Dombox Domains” in a single session. Note: The values 10 and 100 used here as example values.

4.7.6. Sample SAD Record Query

The SAD record will be fetched from the Dombox Domain. Sample SAD record query 522 illustrated in FIG. 5D

4.7.7. Alias Layer Flowcharts

FIG. 8C illustrates the logical flow of SAD. BuyFruits.com 821 is a company that sells fruits. This is the parent company. But it also has three subsidiaries BuyOranges.com 825, BuyApples.com 826, BuyGrapes.com 827. When a user create Dombox for BuyOranges.com, the dombox address will be buyoranges.com@giri123.domboxmail.com 822. For this Dombox, only the mails from BuyOranges.com are allowed. When a user create Dombox for BuyApples.com, the dombox address will be buyapples.com@giri123.domboxmail.com 823. For this Dombox, only the mails from BuyApples.com are allowed. When a user create Dombox for BuyGrapes.com, the dombox address will be buygrapes.com@giri123.domboxmail.com 824. For this Dombox, only the mails from BuyGrapes.com are allowed. There should be a way for the parent company to send mails to subsidiary company users. e.g. A mail from the parent company CEO (ceo@buyfruits.com) to the subsidiary company users. We solve this problem with our standard called Sender Alias Domains (SAD). SAD is applicable only for Domboxes 202. SAD should be placed in the “Dombox Domain”. buyapples.com@giri123.domboxmail.com where buyapples.com is the “dombox domain”. So the SAD should be placed in buyapples.com. The SAD structure would look like this. “v=sad1 buyfruits.com-all”. If the above string found in buyapples.com DNS record 829, that would allow mails from @buyfruits.com to the Dombox buyapples.com@giri123.domboxmail.com. In other words, although the box created only for buyapples.com, it can receive mails from buyfruits.com. If SAD records not found in DNS, then we allow only the Dombox Domain “buyapples.com” to send emails to the user. “v=sad1 buyfruits.com-all” 829 SAD Record is defined in all three subsidiary domains DNS 828. i.e. BuyOranges.com 825, BuyApples.com 826, BuyGrapes.com 827. So buyfruits.com 821 now can send mails to subsidiary domain users. Because buyfruits.com is a “Sender Alias Domain” for the subsidiary domains. In FIG. 8C dotted arrows represents indirect mail delivery. i.e. via a Sender Alias Domain.

As of now the SAD Records are duplicated in subsidiary domains. i.e. The same SAD Record present in all three subsidiary domain DNS. SAD Record can be managed in only one place with the help of “redirect” tag. We can place the main SAD Record “v=sad1 buyfruits.com-all” in _sad.buyfruits.com and then in all subsidiary domains we can use the following SAD Record. “v=sad1 redirect:_sad.buyfruits.com”. Now all the subsidiary SAD queries are redirected to _sad.buyfruits.com. If we add more domains in the future, we don't have to edit each and every subsidiary domain. We have to only edit the main SAD.

We can also have “include” tag. This will include the external SAD. “v=sad1 example1.com-all” Record is placed in _sad.abc.com and “v=sad1 example2.com-all” Record is placed in _sad.xyz.com. Now we can use the “include” tag to include those SAD. “v=sad1 include:_sad.abc.com include:_sad.xyz.com-all”. If that SAD found in a domain, that would allow both example1.com and example2.com. There is a maximum of 10 DNS lookups in order to avoid DDoS attacks.

Both “include” and “redirect” options will be helpful when a service rely on third party services to send mails. Third-party newsletter services like mailchimp uses their own custom domain for “Envelope Domain” to generate VERP. bounce-mc.us3_7667677.3535173-domboxtester=gmail.com@mail144.atl221.rsgsv.net. The following are some of the “Envelope Domain” mailchimp uses in the MAIL FROM command. mcsv.net, mcdlv.net, or rsgsv.net. Unless mailchimp explicitly state this information in their documentation, website owners will have no idea. And mailchimp may add custom servers in the future. So instead of asking the website owners to add these domains manually, they can configure a SAD record in the following path. _sad.mailchimp.com=>“v=sad1 mcsv.net mcdlv.net rsgsv.net-all”. And then ask the website owners to “include” or “redirect” to sad.mailchimp.com

In some cases, the business owner would like to have a single “Dombox Domain” for all their domains. For example, Google owns thousands of domains like blogger.com, googleplus.com, youtube.com etc. google.com is the main domain. Google would like to use the main domain for creating dombox when users try to create dombox for googleplus.com. In such cases, Google can configure the SAD record in googleplus.com like this.

_sad.googleplus.com=>“v=sad1 box:google.com-all”.

The “box” keyword says, create a dombox for google.com instead of googleplus.com. So the addresses would look like giri123$google.com@domboxmail.com instead of giri123$googleplus.com@domboxmail.com. When the user tries to create a dombox for googleplus.com, we will fetch the SAD record from the googleplus.com DNS. If “box” option found in the googleplus.com SAD record, we will use the domain specified in the box option for creating dombox. Otherwise we will fallback to the current passed domain. We can display a popup saying “You are trying to create a dombox for googleplus.com. However, googleplus.com suggests us to create the dombox for google.com. Would you like to continue? (a) Yes, create dombox for google.com (b) No, create dombox for googleplus.com”

FIG. 8E illustrates the logical flow of “Alias—Envelope layer—Fake Pass” check. Mail Sending Server (Client) issues the RCPT TO 513 command. e.g. RCPT TO:<giri@domboxmail.com>. At this stage, we pull the box type for the RCPT TO email address 841. In our case, we pull the “giri@domboxmail.com” address box type. We check 842 whether the box is one of the boxes found in “Domboxes” 202 group. If the box type of that address is either Primary (P) or Mailbox (M), then this is a box found in “Mailboxes” 201 group. If the box type of that address is either Dombox (D), Hybrid (H) or Combox (C), then this is a box found in “Domboxes” 202 group. If the box is one of the boxes found in Domboxes 202 group, then we proceed to the “Envelope SAD Direct Pass” Check 843. If the box is a box found in Mailboxes 201 group, then we set the “Alias—Envelope Layer” main result state to “PASS” and sub state to “FAKEPASS” 844 and then proceed to next layer check 845. We will be having mail score from 1 to 5. i.e. For each layer, if the result is “PASS”, the score is 1 will be applied. Mail Score will be explained in a later section. SAD is not applicable for Mailboxes 201. So we use “PASS” with “FAKEPASS” for Alias Layer in the box found in Mailboxes 201 to keep the score consistent.

FIG. 8F illustrates the logical flow of “Alias—Envelope layer—Direct Pass” check. Get “host part” of “MAIL FROM” command 851. e.g. example.com extracted from MAIL FROM:<john@example.com>. Get “dombox domain” of “RCPT TO” address 852. e.g. example.com extracted from RCPT TO:<example.com@giri123.domboxmail.com>[Note: At this point we also pull the SAD record from the “dombox domain” and store it in our session cache for Message SAD check]. Is the “Dombox Domain” matches with “MAIL FROM” domain? 853. If yes, we mark the “Alias—Envelope Layer” as Direct Pass 855 and then proceed to the next layer check 856. Because the “Envelope domain” is the “Dombox domain”. We set the Alias—Envelope layer main result state to “PASS” and sub state to “DIRECTPASS”. If no, then we proceed to the “Envelope SAD Indirect Pass” Check 854.

FIG. 8G illustrates the logical flow of “Alias—Envelope layer—Indirect Pass” check. Get “host part” of “MAIL FROM” command 851. e.g. buyfruits.com extracted from MAIL FROM:<john@buyfruits.com>. Get “dombox domain” of “RCPT TO” address 852. e.g. buyapples.com extracted from RCPT TO:<buyapples.com@giri123.domboxmail.com>. Is the “Dombox Domain” matches with “MAIL FROM” domain? 853. If yes, we mark the “Alias—Envelope Layer” as Direct Pass 855. If no, we fetch the SAD Record from “Dombox Domain” DNS. In our case buyapples.com DNS 861. DNS response would look like this. “v=sad1 buyfruits.com-all”. Is SAD Record found in DNS TXT Records? 862. If no, Reject mail for the recipient 863. If yes, check whether the “Envelope Domain” present in the SAD Record 864. In our case we check whether the domain buyfruits.com listed in the SAD Record. SAD Record would look like this. “v=sad1 buyfruits.com:r+b-all”. Get the “Envelope Domain” host configuration from the SAD Domains. In our case, Domain=>buyfruits.com. Config=>Relaxed Mode (r) and Both Mode (b). Check whether the “Envelope Domain” is allowed in the “Alias—Envelope Layer”. In our case we check whether buyfruits.com has envelope mode (e) or both mode (b). If the mode is neither “e” nor “b”, that means the “Envelope Domain” is not allowed in the “Envelope From”. Mark the Layer as “Envelope SAD Fail” 865 and then reject mail for the recipient 866. If the mode is either “e” or “b”, that means the “Envelope Domain” is allowed in the “Envelope From”. Mark the Layer as “Envelope SAD Indirect Pass” 867 and then proceed to next layer check 868. We set the “Alias—Envelope layer” main result state to “PASS” and sub state to “INDIRECTPASS”

FIG. 8H illustrates the logical flow of “Alias—Message layer—Fake Pass” check. Mail Sending Server (Client) issues the RCPT TO 513 command. e.g. RCPT TO:<giri@domboxmail.com>. At this stage, we pull the box type for the RCPT TO email address 871. In our case, we pull the “giri@domboxmail.com” address box type. We check whether the box is a Dombox 872. I.e. We check whether the box is a box found in the “Domboxes” 202 group. If the box type of that address is either Primary (P) or Mailbox (M), then this is a box found in “Mailboxes” 201 group. If the box type of that address is either Dombox (D), Hybrid (H) or Combox (C), then this is a box found in “Domboxes” 202 group. If the box is a box found in Domboxes 202 group, then we proceed to the “Message SAD Direct Pass” Check 873. If the box is a box found in Mailboxes 201 group, then we set the “Alias—Message layer” main result state to “PASS” and sub state to “FAKEPASS” 874 and then proceed to next layer check 875. This is because SAD is not applicable to boxes found in the Mailboxes group.

FIG. 8I illustrates the logical flow of “Alias—Message layer—Direct Pass” check. Get “host part” of “Message From” header 881. e.g. example.com<=From:<john@example.com>. Get “Dombox Domain” of “RCPT TO” address 882. e.g. example.com<=RCPT TO:<example.com@giri123.domboxmail.com>. Is the “Dombox Domain” matches with “Message From” header domain? 883. If yes, we mark the “Alias—Message Layer” as Direct Pass 885 and then proceed to the next layer check 886. Because the “Message From” domain is the “Dombox Domain”. We set the “Alias—Message layer” main result state to “PASS” and sub state to “DIRECTPASS”. If no, then we proceed to the “Message SAD Indirect Pass” Check 884.

FIG. 8J illustrates the logical flow of “Alias—Message layer—Indirect Pass” check. Get “host part” of “Message From” header 881. e.g. buyfruits.com<=From: John Doe <john@buyfruits.com>. Get “Dombox Domain” of “RCPT TO” address 882. e.g. buyapples.com<=RCPT TO:<buyapples.com@giri123.domboxmail.com>. Is the “Dombox Domain” matches with “Message From” header domain? 883. If yes, we mark the “Alias—Message Layer” as Direct Pass 885. If no, we fetch the SAD Record of “Dombox Domain” from the session cache (We already fetched the SAD for Envelope SAD check.). In our case buyapples.com 891. SAD Record would look like this. “v=sad1 buyfruits.com:r+b-all”. Get the “Message From” domain host configuration from the SAD Domains 892. In our case, Host=>buyfruits.com. Config=>Relaxed Mode (r) and Both Mode (b). Check whether the “Message From” domain is allowed in “Alias—Message Layer” 893. In our case we check whether buyfruits.com has message mode (m) or both mode (b). If the mode is neither “m” nor “b”, that means the “Message Domain” is not allowed in the “Message From”. Mark the Layer as “Message SAD Fail” 894 and then reject mail for the recipient 895. If the mode is either “m” or “b”, that means the “Message Domain” is allowed in the “Message From”. Mark the Layer as “Message SAD Indirect Pass” 896 and then proceed to next layer check 897. We set the “Alias—Message layer” main result state to “PASS” and sub state to “INDIRECTPASS”

4.7.8. Sender Alias Addresses (SAA)

Our Alias Layer deals with only the “domain” part of the “Envelope From” and “Message From” email addresses. I.e. Envelope Domain and Message Domain. The system can also configured to deal with full email addresses. In this case the “Dombox Domain” may authorize full email addresses via SAD. I.e. Sender Alias Addresses (SAA). E.g. “v=saa1 hello@example.com test@acme.com:e-all”

When the “Alias Layer” rely only on full email addresses, then the system will fail for the following reasons. Let's divide the SAA into two parts just like SAD. Envelope SAA and Message SAA.

Envelope SAA will fail primarily because third-party newsletter services like mailchimp uses Variable Envelope Return Path (VERP). I.e. The “Envelope From” email address will be unique for each and every recipient. And it's generated by the mailchimp system on the fly. It's really impossible for the domain owners to know these addresses beforehand. Here is an example VERP. bounce-mc.us3_7667677.3535173-domboxtester=gmail.com@mail144.atl221.rsgsv.net

You won't have this kind of problem in SAD. The VERP address would work flawlessly in SAD if it looks like this. “v=sad1 rsgsv.net:r+e-all” or “v=sad1 mail144.atl221.rsgsv.net:s+e-all”. The first SAD uses relaxed configuration. The second SAD uses strict configuration. So the mail will be accepted in both cases.

Message SAA will fail because (1) whitelisting each and every “Message From” address in the SAA is impossible for domain owners. (2) Bigger companies like amazon has plenty of “Message From” addresses for their domain amazon.com (3) It's really impossible to manually whitelist every new email addresses (4) The system needs to rely on signature mechanism like DKIM in order to prove “Message From” genuinity. (5) Unlike SPF, DKIM is complicated for non-tech savvy domain owners since it deals with Public and Private keys (6) DKIM signatures are included in the email Message Headers. So it can be stripped by a middle-man.

4.7.9. Receiver Policy Framework (RPF)

In Alias layer, Dombox Domain (Primary Subject) compares itself with “Envelope Domain” and “Message Domain”. And SAD Domains are pulled from the “Dombox Domain” DNS. A domain name is nothing but human readable network address. An IP address is a machine readable network address. A domain actually get translated to one or more IP addresses. I.e. The whole point of “SAD” is about identifying one or more “authorized servers” authorized to send mails for the “Dombox Domain”. So SAD record can be used for whitelisting (i.e. authorizing) “IP addresses” rather than “domains”.

When we use “IP addresses” for SAD, then it's nothing but a replica of “Sender Policy Framework (SPF)”. The only difference is that SPF is used in the “MAIL FROM” command. But SAD is associated with the RCPT TO. i.e. We pull the SAD record during the RCPT TO command using the “Dombox Domain”. So the standard can be termed as “Receiver Policy Framework (RPF)”. It has to be noted that, SPF record is only once per message 501. But we may have to pull RPF records multiple times since there will be multiple recipients 502.

Simply put, we are gonna pull a DNS record from the “Dombox Domain” as usual during RCPT TO command. But the SAD record (i.e. RPF record) will be a list of IP addresses rather than domain names. The “Client IP” 511 will be compared with the list of “Authorized IP addresses” provided by “Dombox Domain”.

We can use the exact SPF specification and SPF configuration for RPF. RPF record can be placed in this location. _rpf.domboxdomain.com

4.7.10. Sender Alias Hashes (SAH)

Rather than asking for domains and IP addresses, a system can be configured to ask for domain and IP hashes. In that case the system should be treated equally. Because Hash is being used here to mask the real information.

Real SAD: _sad.facebook.com=>“v=sad1 mailchimp.com instagram.com:r+m-all”.

Masked SAD: _sad.facebook.com=>“v=sad1 647c5fe1060e7ef85eb2733a230abff8 8dc6460bbbb088757ed67ed8fb316b1b:r+m-all”. 647c5fe1060e7ef85eb2733a230abff8 is the md5 hash of mailchimp.com. 8dc6460bbbb088757ed67ed8fb316b1b is the md5 hash of instagram.com

Real RPF: _rpf.facebook.com=>“v=rpf1 ipv4:127.0.0.1 ipv4:127.0.0.2-all”.

Masked RPF: _rpf.facebook.com=>“v=rpf1 ipv4:f528764d624db129b32c21fbca0cb8d6 ipv4:ab416c39d509e72c5a0a7451a45bc65e-all”. f528764d624db129b32c21fbca0cb8d6 is the md5 hash of 127.0.0.1. ab416c39d509e72c5a0a7451a45bc65e is the md5 hash of 127.0.0.2

Email Address:

In some cases, the service owner would like to allow only an email address via SAD. For example, the owner of acme.com has a mail address johndoe@gmail.com. We don't consider gmail.com as a valid SAD domain since that would allow every gmail user to send mail to the service. However, we can allow email addresses. “v=sad1 johndoe@gmail.com giri@gmail.com-all”. The last SAD record allows 2 email addresses. Since SAD records usually hosted in either DNS or a web server, anyone can see the email address, scrap it and send spam mails. So we accept email address as hashes rather than plain email addresses. i.e. “v=sad1 e:29a1df4646cb3417c19994a59a3e022a e:feb33ed1ca09bc74f6688e6fb5536aa1-all”. The “e” before the colon says that the hash is an email address hash.

4.7.11. Split SAD

Our Alias Layer contains two sub layers. Envelope Layer and Message Layer. We perform SAD check for Envelope Layer (Envelope SAD) and one more SAD check for Message Layer (Message SAD). We use a single DNS record to perform both checks. _sad.facebook.com=>“v=sad1 mailchimp.com instagram.com:r+m-all”. A system can go two different SAD records. One for Envelope SAD (ESAD) and one for Message SAD (MSAD). _esad.facebook.com=>“v=esad1 mailchimp.com-all”. _msad.facebook.com=>“v=msad1 instagram.com-all”

4.7.12. Authorization Hierarchy

Dombox Address: amazon.in@giri123.domboxmail.com

Dombox Domain: amazon.in

SAD Record: _sad.amazon.in=>“v=sad1 amazon.com amazon.co.uk-all”

Dombox mail address authorizes the domain amazon.in. Amazon.in authorizes additional domains via SAD. So from the “Dombox mail address” perspective, authorized domains are “amazon.in, amazon.com, amazon.co.uk”

OAuth based apps usually identified via Client ID. So the address structures might look like this. {ClientID}@domkey.domboxmail.com. In other words, there is no “Dombox Domain” here. So the SAD is directly linked here with the dombox mail address. Service Owner or Service Manager may provide the SAD while registering an oauth application.

4.8. Authentication Layer

This layer checks whether the mail is digitally signed and the digital signature valid. Technical Name: DomainKeys Identified Mail (DKIM). Possible Results: Pass or Neutral or Fail. Pass—Digitally Signed and Signature Verification Passed. Neutral—Digitally not Signed. Fail—Digitally Signed, but Signature Verification Failed. Note: This layer uses DKIM since it is the most popular one as of now. Identified Internet Mail (IIM) and Yahoo's DomainKeys were merged and formed the basis for DomainKeys Identified Mail (DKIM). So this layer shouldn't be limited to DKIM. Any cryptography-based signing and signature verification mechanism for validating mails applicable here.

4.8.1. Sample DKIM Public Key Query

The DKIM public key will be fetched from the “Signature Domain”. Sample DKIM public key query 523 illustrated in FIG. 5D

4.8.2. Authentication Layer Flowcharts

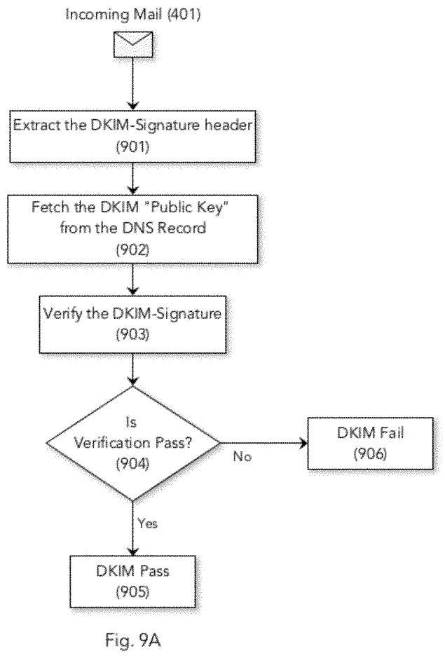

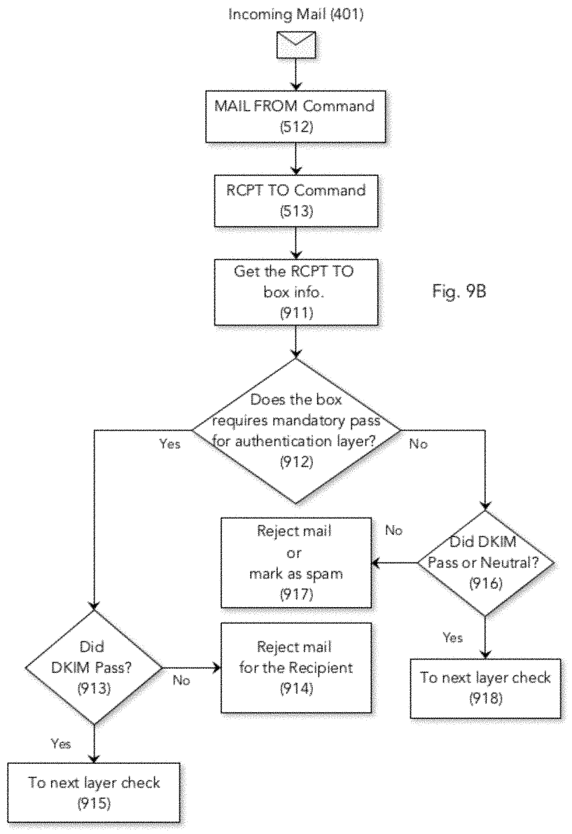

FIG. 9A illustrates the logical flow of DKIM. Extract DKIM-Signature 517 “Message Header” from the “Message Part” 901. If no DKIM-Signature found that means DKIM result is NEUTRAL.

DKIM-Signature: v=1; a=rsa-sha256; s=dev; d=example.com; c=simple/simple; q=dns/txt; h=Received:From:To:Subject:Date:Message-ID; bh={body hash goes here}; b={signature value};

Get the “d” (domain) tag value.=>example.com. Get the “s” (selector) tag value=>dev. Fetch the DKIM public key from the TXT record found in this path. {s tag value}. _domainkey.{d tag value} 902. i.e. dev._domainkey.example.com. Verify the DKIM-Signature using the public key 903. Is verification passed? 904 If yes DKIM Pass 906. If no, DKIM Fail 905

FIG. 9B illustrates the logical flow of Authentication layer check. An incoming mail 401 from the sender begins the MAIL FROM 512 command. Mail Sending Server (Client) issues the RCPT TO 513 command. e.g. RCPT TO:<example.com@giri123.domboxmail.com>. At this stage, we pull the box type for the RCPT TO email address 911. In our case, we pull the “example.com@giri123.domboxmail.com” address box type. If the box type of that address is either Hybrid (H) or Combox (C), then this box requires “mandatory pass” for Authentication layer. So at this stage, we check whether the box requires mandatory pass or not for authentication layer 912. If the box require “mandatory pass” for authentication layer, then we check whether DKIM passed or not 913. If DKIM has passed then we can proceed to the next layer check 915. If DKIM has not passed then we reject the mail 914. If the box doesn't require “mandatory pass” for authentication layer, then we check whether DKIM passed or Neutral 916. If DKIM has passed or Neutral then we can proceed to the next layer check 918. If DKIM has not passed or neutral, then we can either reject mail or mark the mail as spam 917.

4.9. Alignment Layer

Checks whether “Envelope Domain and/or Signature Domain” is aligned with “Message Domain”. Technical Name: Domain-based Message Authentication, Reporting and Conformance (DMARC). Possible Results: Pass or Neutral or Fail. Pass—Domains are aligned. Neutral—Domains are not aligned, but the “Message Domain” either has “No Objection” or no valid DMARC record found in the “Message Domain”. Fail—Domains are not aligned and the “Message Domain” has “Objection”

“You can send mails for the domain you don't own”. That's what the third-party newsletter services like mailchimp doing right?. So what's stopping the spammers from misusing your domain? If you own a domain called abcd.com, what's stopping spammers from sending “Viagra” mails from email address like no-reply@abcd.com?. This is called Email Spoofing. Many spammers use the spoofing method to send Phishing mails. Companies like PayPal had been a major victim of Phishing mails in the past. Companies like PayPal, your banking website etc. can't afford when spammers misuse their domain. Hence DMARC came to the rescue.

This layer protects the “Message Domain”. This Layer is all about 3 domains too. In Alias Layer, Dombox Domain (Primary Subject) compares itself with “Envelope Domain” and “Message Domain”. Purpose: To “Allow” third party domains. Just like that, In Alignment Layer, Message Domain (Primary Subject) compares itself with “Envelope Domain” and “Signature Domain”. Purpose: To “Deny” third party domains.

When all three domains look exactly the same, then it's already aligned. We just accept the mail. But if there is even a small change (e.g. subdomain) or completely different domains used, then we need to ask the “Message Domain” about how we should treat the mail. If there is no DMARC record found in the “Message Domain” DNS, then the ball is in our court. So we use our version of the book to play the game. If a DMARC record found in the “Message Domain” DNS, then we should treat the mail as they say. This is called DMARC policy. The policy can be one of the three things. None, Quarantine or Reject

Policy: None, Meaning: Do whatever you want. Policy: Quarantine, Meaning: Put in the spam folder. Policy: Reject, Meaning: Reject the mail immediately

The following DMARC record is what PayPal has in its DNS at this location=>_dmarc.paypal.com

“v=DMARC1; p=reject; rua=mailto:d@rua.agari.com; ruf=mailto:d@ruf.agari.com”

We actually wanted to call this layer as “Objection Layer”. This is because, this layer is all about asking a question to the “Message Domain”. Hey “Message Domain”, The domains are not aligned. But our server is going to accept this mail. Do you have any objection? The response will be one of the following.

(i) Policy: None, Meaning: I have no objection, Result: No Objection. (ii) Policy: Quarantine, Meaning: Yes I have objection . . . Put in the spam folder, Result: Objection. (iii) Policy: Reject, Meaning: Yes I have objection . . . Reject the mail immediately, Result: Objection. (iv) Policy: No Record, Meaning: I don't know what you are talking about, Result: No Objection

From the last table, we can come to a conclusion, a “Message Domain” can have either objection or no objection. We can mark this layer as “Pass” when domains are aligned. We can mark this layer as “Fail” when the “Message Domain” has “Objection”. i.e. Quarantine or Reject. We can mark this layer as “Neutral” when the “Message Domain” has “No Objection”. i.e. None or No Record.

However, we need a small change for the incoming mails to the boxes found in “Domboxes” group. In Domboxes, We should mark this layer as “Pass” when the “Message Domain” has “No Objection”. i.e. None or No Record. As of 2018, 332 million domains are registered so far. In “Mailboxes” case, receiving mails is like opening a can of worms. The DMARC is the “Iron Grip”. So it gives us clarity. i.e. 332 million domains can send mails to the mailbox. In “Domboxes” case, only the “Dombox Domain” and it's SAD Domains can send mails to the Dombox. So we are talking about only a handful of domains here. But still, we need to make sure that the Message Domain has no Objection, before accepting the mail. For example, if a domain owner configured SAD record like this “v=sad1 paypal.com:r+m-all”, then we shouldn't just take his word for it. So if there is no DMARC record found in the “Message Domain”, then we take the “Dombox Domain” owner's word for it. Because we are hoping they won't ruin their domain reputation by whitelisting domains in their SAD record for email spoofing. Our point is that “Alignment Layer” can be “Neutral” in “Mailboxes”. But can't be in “Domboxes”. Because if there is no DMARC record found or None value configured then we just accept the mail by marking the result as “Pass”

4.9.1. Sample DMARC Record Query

The DMARC record will be fetched from the “Message Domain”. Sample DMARC record query 524 illustrated in FIG. 5D

4.9.2. Alignment Layer Flowcharts

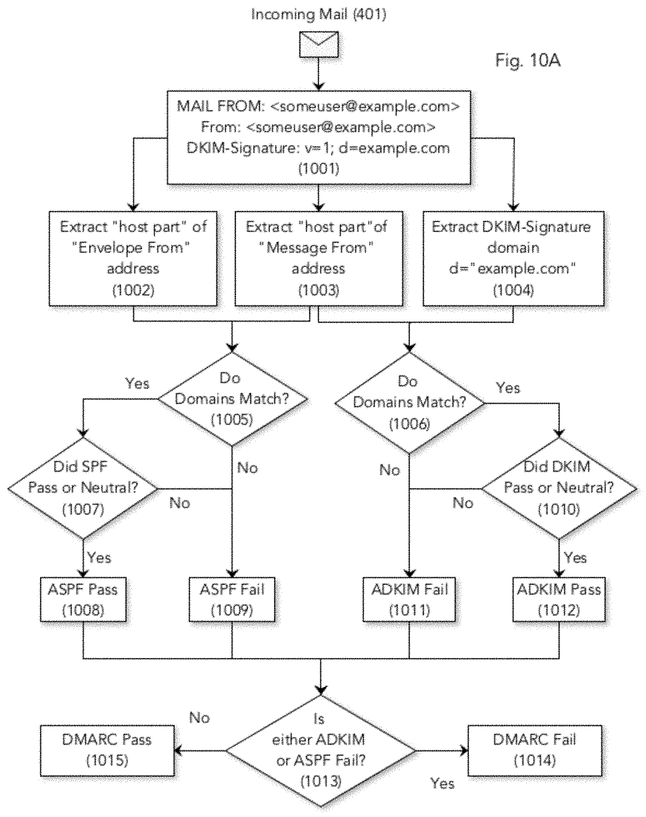

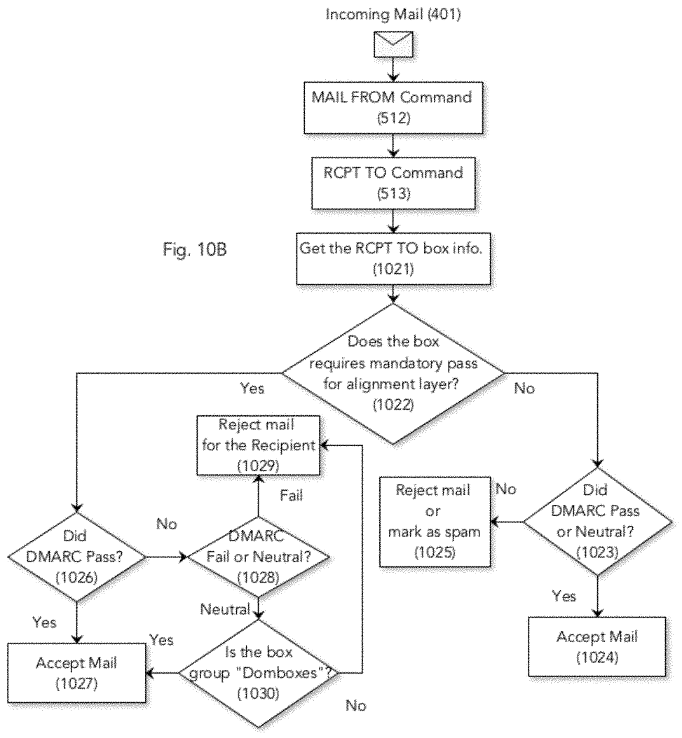

FIG. 10A illustrates the logical flow of DMARC. An incoming mail 401 with “Message From” address “someuser@example.com” 1001 is checked with DMARC. Get “host part” of “Message From” 1003 header. e.g. example.com<=From:John <someuser@example.com>. Check whether a valid DMARC record exists in “Message From” domain in this path. _dmarc.{Message From Domain}. e.g. _dmarc.example.com. If a valid record not exists, then DMARC result is NEUTRAL. Get the “Host Part” from “Envelope From” 1002. Get the “Host Part” from “Message From” 1003. Get the “d” (domain) tag value of DKIM-Signature. 1004. Is the “Envelope Domain” matches “Message Domain”? 1005. If No, SPF is not Aligned 1009. If Yes, Check for SPF Result 1007. If Pass or Neutral, SPF is Aligned (ASPF Pass) 1008. If Fail, SPF is not Aligned (ASPF Fail) 1009. Is the “Message Domain” matches “Signature Domain”? 1006. If No, DKIM is not Aligned. 1011. If Yes, Check for DKIM Result 1010. If Pass or Neutral, DKIM is Aligned (ADKIM Pass) 1012. If Fail, DKIM is not Aligned (ADKIM Fail) 1011. Is either ADKIM or ASPF Fail? 1013. If Yes, DMARC Fail 1014. If No, DMARC Pass 1015.

FIG. 10B illustrates the logical flow of Alignment layer check. An incoming mail 401 from the sender begins the MAIL FROM 512 command. Mail Sending Server (Client) issues the RCPT TO 513 command. e.g. RCPT TO:<example.com@giri123.domboxmail.com>. At this stage, we pull the box type for the RCPT TO email address 1021. In our case, we pull the “example.com@giri123.domboxmail.com” address box type. If the box type of that RCPT TO address is either Hybrid (H) or Combox (C), then this box requires “mandatory pass” for Alignment layer. So at this stage, we check whether the box requires mandatory pass or not for alignment layer 1022. If the box require “mandatory pass” for alignment layer, then we check whether DMARC passed or not 1026. If DMARC has passed then we can proceed to accept the mail 1027. If DMARC has not passed then we check whether the DMARC result is Fail or Neutral 1028. If the DMARC result is “Fail”, then we reject the mail for the recipient 1029. If the DMARC result is “Neutral”, then we check whether the box group is “Domboxes” 1030. If the box group is “Domboxes” then we accept the mail 1027. If not we reject the mail 1029. If the box doesn't require “mandatory pass” for alignment layer, then we check whether DMARC passed or neutral 1023. If DMARC has passed or Neutral then we can proceed to accept the mail 1024. If DMARC has not passed then we can either reject mail or mark the mail as spam based on the policy provided by the DMARC Record 1025.

4.10. Possible Results

(i) Encryption Layer—Pass: Yes, Neutral: No, Fail: Yes. (ii) Authorization Layer—Pass: Yes, Neutral: Yes, Fail: Yes. (iii) Alias Layer—Pass: Yes, Neutral: No, Fail: No. (iv) Authentication Layer—Pass: Yes, Neutral: Yes, Fail: Yes. (v) Alignment Layer—Pass: Yes, Neutral: Yes*, Fail: Yes

* Not Applicable for the boxes found in “Domboxes”

(1) The Encryption Layer 421, checks whether the incoming message is encrypted or not. This layer uses TLS protocol. Encryption Layer Result Main state can be either PASS or FAIL. There is no sub state available for Encryption Layer. (2) The Authorization Layer 422, checks whether the mail sending server is authorized to carry the message or not for the “Envelope Domain”. This layer uses a standard called Sender Policy Framework (SPF). Authorization Layer Result Main state can be either PASS, NEUTRAL or FAIL. NEUTRAL state can have one of the following sub-states: NONE, NEUTRAL. FAIL state can have one of the following sub-states: FAIL, SOFTFAIL, TEMPERROR, PERMERROR. (3) The Alias Layer 423, checks whether the “Envelope Domain” and “Message Domain” are authorized alias for the “Dombox Domain”. This layer uses our proprietary standard called Sender Alias Domains (SAD). This layer contains two sub layers. Envelope Layer 424 and Message Layer 425. (3a) The Alias—Envelope Layer 424, checks whether the “Envelope Domain” is an authorized alias for “Dombox Domain”. The Alias—Envelope Layer Result main state can be one in the following. PASS or FAIL. PASS state can have one of the following sub-states: FAKEPASS, DIRECTPASS, INDIRECTPASS. (3b) The Alias—Message Layer 425, checks whether the “Message Domain” is an authorized alias for “Dombox Domain”. The Alias—Message Layer Result main state can be one in the following. PASS or FAIL. PASS state can have one of the following sub-states: FAKEPASS, DIRECTPASS, INDIRECTPASS. The overall Alias Layer 423 result depends on the sub layer results. If one sublayer result is fail, then the overall Alias Layer 423 result is Fail. Note: Alias Layer can have only “PASS” result. When the layer result is “FAIL”, mail will be rejected. Mail may be accepted only in development/testing mode when the result is FAIL. (4) The Authentication Layer 426, checks whether the mail is digitally signed by the sending server. This layer uses the standard DomainKeys Identified Mail (DKIM). Authentication Layer Result main state can be one in the following. PASS, NEUTRAL or FAIL. NEUTRAL state can have the following sub state: NONE. FAIL state can have one of the following sub-states: FAIL, TEMPERROR, PERMERROR. (5) The Alignment Layer 427, checks whether the “Message Domain” is aligned properly with SPF Domain and DKIM domain. If not aligned, then it applies the policy fetched from the “Message Domain”. This layer uses a standard called “Domain-based Message Authentication, Reporting and Conformance (DMARC)”. Alignment Layer Result main state can be one in the following. PASS, NEUTRAL or FAIL. There is no sub state available for Alignment Layer.

4.11. SPF vs DKIM vs DMARC

All these three mechanisms are widely used to combat email spoofing. There is a misconception that SPF, DKIM and DMARC helps the receiver to combat email spam. That's not true. All three mechanisms are open standards. So any domain owner can deploy them since they are free. That means a spammer can deploy them too. If a domain get blacklisted, then spammers would go for new domain. You can register domains for free these days. Freenom offers free domains for the following extensions. .tk, .ml, .ga, .cf, .gq. When a domain owner configures those three mechanisms in their domain, then scammers cannot misuse that domain. SPF is Direct Mechanism.

DKIM is Indirect Mechanism. DMARC is Complimentary. SPF would work only for direct flow. e.g. accounts@paypal.com sends an email to johndoe@gmail.com. PayPal whitelisted the following IP addresses in their SPF record. {100.100.100.100, 200.200.200.200}. PayPal sends that mail from the IP address 100.100.100.100. gmail.com verifies SPF and it is a pass. But what happens when johndoe@gmail.com enabled “mail forwarding” and asks gmail to forward his incoming mails to johndoe@yahoo.com? When we mean “mail forwarding” we are talking about the “server forwarding” here, not the “Forward” option you see in the email clients/apps. When a mail gets forwarded from gmail.com to yahoo.com server, the sender IP will be the gmail.com IP address. Not paypal.com IP address. So the SPF would fail. Mailing list/Discussion list heavily relies on “mail forwarding”. So there is a need for “Indirect” mail spoof prevention mechanism. That's where DKIM comes to play. SPF deals with “Envelope Part”. DKIM deals with the “Message Part”. DMARC deals with SPF and DKIM results. In other words, DMARC alone cannot able to combat email spoofing. It needs to rely on at least SPF or DKIM in order to work. The more the merrier here. Meaning, you should always configure both SPF and DKIM before deploying DMARC for better coverage. However, DMARC can work with only one method too.

5. Mail Score

Our “Layers” component contains 5 layers. Encryption Layer, Authorization Layer, Alias Layer, Authentication Layer, Alignment Layer. One point will be given for each layer if the result is “Pass”

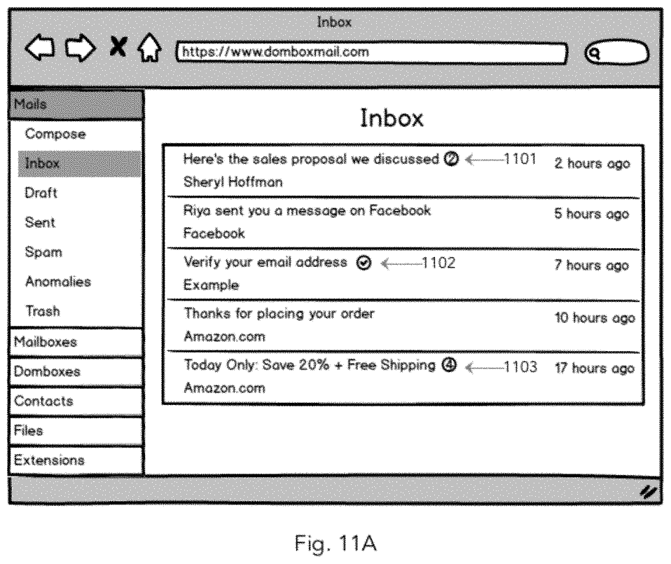

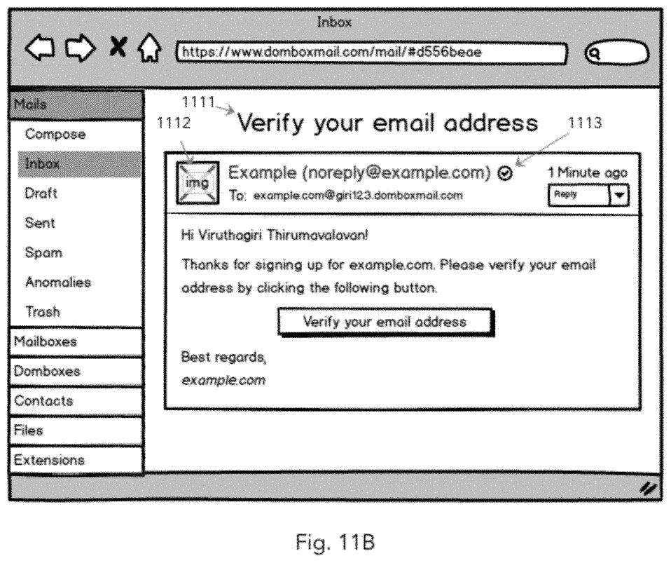

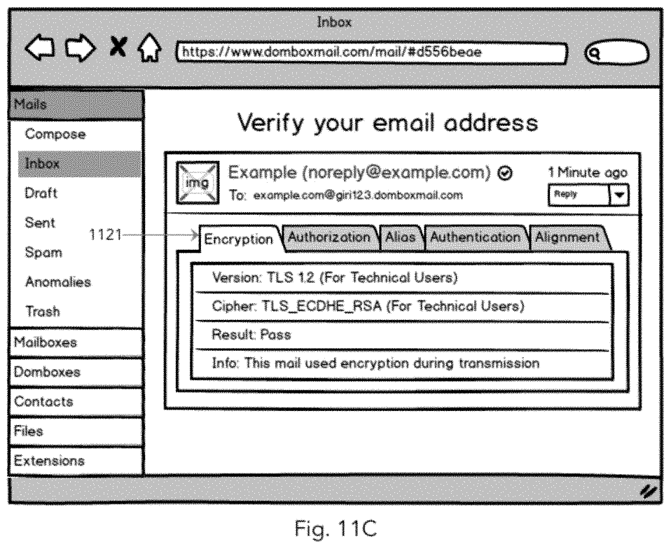

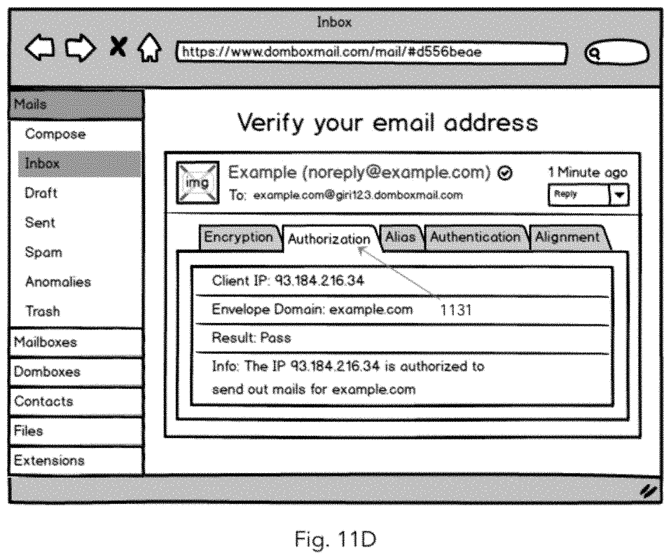

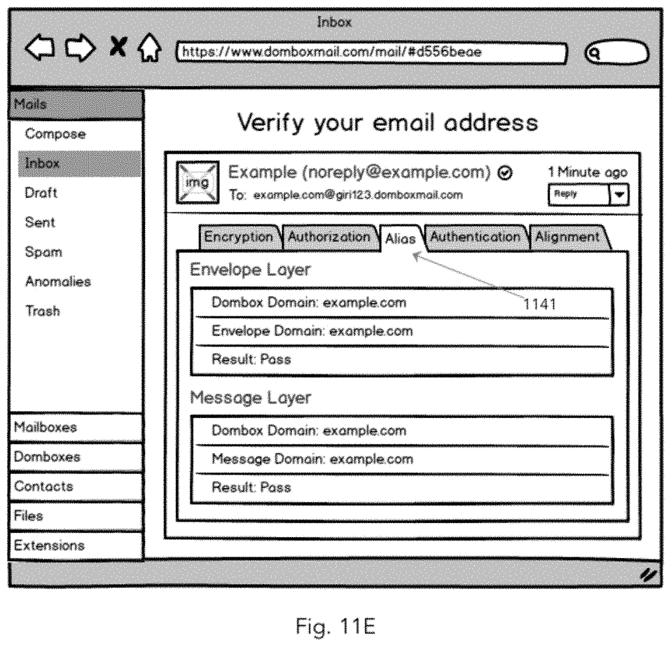

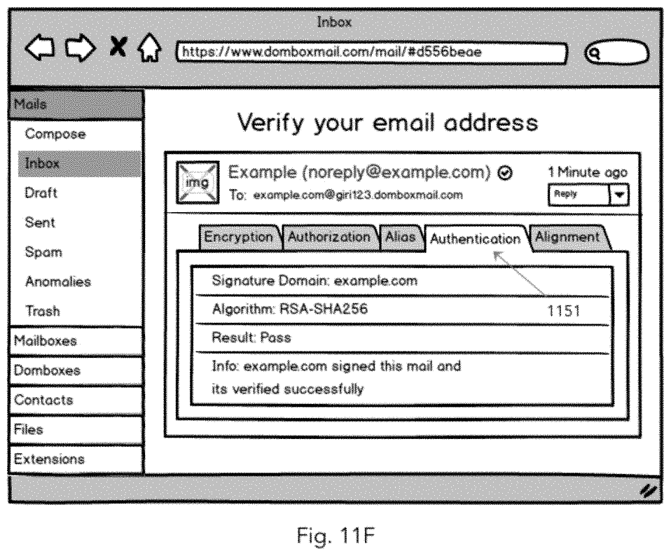

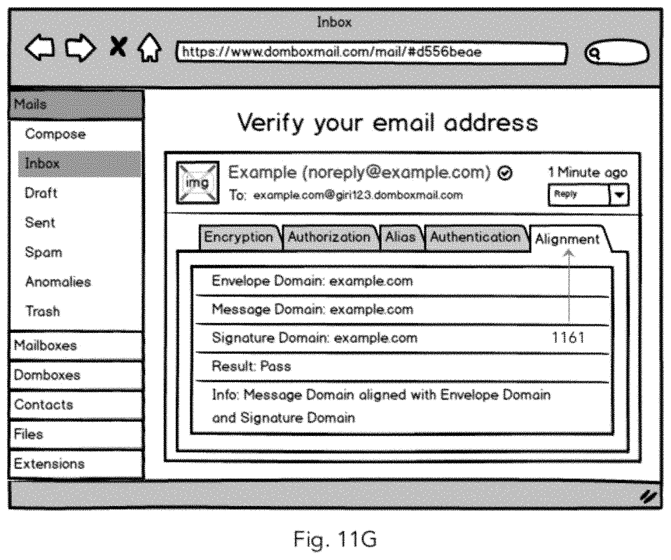

FIG. 11A illustrates the “Mail Inbox” page layout with mail score. The mail score is displayed right next to the mail subject in the mail inbox layout. We will be displaying the score in each mail. If you click the score, you can view detailed info. Keep in mind, the score can be from 1 to 5 {Note: Alias Layer will always have the “Pass” value. So the minimum possible score is one.} For example, If Encryption layer and Alias layer results are “Pass”, but Authorization layer, Authentication layer and Alignment layer results are “Neutral”, that means the score is 2. This will be displayed right next to email subject 1101. A score of 2 means, 2 layers passed. But that doesn't mean 3 layers failed. Because these three layers can also be “Neutral”. When the score is “5”, a “Green Checkmark” will be displayed instead of the score “5” i.e. If all five layer results are “Pass”, then instead of showing the score 5, we display a green check mark icon 1102. If you see the score in “Green Circle”, that means the layer results contains only “Pass” and “Neutral” values. If at least one layer result is “Fail”, then the score will be shown in “Red Circle”. Be sure to check the info by clicking the score. By giving a score to each mail, we bring “transparency” to the user. Now users can question the website owners why they are not supporting those layers. For example, if your banking website doesn't support “Encryption Layer”, then you have every right to question them. If you are a website owner, most likely you want your users to see the “Green Checkmark”. So we are also encouraging the website owners to support all 5 layers. Note: Mail Score is applicable only for “Incoming” mails

Note: Our method displays the positive score. A score of 2 means, 2 layers passed. But that doesn't mean 3 layers failed. Because these three layers can also be “Neutral”. A method can also display only negative score. I.e. A score of −3 means, 3 layers failed. But that doesn't mean 2 layers passed. Because these two layers can also be “Neutral”.

FIG. 11B illustrates the “View Mail” page layout. In “View Mail” page, subject is displayed at the top 1111, avatar is displayed in the left 1112 and the mail score is displayed right next to the sender name 1113. If the mail passed all five layers, then check mark icon 1102 will be displayed otherwise mail score will be displayed in numbers 1103. The value can be from 1 to 5. But since we are displaying the check mark icon for the value 5, the possible values are from 1 to 4.

FIG. 11C illustrates the “View Mail—Encryption Info” page layout. When the user clicks the mail score 1113, the mail content will be hidden and the mail score details for each layer will be displayed. The Encryption tab 1121 displays the Encryption layer info like SSL/TLS version, Cipher, Encryption Layer result.

FIG. 11D illustrates the “View Mail—Authorization Info” page layout. The Authorization tab 1131 displays the Authorization layer info like Client IP, Envelope Domain, Authorization Layer result.

FIG. 11E illustrates the “View Mail—Alias Info” page layout. The Alias tab 1141 displays the Alias layer info. Alias Layer contains two sub layers. Envelope Layer and Message Layer.

Envelope Layer section in Alias tab contains Dombox Domain, Envelope Domain and the Envelope Layer result. Message Layer section in Alias tab contains Dombox Domain, Message Domain and the Message Layer result.

FIG. 11F illustrates the “View Mail—Authentication Info” page layout. The Authentication tab 1151 displays the Authentication layer info like Signature Domain, Signature Algorithm and Authentication Layer result.

FIG. 11G illustrates the “View Mail—Alignment Info” page layout. The Alignment tab 1161 displays the Alignment layer info like Envelope Domain, Message Domain, Signature Domain and Alignment Layer result.

6. Box Types

FIG. 2B illustrates the box types. The group “Mailboxes” 201 divided into two types. Primary (P) 211 and Mailbox (M) 212. The group “Domboxes” 202 divided into three types. Dombox (D) 213 and Hybrid (H) 214 and Combox (C) 215. A user account can have only one Primary (P) box. A user account can have unlimited Mailbox (M) boxes, Dombox (D) boxes, Hybrid (H) boxes and Combox (C) boxes.

Each box type designed for a different purpose. (i) Primary (P)—To have a “Normal Mailbox” that works exactly like Gmail. (ii) Mailbox (M)—To use as a 3rd party Mail Client. e.g. @gmail.com & To use as a 3rd party mail server. e.g. @yourcompany.com (iii) Dombox (D)—To let consumers have control over the “Isolated Mailbox”. (iv) Hybrid (H)—To provide “One-Click” newsletter subscription service. (v) Combox (C)—To let businesses have control over the “Isolated Mailbox”

6.1. Must Pass Layers

FIG. 4B illustrates the mandatory pass layers for each box type. “mandatory pass” means the layer result must be “PASS” to accept mail.

6.2. Box Features

Boxes come with the following features.

Make Offline 1532—When a box is offline, it can't be able to accept any new mails.

Delete 1533—When a box gets deleted, only the box mail address will be lost. But the mails can still be browsed via “Unified Mails” page (Refer FIG. 11A). The mails can be recovered if you recreate the box. And yes, a deleted box can't be able to accept any new mails.

Format 1534—Bulk deletes all the mails found in a particular box. Applicable only for Domboxes. {Normal Mailboxes usually contains Conversational Mails which are very important. So Format option not available in Normal Mailboxes}. To completely delete the box along with its mails, you must “format” the box first and then use the “delete” option.

Mute 1536—Prevents annoying mail notifications. Mail will be accepted but you won't be notified when a box is “Muted”.

Subscribe 1537—When a user is “Subscribed” to the box, the user is voluntarily asking the domain to send newsletters/promotional mails.

Unsubscribe 1538—This option helps you with the unsubscription nightmare. When a user is “Unsubscribed” to the box, the user is asking the site, not to send any newsletters/promotional mails. When the box status is “Unsubscribed” and our system find any new mails with “List-Unsubscribe” header and/or “Unsubscribe” link at the mail footer, then we automatically try to unsubscribe on behalf of the user and then instantly move the mail to the “Trash” folder. If a domain sends Promotional emails without “Unsubscribe” link, then they are breaking the law.

Set Password 1539—Applicable only to Domboxes. Since boxes found in the Domboxes group are isolated for a single domain, we can use the box as a password manager for that domain. For example, if the consumer create a Dombox for example.com, then we should allow the consumer to generate a random password for that domain. The password will be uniquely generated for that domain. So the consumer can give that password while signing up to that domain. This prevents the password reuse in all websites. The consumer can generate the password with the help of browser extensions.

Nuke—Applicable only to Domboxes. This option combines Delete 1533 and Format 1534 option. I.e. Completely erases everything related to that particular Dombox.

6.3. Inbox

Inbox can be classified into two types. (1) Global Inbox (2) Local Inbox

6.3.1. Global Inbox

FIG. 11A illustrates the “Global Inbox” page layout. “Global Inbox” is also known as “Master Inbox”. This is equivalent to the “inbox” found in other services. “Global Inbox” contains aggregated mails from all 5 box types. So it's a unified mail inbox. In other words, both Mailboxes 201 and Domboxes 202 mails can be found on this page. All mails are ordered by date and time. Recent mails will be displayed first. The mails menu you see on FIG. 11A contains aggregated mails from all 5 box types for all sections like Inbox, Draft, Sent, Spam, Anomalies, Trash. So the mails are “Unified” there.

6.3.2. Local Inbox

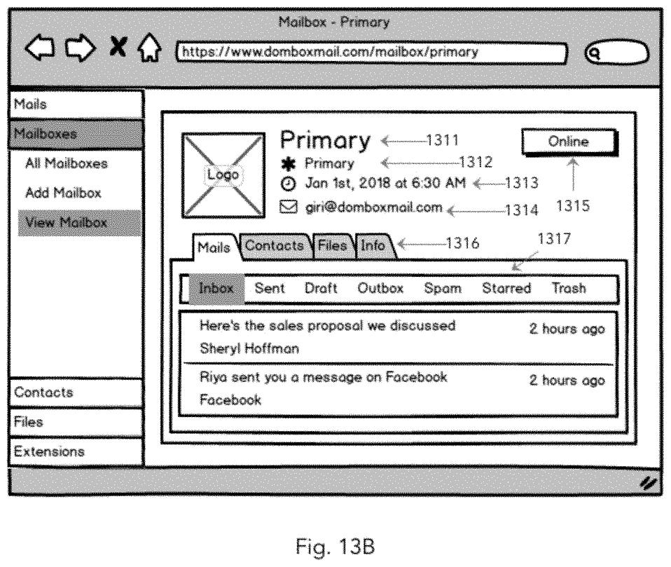

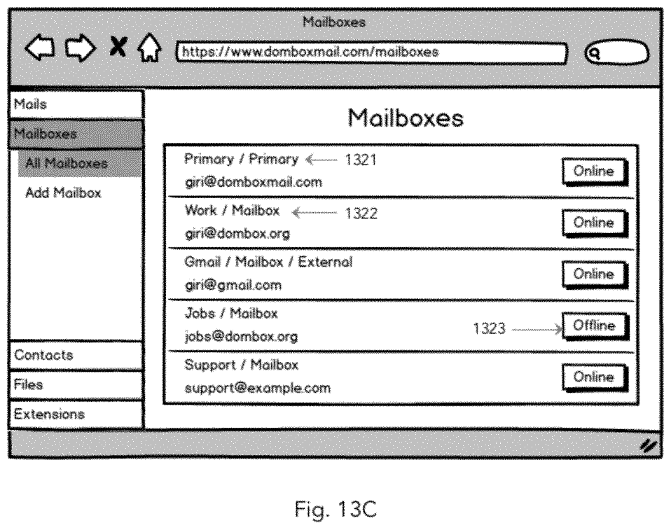

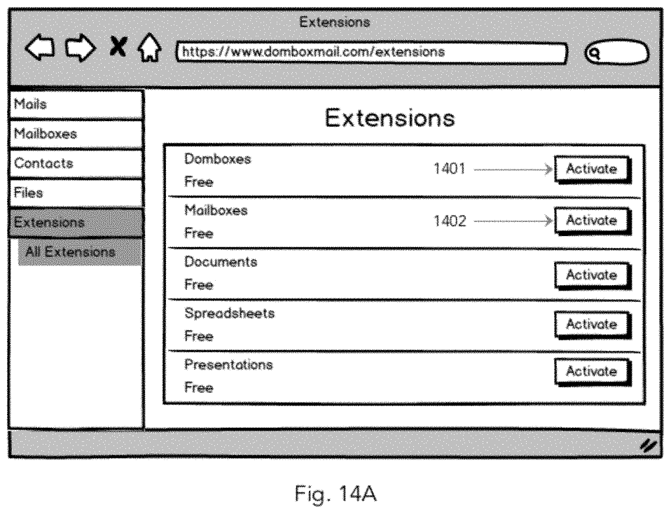

FIG. 13B illustrates the “Local Inbox” page layout. This is the inbox found in the individual box. In “Local Inbox” you can browse only that particular box mails. Mails can be browsed from the Individual box page (Refer FIG. 13B) as well as from the “Mails” menu (Refer FIG. 11A). If the user wants to browse the individual box mails then they have to go to “View Box” page. FIG. 13B shows a sample “View Box” page.

6.4. Box Type: Primary (P)

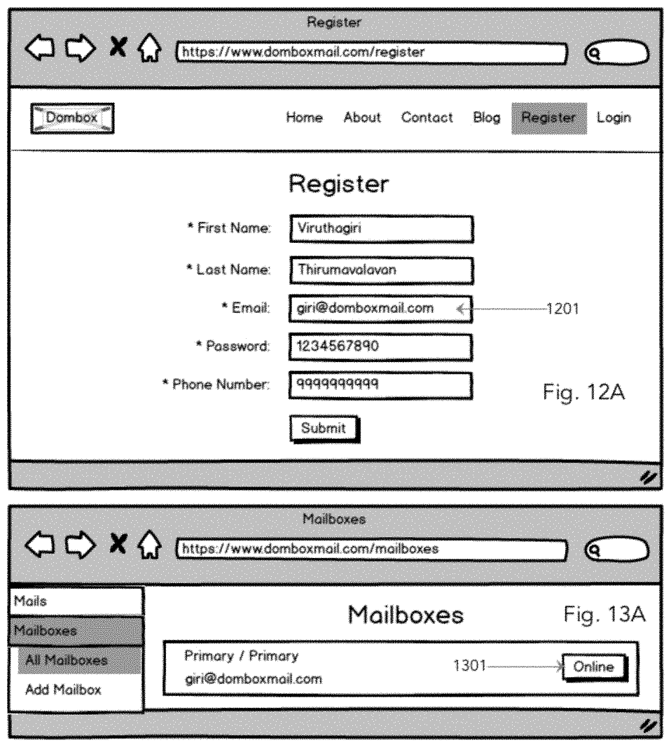

The Box Type Primary (P) 211 refers to the email address user picked while registration 1201. A user can have only one email address as Primary (P) box. Primary (P) box address should be used as username for logging in. Primary (P) box CANNOT be deleted by the user. Primary (P) box address should be used only for real conversations. (e.g. Sending mail to your family, friends, colleagues etc.). You can have only one box of this type. Whereas in other box types you can have unlimited boxes. This “only one box” is called “Primary” box. In our mail service, the “Primary” box is equivalent to your @gmail address. But you should use that only for real conversational mails. If you are not planning to use our “Domboxes” feature, then you are welcome to use your Primary box for all type of mails (like Gmail). This is the box type you get when you sign up for our mail service. You can get this box via signup form 1201. Must Pass Layers: None. Note: Although there is no requirement for “Pass” in this box type, that doesn't mean mail will be accepted when all layers are failed. FIG. 12A illustrates the registration form where Primary email address can be picked. This Primary email address will be used as username to log into the Dombox mail system. Domkey also can be used to log into the Dombox mail system since it's unique per account.

6.5. Box Type: Mailbox (M)

Mailbox (M) 212 boxes are additional “Normal Mailboxes”. This box type usually requires a nominal fee. For most users, there won't be a need for this box type. Only the “Primary” box is enough. A “box” found in Mailboxes group is called “Mailbox”. The term “Mailbox” always refers to any box found in “Mailboxes” group. Since Primary (P) is also a box type found under mailboxes group, we can call it a Mailbox. Since the term “Mailbox” already refers to any box found in the Mailboxes Group, we use the letter M in parentheses to indicate “Mailbox Box Type”. In other words, “Mailbox” refers to ANY Box found in “Mailboxes” Group. But “Mailbox (M)” refers to the Box Type found in “Mailboxes” Group. This box type can behave in two ways. (1) As a Mail Server (2) As a Mail Client. To get this box, Activate our “Mailboxes” extension and then use the “Add Mailbox” link found in the sidebar menu. Must Pass Layers: None.

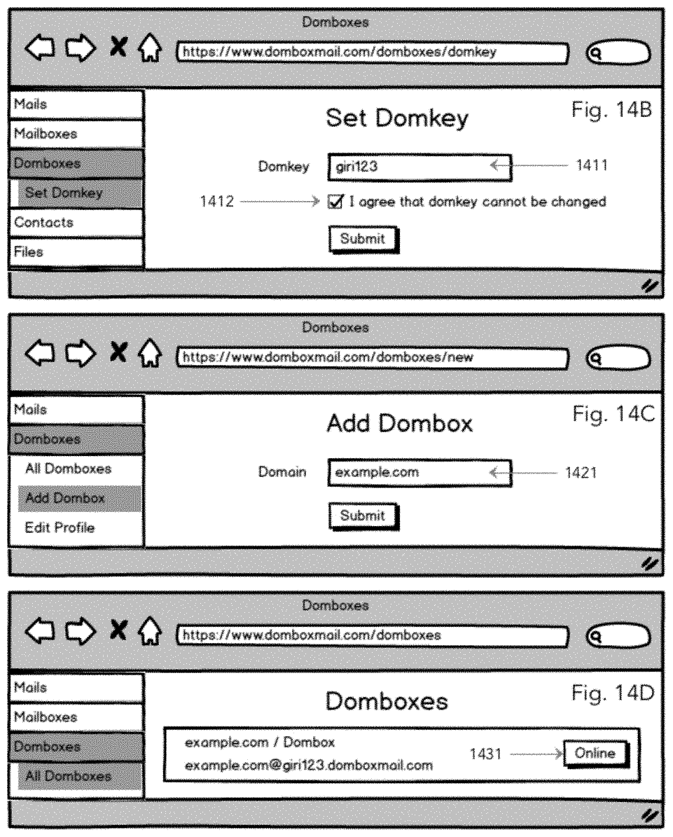

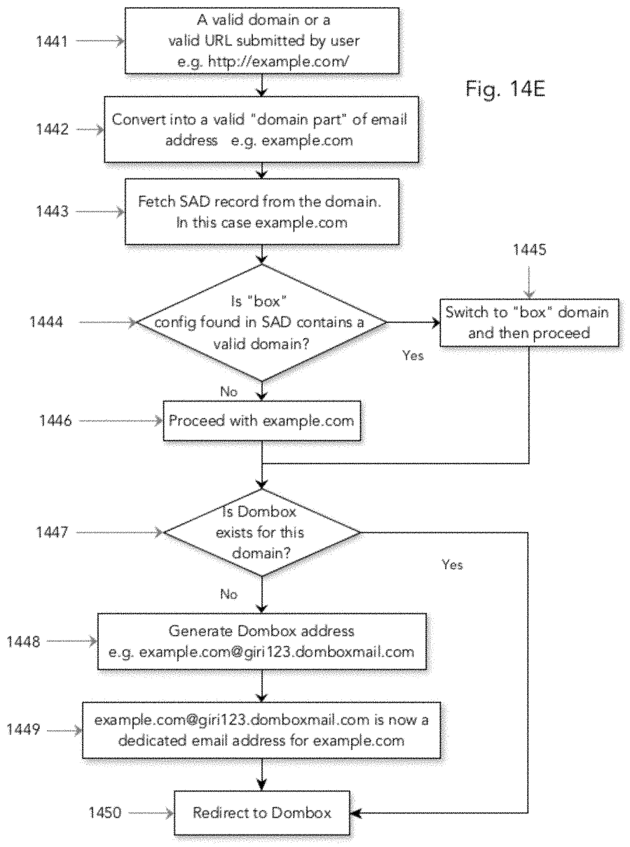

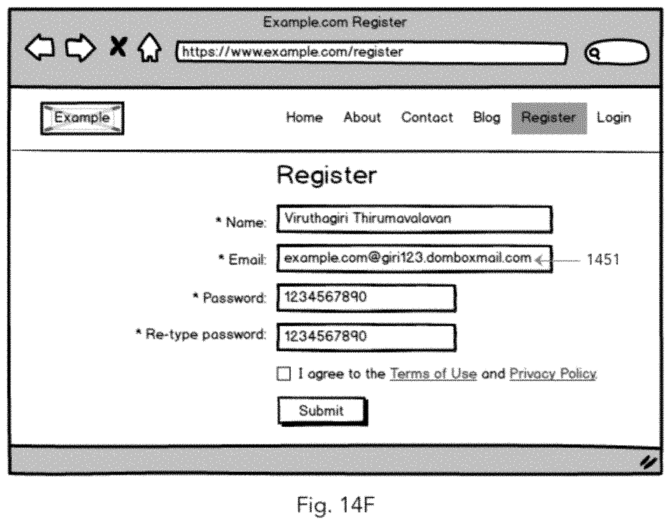

FIG. 14A illustrates the extensions page layout. Unlike other mail systems, Dombox mail system is a module based system. More features and apps will be provided as modules. We call them Extensions. To view and browse the boxes found in mailboxes 201 group, user need to activate 1402 “Mailboxes” extension.

FIG. 13A illustrates the “All Mailboxes” page layout. When Mailboxes extension activated 1402 there will be a new menu called “Mailboxes” in the sidebar. Mailboxes page lists the boxes found in the Mailboxes 201 group. i.e. This page contains all the boxes that has the following box types. Primary (P) 211 and Mailbox (M) 212. Since the Primary (P) box already created via registration form 1201, FIG. 13A shows the Primary (P) box giri@domboxmail.com

All boxes in the Dombox mail system regardless of its box type can be either “Online” or “Offline”. When a box is “Online” it means the box is active and accepting mails from others. When a box is “Offline” it means the box is inactive and not accepting mail from others. Primary (P) box can have only “Online” 1301 status. In other words it cannot go offline. Mailbox (M), Dombox (D) and Hybrid (H) box status can be either “Online” or “Offline”. Combox (C) box type can have only “Online” status. In other words it cannot go offline.

FIG. 13B illustrates the “View Mailbox” page layout. View Mailbox page contains Box Label 1311, Box Type 1312, Box created date 1313, Box mail address 1314, Box status 1315, Box Main Tabs 1316 and Sub tabs 1317. If the user want to browse individual box mails, they should do it in the Mails tab found in the Box Main Tabs 1316.

FIG. 13C illustrates the “All Mailboxes” page layout after adding more boxes. The mailboxes page contains 4 Mailbox (M) 212 type boxes. The box with Primary label 1321 is a Primary (P) 211 box. The labels 1322 Work, Gmail, Jobs and Support are Mailbox (M) 212 box types. The box with “Jobs” label is offline 1323. It means that box is not accepting any mail. The box with “Gmail” label is used as “Mail Client”. Since the mails are handled by an external server the tag “External” is applied.

6.5.1. As a Mail Server

This is similar to Google's business mail service. You can have mailbox address like @yourdomain.com. Keep in mind, you must be a domain owner/domain admin and you must have access to your domain DNS. You have to verify your domain first and then add MX records like mx1.domboxmail.net, mx2.domboxmail.net and mx3.domboxmail.net in your DNS. In this case, our mail service act as a “Mail Server”.

6.5.2. As a Mail Client

This works similar to “Mozilla Thunderbird” or a mail client found in your mobile. Keep in mind, you need to already have an Email Account and then add that account here as a “Mailbox (M)” box type. You can add ONE third party mail account for free. It can be @gmail.com, @yahoomail.com, @outlook.com or even @yourcompany.com. As long as your original mail server support protocols like POP3, IMAP or Mail Forwarding, you are good to go. We will be using protocols like POP3, IMAP, OAuth for fetching the initial mails and then the “mail forwarding” option for the new mails. This let them gradually degrade their old mail account. For example, if they had signed up for twitter.com with their old @gmail.com address, they can create a “Dombox” now for twitter.com and then update the email address in their twitter account settings page. That way they can still use @gmail.com in our mail service, but offload the Transactional and Promotional Mails to the Isolated Mailboxes.

6.6. Box Type: Dombox (D)

Since the term “Dombox” already refers to any “box” found in the Domboxes Group, we use the letter D in parentheses to indicate “Dombox Box Type”. In other words, “Dombox” refers to any box in “Domboxes” Group. But “Dombox (D)” 213 refers to the Box Type found in “Domboxes” Group. “Dombox (D)” boxes CAN be deleted by the user at anytime.

6.7. Box Type: Hybrid (H)

The term “Hybrid” refers to a Dombox that must pass 5 layer checks for all incoming mails. The five layers are Encryption Layer 421, Authorization Layer 422, Alias Layer 423, Authentication Layer 426 and Alignment Layer 427. These layer checks already explained in the previous sections. “Hybrid (H)” 214 boxes CAN be deleted by the user at anytime.

6.8. Box Type: Combox (C)

The term “Combox” refers to a Dombox that is under contract. In other words Combox refers to a “Contract-based Dombox”. Combox (C) 215 boxes CANNOT be deleted by the user. When the contract expires, the box will be converted into a “Hybrid (H)” 214 box. Combox (C) box type also must pass 5 layer checks for all incoming mails just like Hybrid (H) box type. Both Hybrid (H) and Combox (C) functions similarly except that Hybrid (H) boxes CAN be deleted anytime or put offline by the user. A user can upgrade to Hybrid (H) box from Dombox (D) manually. A user can also downgrade to Dombox (D) from Hybrid (H) box manually. However the downgrade from Combox (C) to Hybrid (H) box does not require any user intervention. It's automatic. When a Combox contract expires, the box will be automatically downgraded to Hybrid. Hybrid (H) boxes are very useful when “Telescribing”. The term “Telescribe” will be explained in a later section.

7. Dombox

We cannot expect every website in the world to support all our 5 layers. So for Dombox (D) box type, only the “Alias Layer” must be passed. If all other four layer fails then most likely we will reject the mail. But if most of them are “Neutral”, then we may accept the mail. Let's say we accept mails even when “Alias Layer” result is “Fail”. This means we are accepting mails from every domain on the Internet. The “Alias Layer” is what makes the Dombox special. Without it, “Dombox” will be equivalent to the “Mailbox” since it's accepting mail from anyone. Since we are allowing unlimited “Domboxes”, without “Alias Layer”, the users can run their own version of mail service inside their account. So for Dombox (D) box type “Alias Layer” must be passed for accepting the mail.

Dombox (D) box type has the options “Delete” and “Make Offline”. If somehow a spammer sends you spam mails to the Dombox (D), that means that domain is vulnerable to “email spoofing”. So you have the following options. (1) Contact the website owner and demand them to configure “email spoofing” prevention mechanisms like SPF, DKIM and DMARC. (2) Delete the box and move on (This is why we gave you those privileges right?)

To create a Dombox, you need to activate the “Domboxes” extension first. FIG. 14A illustrates the “domboxes” extension activation process. To add, view and browse the boxes found in domboxes 202 group, user need to activate 1401 “Domboxes” extension.

FIG. 14B illustrates the “set domkey” page layout. The term “Domkey” is already explained in prior section. You must set the “Domkey”, before accessing the “Add Dombox” page. If the Domkey already not set, then the user will be redirected to the “Set Domkey” page. In FIG. 14B user sets the Domkey 1411. Domkey once set cannot be changed. So user agree to that by checking the checkbox 1412. Domkey is a global identifier for all Domboxes and should be set only once. If Domkey has already been set, user can proceed to Dombox creation.

FIG. 14C illustrates the “Add Dombox” page layout. A Dombox requires a valid domain name or a url to generate the address. In FIG. 14C user enters example.com 1421 as domain. FIG. 14E illustrates the logical flow of a “Dombox” creation

User needs to enter a valid domain 1441 or valid url in order to create a Dombox. e.g. http://example.com, example.com or http://example.com/hello-world. User entered domain or URL should be cleaned up and converted into a valid domain 1442. e.g. example.com. Dombox domain should be a main domain. So xyz.example.com will be converted to example.com. Once we convert the domain into a valid domain, we pull the SAD record 1443 from the cleaned up domain. If there is a SAD record found and the SAD record contains a valid domain for “box” config 1444, then we switch the domain to value found in the “box” config and then proceed 1445. Else we proceed with the domain user provided 1446. We query our database to check whether the Dombox already exists for that domain or not for that particular user 1447. If already exists, then we redirect the user to that particular Dombox 1450. So the user can check their emails. The url structure of Dombox looks like this. https://www.domboxmail.com/dombox/example.com. User will be redirected to such url, if Dombox already exists. If Dombox not already exists, then we generate a new dombox for that domain 1448. So if the user entered the domain example.com, then the dombox address will be example.com@giri123.domboxmail.com. example.com@giri123.domboxmail.com is a dedicated mail address for example.com 1449. By default only mails from example.com are allowed in that dombox. However example.com domain admin can add SAD record in example.com to allow emails from other domains. SAD already explained in earlier sections. Once the dombox is generated, we redirect the user to that dombox 1450. If example.com is the newly created dombox, then the user will be redirected to https://www.domboxmail.com/dombox/example.com

A Dombox creation can originate from multiple sources. A browser extension that's created for filling signup/login forms, can provide a valid domain 1441 input and then get the generated email address as response. Browser extension can also include a “Set Password” 1539 request and then get the generated password as response.

FIG. 14D illustrates the “All Domboxes” page layout. When Domboxes extension activated 1401 there will be a new menu called “Domboxes” in the sidebar. Domboxes page lists the boxes found in the Domboxes 202 group. i.e. This page contains all the boxes that has the following box types. Dombox (D) 213, Hybrid (H) 214 and Combox (C) 215. Since the example.com dombox is already created via “Add Dombox” page 1421, FIG. 14D shows the dombox example.com@giri123.domboxmail.com. example.com dombox has “Online” 1431 status. That means the box is active and accepting mails from others.

FIG. 14F illustrates a “third party registration page” where Dombox email address can be used. If user created a Dombox for example.com, then he/she should visit the example.com register page and use the dombox address for email 1451 while signing up. Upon submitting the form usually websites send a confirmation email to verify the email address. A browser extension can generate/fill the email field 1451 and password field with one click.

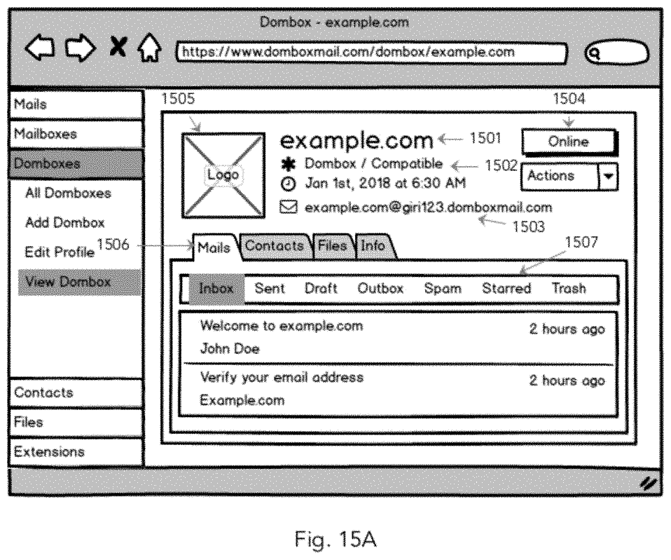

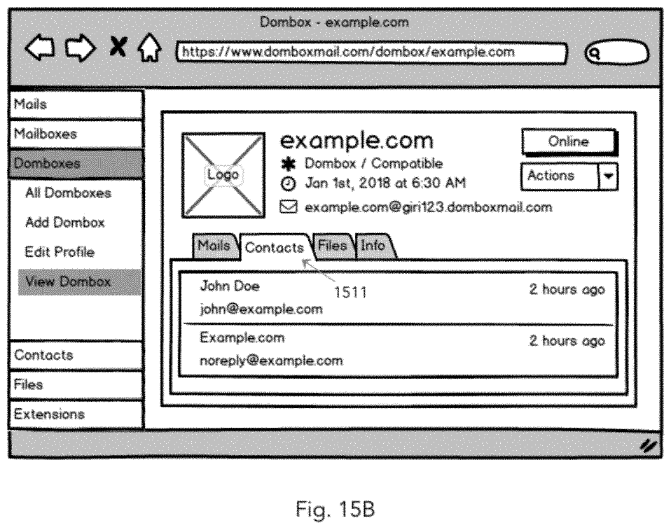

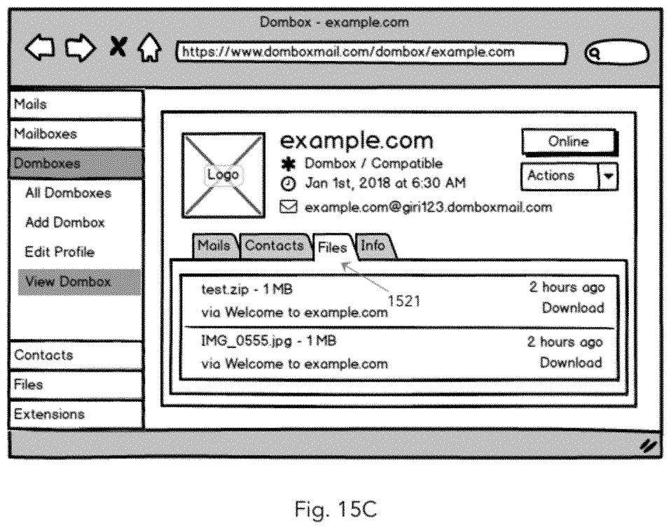

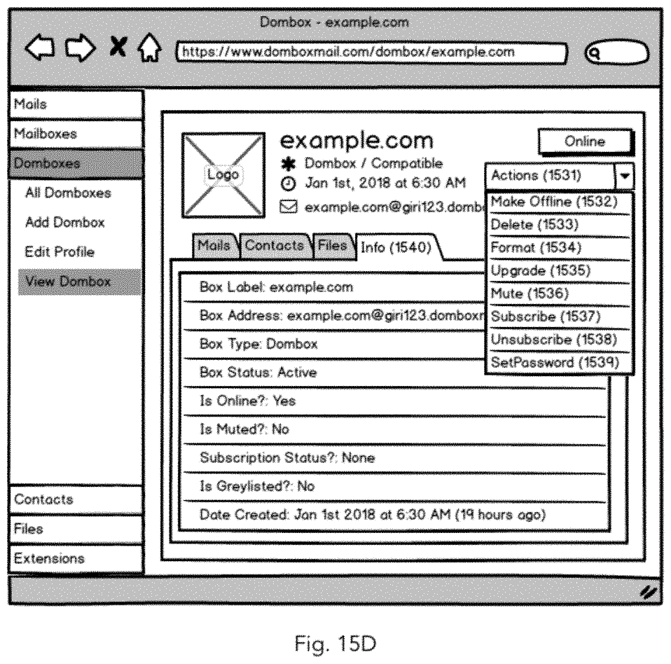

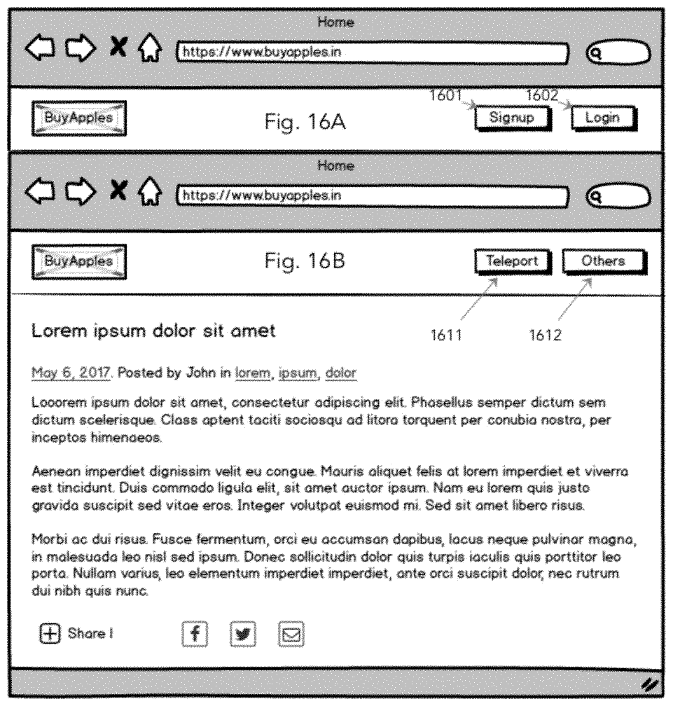

FIG. 15A illustrates the “View Dombox” page layout. View Dombox page contains Box Label 1501, Box Type 1502, Box created date, Box mail address 1503, Box status 1504, Box Domain Logo 1505, Box Main Tabs 1506 and Sub tabs 1507. If the user want to browse individual box mails, they should do it in the Mails tab found in the Box Main Tabs 1506. The mails we see in the Mails tab 1506 is only the example.com dombox mails.

FIG. 15B illustrates the “View Dombox—Contacts” page layout. Contacts tab 1511 lists the contacts related to example.com Dombox. Usually it lists the contacts mailed to that Dombox or added manually by the user.

FIG. 15C illustrates the “View Dombox—Files” page layout. Files tab 1521 lists the files related to example.com Dombox. It lists the attachments found in the example.com dombox mails.

FIG. 15D illustrates the “View Dombox—Info” page layout. Some of the info page contents 1540 depend on the “Actions” button 1531. The “Make Offline” 1532 option puts the box in “Offline” mode. If the box is in “Offline” mode, it means the box is inactive and not accepting mail from others. Box “Online” and “Offline” status already explained in prior sections. “Make Offline” option not available in Primary (P) and Combox (C). The “Delete” 1533 option deletes the Box. But it won't delete any mails. User can still browse the old emails using the “Mails” menu from the sidebar. “Delete” option not available in Primary (P) and Combox (C). Once a box get deleted, it won't accept any mails for that box address. A user can recover the Dombox mails once they recreate the dombox. i.e. When a Dombox get deleted the mails can be browsed via “Mails” menu. If the box created again all the mails will be recovered. The “Format” 1534 option deletes all the mails found in that dombox. Format option available only for the boxes found in Domboxes 202 group since they most likely contains Transactional Mails and Promotional Mails. So “Format” option applicable only for Dombox (D) 213, Hybrid (H) 214 and Combox (C) 215. Boxes found in Mailboxes 201 group usually contains Conversational mails which are important. So “Format” option is not available in Mailboxes. The “Upgrade” 1535 option available only for the Dombox (D) 213 box type. So the user can upgrade the box to Hybrid (H) 214 box manually. When a Dombox is created via “Add Dombox” page, the box type will be Dombox (D) box type. Sometimes users prefer to have Hybrid (H) box type. In such cases “Upgrade” option will be helpful. The “Downgrade” option available only for the Hybrid (H) box type. So the user can downgrade the box to Dombox (D) box manually. The “Mute” 1536 option stops the email notifications to the user. User can “Mute” less important Domboxes. Mails will still be there in the inbox. “Mute” option only stop the notifications. “Mute” option applicable only for Mailbox (M), Dombox (D), Hybrid (H) and Combox (C) and not applicable for Primary (P) box. The “Subscribe” 1537 and “Unsubscribe” 1538 option available only in the boxes found in Domboxes 202 group. By default the box subscription status is “None”. When a user is “Subscribed” to the box, the user is voluntarily asking the site to send newsletters/promotional mails. Refer to the section “Telescribe”. When a user is “Unsubscribed” to the box, the user is asking the site, not to send any newsletters/promotional mails. When the box status is “Unsubscribed” and our system find any new mails with “List-Unsubscribe” header and/or “Unsubscribe” link at the mail footer, then we automatically try to unsubscribe on behalf of the user and then instantly move the mail to the “Trash” folder. If a domain sends Promotional emails without “Unsubscribe” link, then they are breaking the law.

8. Teleport

8.1. Unstable Users

By creating Dombox (D) we may have found a solution for the spam problem, but we have created another problem. The consumers have full control of the box. The consumers can make their box offline or delete it completely anytime they want. This may please the consumers but not the businesses. From the business perspective, these users are nothing but “Unstable Users”. i.e. They can disappear any time. Recently Facebook's privacy fiasco cost them billions of dollars. People started to delete their Facebook accounts. People who deleted their Facebook accounts also encouraged others to delete it using the #DeleteFacebook campaign. Back In 2017, people were pissed about the way Uber doing business and started #DeleteUber campaign. Unlike Facebook, Uber is a Private Company. So the campaign didn't do much damage. Uber only lost around 500,000 users. Both campaigns would have had massive success if most of their users were Dombox users. Because we are letting the users to delete their box with a Single click. Just for the record, Dombox is here to solve the spam problem. Not to jeopardize other businesses. Dotcom Investors depends on metrics like “Number of Users” for valuing a company. So If we don't solve the “Unstable Users” problem, then every business in the world gonna hate our mail service. So let's solve that.

8.2. Combox (C)

The Combox (C) box type revokes the box deletion and box offline privileges from the consumer. The term “Combox” refers to a Dombox that is under contract. In other words, Combox refers to a “Contract-based Dombox”. The term “Contract” refers to an agreement between “Consumer” and the “Business”. To initiate a Contract, business owners must register an App on our website and then they have to display a button on their websites/apps. To register an App, business need to verify their domain first, since all contracts are linked to a particular domain. When a contract is signed, it also creates the Combox (C) for that contract automatically. Combox (C) cannot be created from our website. A user needs to visit a third party website and then click our “Auth” button to initiate the “Contract”. The whole point of Combox (C) is that the box can accept only the emails that pass all 5 layers. i.e. Score 5 mails. The business agrees to that part and we revoke the box deletion and box offline privileges from the consumer. Business Side: Stable Users. Consumer Side: Spam free Combox (C)

8.3. Auth Buttons

The current Internet has “Auth Buttons” like “Signup with Facebook”, “Signup with Google” etc. Hundreds of auth buttons like these available on the internet. We are trying to bring an alternative to those buttons. Our “Auth Button” is called “Teleport”. Other “Auth Buttons” are relying on e-mail address. But our “Auth Button” rely on i-mail address. So our “Auth Button” solves the Internet Privacy issue.

8.4. Portal

Portal can mean many things. e.g. Web portal. But we are using the term Portal in the science fiction context. You might have seen the portals in movies. In the movie Avengers, they use a Vertical Portal to travel between planets. But in the movie Dr. Strange, they use Horizontal Portals to travel between places on earth. We're using the term “Portal” because the consumers save their time by skipping the process like filling registration forms, Creating a contract, Creating a Combox, Verifying emails etc. Consumers also skip the Login forms while logging in.

8.5. Teleport

The whole point of a portal is to travel quickly between two distant points. You go through one door but come via another. The process happening between these two doors is called “Teleportation”. Definition from Wikipedia: Teleportation is the theoretical transfer of matter or energy from one point to another without traversing the physical space between them.

8.6. Portal vs Teleport

We use both terms. “Portal” and “Teleport”. Keep in mind, The term “Portal” is intended for “Businesses” and The term “Teleport” is intended for “Consumers”. Note for Developers: Please use the terminology exactly. e.g. Portal ID and Portal Secret. Don't call it Client ID, Consumer ID etc. Business owners create the Portals. But it's the consumers who are gonna travel through them. Take Facebook for an example, If you want to display “Signup with Facebook” button on your website, then you need to register your app first in Facebook and then you will have to display the “Signup with Facebook” button. So two things. App and Button. In Dombox Terminology, those “Apps” are called “Portals”. And the button is called “Teleport”. If still, it doesn't make sense to you, the “Teleport” button is nothing but “Signup with Dombox” button.

Rather than displaying two buttons like “Signup with Dombox” and “Signin with Dombox”, business owners will display the “Teleport” button. “Teleport” deals with both Signup and Sign in.

The term “Auth-Client Application” refers to “Portal”. The term “Auth-Button” refers to “Teleport” button.

8.7. Parallel Internet

Every product needs a vision. Dombox is our core product and its vision statement is “A Spamless Internet”. Dombox targets the consumers. On the other hand, Teleport is our Authentication service and it targets the businesses. It's vision statement is “A Parallel Internet”. Don't take it in the wrong way. We are not trying to build a new Internet. These days the term “Internet” lost its meaning to the “World Wide Web”. So when we use the term “A Parallel Internet”, some people may expect a new kind of browser, a new HTTP alternative protocol etc. But the truth is, calling “World Wide Web” as “Internet” is nothing more than calling the “Angry Birds” app found in your phone as “iPhone”. iPhone is the platform and the app leverages that platform to provide its services. “Internet” stands for “Interconnected Computer Networks” and when we use the term “A Parallel Internet”, we are talking about a “Interconnected Computer Networks” that revolves around our “i-mail addresses” as opposed to traditional “e-mail addresses”. So the people behind “Teleport” is driven by the vision “A Parallel Internet” and their primary job is developing and distributing the “Teleport” and “Telescribe” button to every website on the internet.

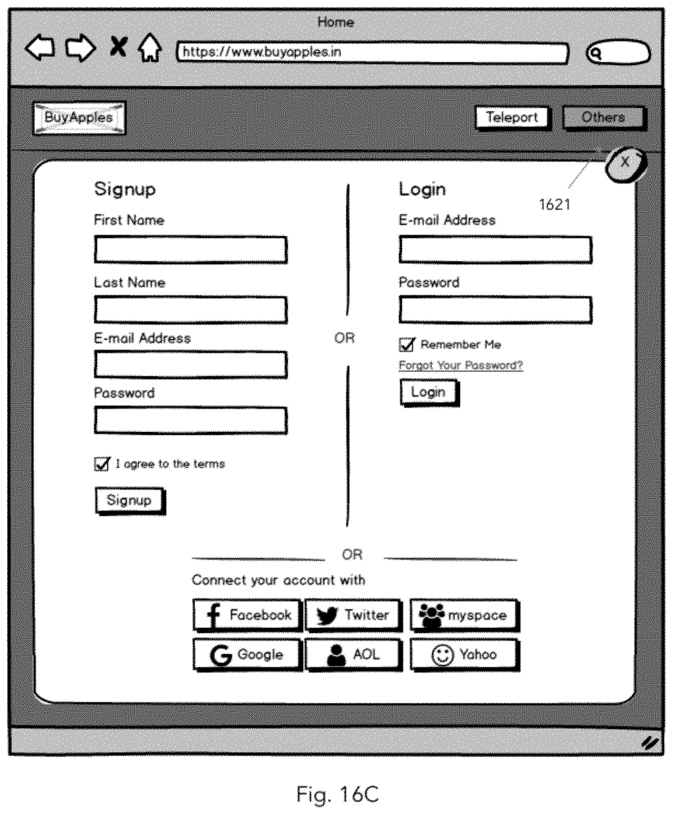

FIG. 16A illustrates the Signup 1601 and Login 1602 buttons on the present Internet. FIG. 16B illustrates the Teleport 1611 and Others 1612 buttons on the future Internet. FIG. 16C illustrates the Popup when Others 1621 button clicked. In FIG. 16B, the website give preference to “Teleport” button by displaying it first.

8.8. Official Domains

(i) domboxmail.com—Consumers (ii) domboxmail.net—Businesses

So far, we were talking from the “User” perspective. So we used the domain “domboxmail.com”. From this point forward, we are gonna talk from the “Business” perspective. So we are gonna use “domboxmail.net”. From this point forward, we are gonna heavily use the term “Consumer”. It refers to the normal mail user.

8.9. Add Domain

8.9.1. Domain Verification

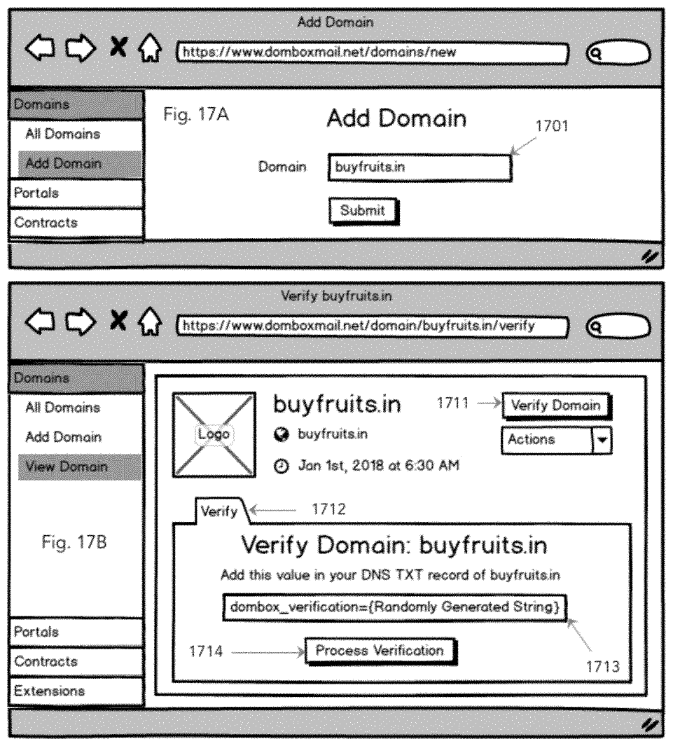

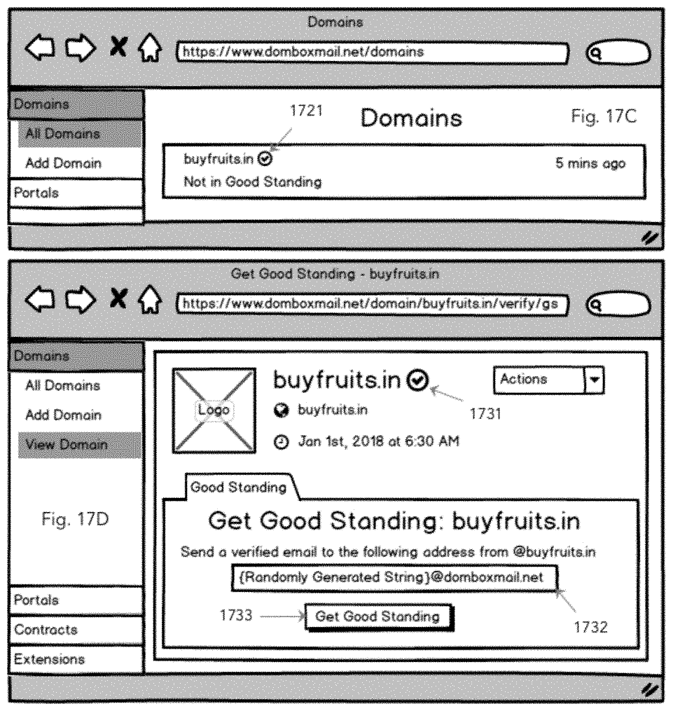

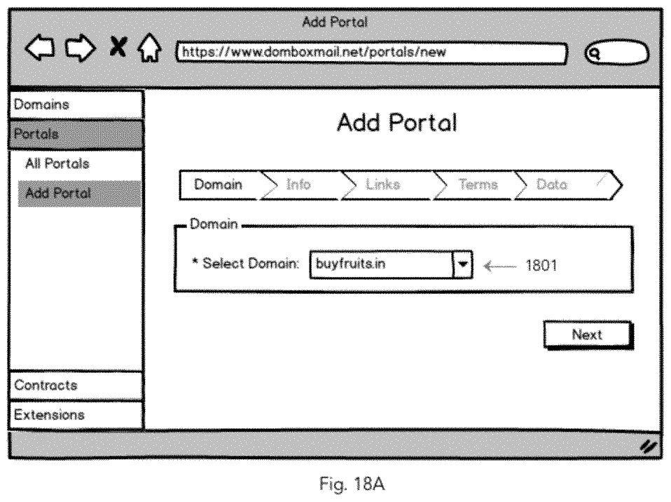

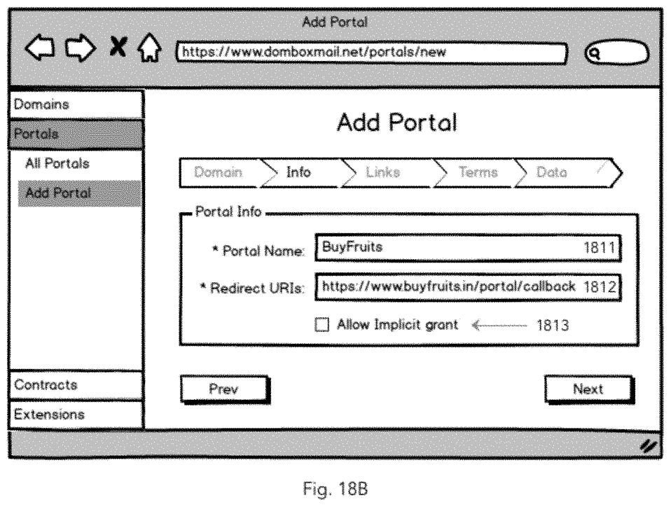

If you are a business owner you need to verify your domain first before creating a portal. FIG. 17A illustrates the “Add Domain” page layout. Business owner enters the domain name buyfruits.in 1701 in the Domain field and then submits the form. FIG. 17B illustrates the “Domain Verification” page layout. When the domain is not verified, a “Verify Domain” 1711 button will be displayed in the “View Domain” page. When clicked it will display the “Verify” 1712 tab. Domain verification page contains a random generated string. The whole string would look like dombox verification={Randomly Generated String} 1713 e.g. dombox_verification=878shgg56. Business owner copies the string, goes to their domain registrar website and then adds the copied string in the DNS as a TXT record. In our case the Business Owner adds the copied string in the “buyfruits.in” DNS as a TXT record. Once the TXT record is created, business owner comes back to the Domain verification page and then clicks the “Process Verification” button 1714. If the “Randomly Generated String” match the strings found in the buyfruits.in DNS, then the “Domain” is marked as “Verified”. FIG. 17C illustrates the “All Domains” page layout. “All Domains” page shows all the domains added by the business owner. If the domain is a “verified” domain, then the green check icon 1721 will be displayed right next to the title.

Note: A domain can be verified in multiple ways. DNS TXT record verification is the most widely used method. Other methods include CNAME record, Hosting a verification file in the domain web server. HTML Meta tag, Sending an email to the email address ends with the same domain. E.g. dombox.org domain can be verified by sending a verification email to giri@dombox.org and asking the receiver to click the uniquely generated link.

8.9.2. Good Standing

FIG. 17D illustrates the “Get Good Standing” page layout. The domain must be in “Verified” 1731 status to get “Good Standing” status. The deal is very simple here. The domain sends only verified emails to the “Combox” and in exchange we remove the box deletion and box offline privileges from that domain's Combox. Underline the words “verified mails”. That's the bargaining chip here. So the business owner need to prove us that their domain really pass all the 5 layers by sending an email to the randomly generated email address 1732. After verification, the system will give the “Good Standing” status. But keep in mind, the domain still need to comply with some of the terms to keep the “Good Standing” status. For example, if the domain keep sending malicious mails even after passing 5 layers, then the domain may lose the “Good Standing” status. To get the “Good Standing” status for the first time, the domain must send a Verified Mail with mail score 5 to the random email address given 1732. The “Get Good Standing” 1733 button needs to be clicked after sending the verification email. If the domain has “Good Standing” status, then the text “Good Standing” will be displayed under domain 1721.

The purpose of asking the business owner to send a verified email to the randomly generated email address is to make sure the website owner configured the domain properly. I.e. We check the domain eligibility by checking for minimum requirements. The business owner will be warned if it doesn't meet minimum requirements. For SPF, SAD and DMARC, we can perform a DNS query to check whether the domain configured those records. But both TLS and DKIM cannot be tested remotely. DKIM-Signature found in the email message headers. DKIM public key record is based on the selector. E.g. dev._domainkey.acme.com. Acme.com can have any name for selector instead of dev. So the only way to perform the test is to receive the mail. For TLS, the sending client need to support Opportunistic TLS check. Hence we ask the business owner to send an email to the randomly generated email address. But keep in mind, SPF, SAD and DMARC records will be fetched from the DNS at least once in the “Good standing” check.

8.10. Add Portal

8.10.1. Select Domain

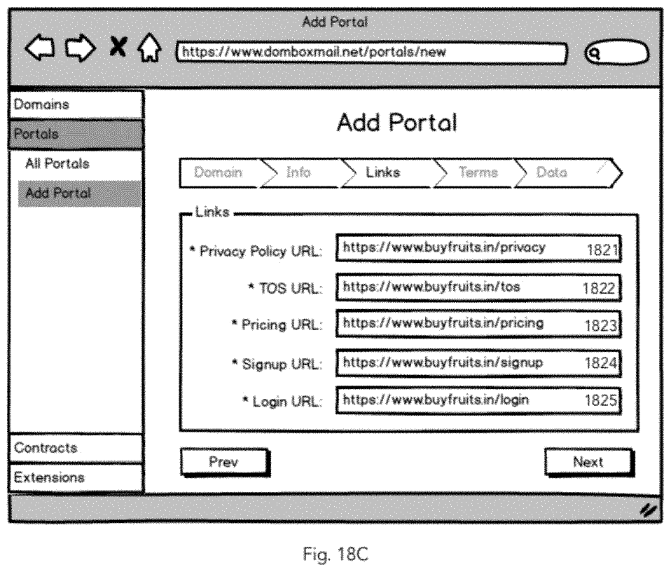

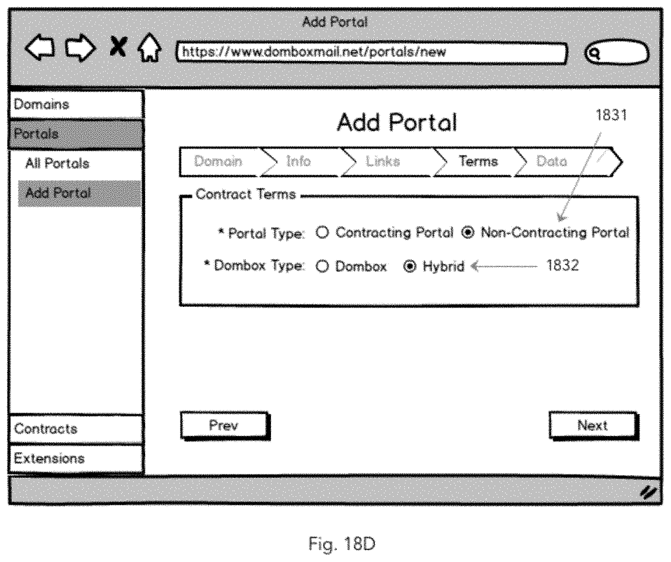

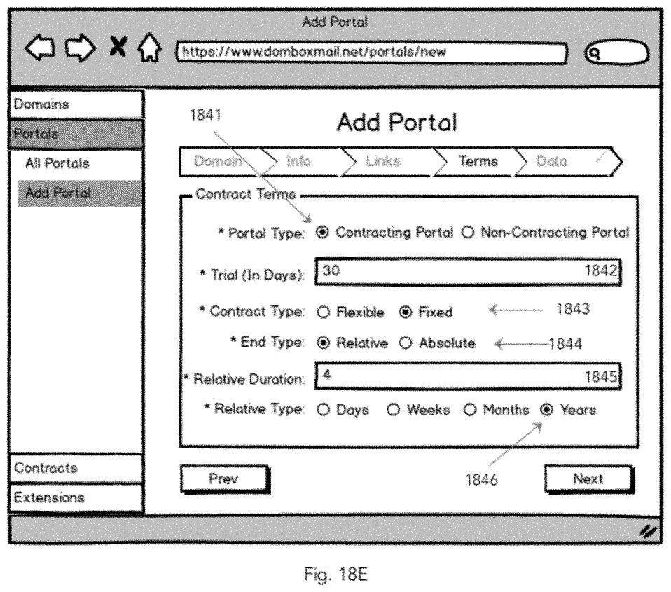

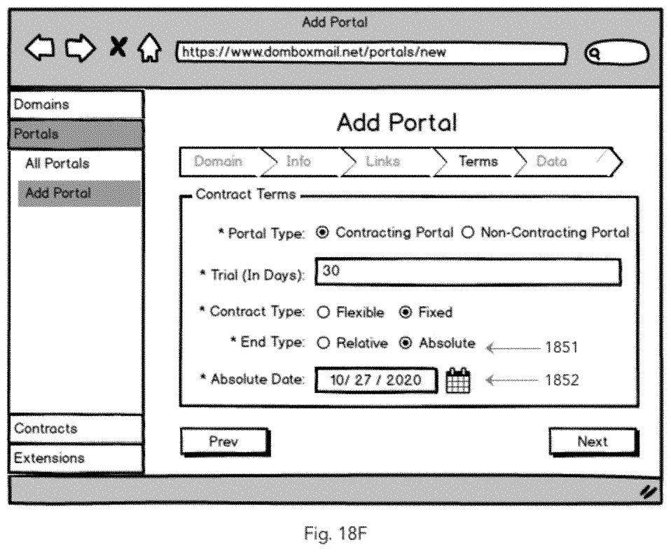

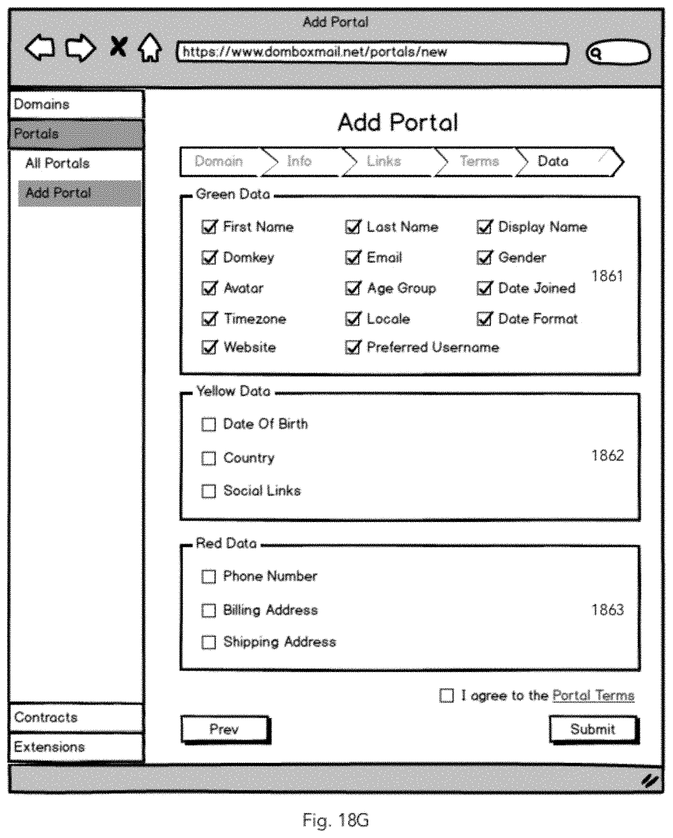

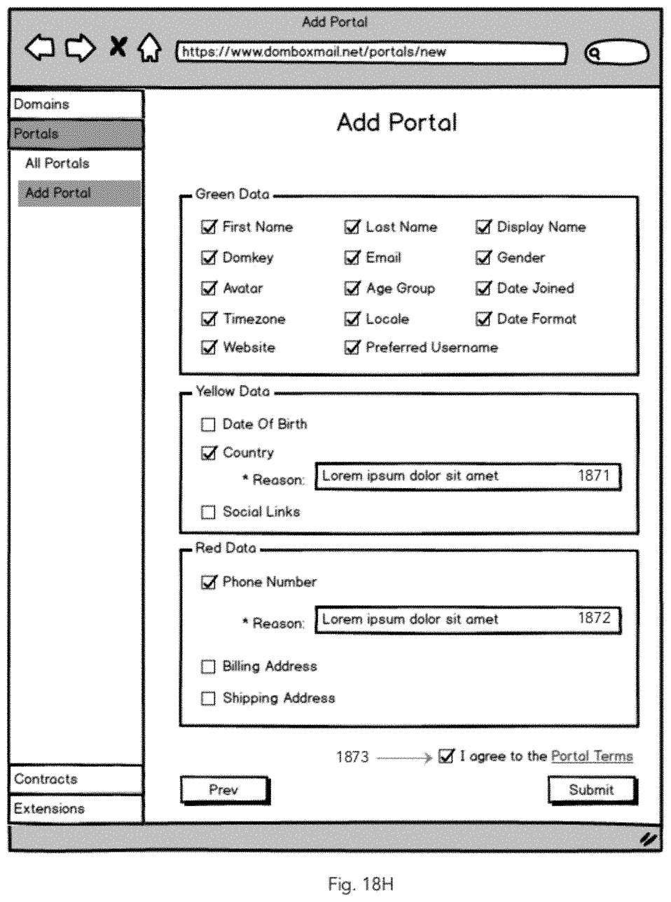

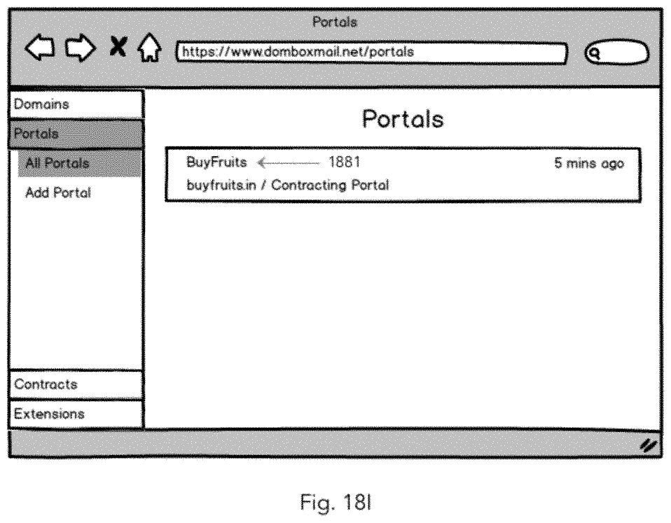

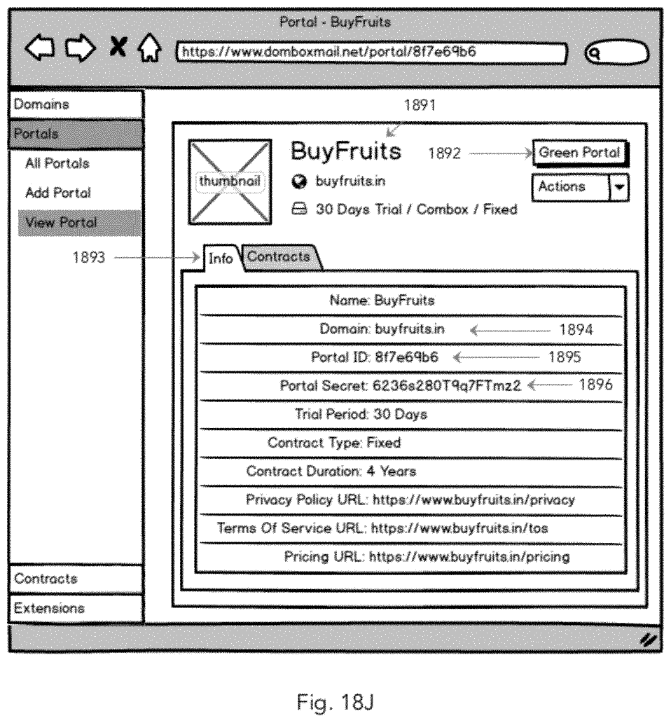

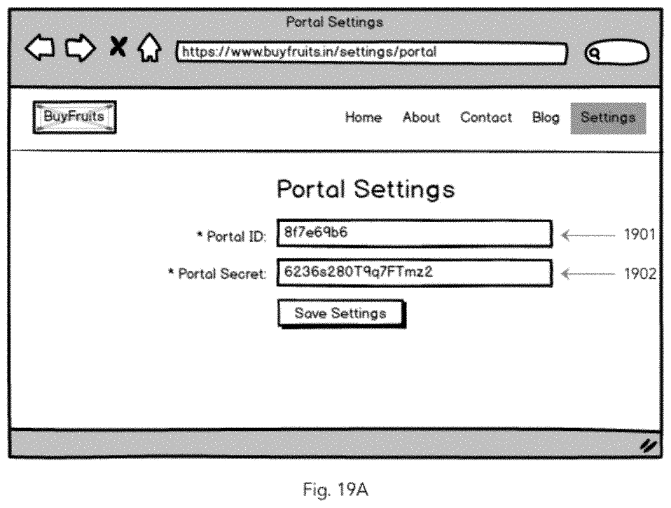

FIG. 18A illustrates the “Add Portal—Select Domain” page layout. Portals cannot be created for unverified domains. Portals cannot be created if the domain doesn't have the “Good Standing” status. Every portal will be linked to a domain. In the select domain page, the business owner needs to select the domain from the domain field 1801. Only verified domains with good standing, are available for selection. buyfruits.in 1801 is selected for the domain.

It has to be noted, this specification primarily focuses on the web platform for explaining the concepts. For mobile platform, there is no need to mandate Domain Verification and Good Standing since companies like Google already knows who is the owner of the app on their app platform.

8.10.2. Portal—Info

FIG. 18B illustrates the “Add Portal—Portal Info” page layout. In Portal Info page, the business owner enters the Portal Name 1811, Redirect URIs 1812. A domain can have unlimited portals. But for most websites only one portal is enough. For example an educational website can have a portal for students and another portal for teachers. To prevent confusion, the business owner should give a portal name 1811 to identify the portal properly. For security reasons, all portals must have at least one Redirect URIs 1812. Business owners need to provide that. Native mobile applications and Some javascript based OAuth clients requires “implicit grant” in order to work. In such cases the Business Owner can opt-in by checking the “Allow Implicit Grant” checkbox 1813. Business owners should Check “Allow Implicit Grant” checkbox, only when they need this option. Implicit Grant provides low security. This is disabled by default for security reasons.

Unlimited Portals offers data sharing between multiple platforms. For example, Whatsapp is a popular app and it's available for Android, iPhone, WindowsPhone, MacOS, Windows etc. The business owner can register a portal for each and every platform. Since these portals are registered under a domain, “Dombox Domain” gonna be the same for all platforms. In other words, the isolated mail address will be shared between multiple Portals. But “Portal ID” will be different for all Portals. So portal can be identified easily.

8.10.3. Portal—Site Links

FIG. 18C illustrates the “Add Portal—Site Links” page layout. In Site Links page, the business owner enters the relevant site links. These links will be displayed to consumers. So they can check the links before signing up to the website. The Business owner should provide the Privacy Policy Page URL 1821, Terms Of Service Page URL 1822, Pricing Page URL 1823, Signup Page URL 1824 and Login Page URL 1825. The Signup Page URL 1824 and Login Page URL 1825 are the urls where the “Teleport” button can be found. Once the domain become our “Portal Partner”, we disable the “Add Dombox” functionality for the domain and then ask our users to signup/login via the “Teleport” button found in those URLs. Signup 1824 and Login page 1825 links will be used for Teleport 3704 button on the “Add Dombox” page.

Signup Page URL 1824 and Login Page URL 1825 are the urls where the “Teleport” button can be found. Website owners can also provide direct URLs that would automatically trigger the “Teleport” button. I.e. The href value found in the Teleport button. We call those URLs “One-Click URLs”. A normal signup page URL might look like this. https://buyfruits.in/signup. Teleport button href value might look like this. https://buyfruits.in/teleport/?action=signup. Our There can be more than one “Teleport” button on the same page, but the href value will be the same for all. When a user clicks “Teleport” button, the user will be redirected to our server for giving consent to access their data. So two steps. (a) User visits the signup page (2) Clicks the button. Via One-Click URLs. These steps can be minimized into a single step. User clicks the “Teleport” 3704 button suggested in the “Add Dombox” page. That button hyperlinks to the One-Click URL. User redirected to the consent page without the need to click the “Teleport” button found in the third-party website.

8.10.4. Portal—Contract Terms

FIG. 18D illustrates the “Non-Contracting Portal” page layout. FIG. 18E illustrates the “Contracting Portal” page layout. FIG. 18F illustrates the “Absolute End Date” selection.

8.10.5. Portal—Required Data

FIG. 18G illustrates the “Required Data” page layout. The user data is classified into three categories to provide better privacy. Green Data 1861, Yellow Data 1862 and Red Data 1863. Green Data contains insensitive data. Yellow Data contains moderate level sensitive data. Red Data contains highly sensitive data. FIG. 18H illustrates the “Add Portal—Yellow and Red Data” selection process. Both “Yellow Data” and “Red Data” requires a reason to access those fields.

The reason should be provided by the website owner for both Yellow Data fields 1871 Red Data fields 1872. The reason will be displayed to the consumer for both Yellow Data 2022 and Red Data fields 2021. The business owner must agree to the portal terms 1873 before creating a portal.

8.11. Portal Types

A portal can be one of two types. Contracting Portal 1841 and Non-Contracting Portal 1831. A Contracting Portal creates a “Combox (C)” 215 during signup whereas a Non-Contracting Portal creates either a Dombox (D) 213 or Hybrid (H) 214 box. Hybrid (H) box is the recommended Dombox Type 1832 for Non-Contracting Portal. The Dombox Type for “Contracting Portal” can be only Combox (C)

8.12. Contract Types

A contract can be one of two types. Flexible Contract and Fixed Contract 1843. The term “Flexible Contract” refers to a contract that has “no end date”. We'll explain later why its called Flexible contract. The term “Fixed Contract” refers to a contract that has an “end date”. The end date can be either relative or absolute 1844.

8.12.1. Fixed Contracts—Relative

Relative end type contracts has the “same duration” for all contracts regardless of the signup date. For example if the relative end duration is “4 Years” 1846, all user contracts will have 4 years duration from the signup date. The best use case for relative end type contract is a student web portal. Priya, Khan, and David they are all trying to signup for a 2 years course. Priya's course starts on January 2018 and ends on January 2020. Khan's course starts on January 2019 and ends on January 2021. Davids's course starts at January 2020 and ends on January 2022. As you can see they all have the same duration regardless of the signup date. In this case, they are all on contract for 2 years. In relative end type, you need to provide a relative duration. The relative duration can be in Days, Weeks, Months and Years 1846. e.g. 30 days from the signup date, 5 weeks from the signup date, 6 months from the signup date, 2 years from the signup date.

8.12.2. Fixed Contracts—Absolute

Absolute end type 1851 contracts has “variable duration” for all contracts. For example if the absolute end date is “Oct. 27, 2020” 1852 then all contracts will get terminated on that date regardless of the signup date. i.e. Users may signup in different date and time. But they always have the same end date. The best use case for absolute end type contract is a music concert. Let's just say Katy Perry has a music concert in December 2020 and the event organizer would like to keep in touch with the online ticket buyers till the concert date. In this case, the event organizer can go for absolute end type contract. Priya buys the concert ticket on January 2018. Khan buys the concert ticket on January 2019. David buys the concert ticket on January 2020. But all their contracts end on December 2020 once the concert is over. If you do the math, Priya is on contract for 3 years, Khan is on contract for 2 years and David is on contract for 1 year. So the duration is not the same in absolute end type contracts. In absolute end type, you need to provide the exact date. e.g. “31 December 2020”

8.13. Trial

Whether its Fixed contract or Flexible Contract, all Contracts can have a Trial Period 1842. By default, the Trial days is set to zero days. i.e. No Trial. However, a website can set a Trial to a higher value (e.g. 30 days) to attract more customers to try their product. Think about it. When a website advertises like “30 days Money back guarantee”, they may return your money, but they are still keeping your email address. That means the website can contact you any time in the future. They can also sell your email address to spammers. But If the website also advertises like “30 days Teleport trial”, that means the website is giving you some sort of “No strings attached guarantee”. You can “Cancel” the contract within the trial period. When you cancel the contract, the box instantly goes to “Offline”. For the sake of our example, let's assume there is a Note Taking website called AwesomeNotes.com. The website owner of AwesomeNotes believes people are gonna love his product if they try his product for just 10 minutes. So the website owner sets the Trial Days to “30 Days” to attract more users. Priya sees this “No strings attached guarantee” and she understands that she can walk away anytime without receiving any annoying emails from the website owner. Since she got nothing to lose, she uses our “Teleport” button and voila, within a matter of seconds she is now a proud member of AwesomeNotes. Priya Signed Up on “1, Jan. 2020” and the Trial ends on “30, Jan. 2020”. Priya clicks the “Cancel Contract” button on January 10. The box goes “Offline”. She can't put the box “Online” unless she continues the contract. Note: If the box is “Offline”, all incoming emails will be rejected. So “Offline” boxes are “Read-Only” boxes. 10 Days later Priya decided to continue the contract. So she clicks the “Continue Contract” button on January 20. The “Cancel Contract” button still available till January 30. She can cancel the contract anytime before January 30. But if 30 days have passed since her signup date, then the “Cancel Contract” button won't be available. However, when the box is in “Cancelled” status, the “Continue Contract” will always be available even after the trial days. If Priya clicks the “Continue Contract” button on February 20 instead of January 20, then she can't cancel the contract anymore.

8.14. Maximum Possible Contract Length

What's preventing a website owner from setting the relative duration value to “2000 years” instead of “2 years”?. What's preventing the music concert organizer from setting the absolute date to the year “December 3020” instead of “December 2020”?. We cannot ask our users to stay on contract for 1000 years. Can we? That would be crazy right? So whether it's a Fixed contract or Flexible Contract, all Contracts must have a maximum duration. This is what we call “Maximum Possible Contract Length”.

The formula for “Maximum Possible Contract Length” calculation is Lₘₐₓ=Hₘₐₓ−Aₘᵢₙ

Where Lₘₐₓ=Maximum Possible Contract Length (in Days).

Where Hₘₐₓ=Longest known human lifespan in History (in Days).

Where Aₘᵢₙ=Minimum age required to signup for Dombox mail service (in Days).

Hₘₐₓ is the longest known human lifespan in History (in Days). This value is constant. Jeanne Louise Calment from France holds the current Guinness record for the title “Oldest Person Ever”. She was born on 21 Feb. 1875. Died on 4 Aug. 1997. So her lifespan 44,724 days is used as the value. This constant value 44724 cannot be changed until someone else break that Guinness record. The new record holder must be officially replaced the old record holder in Guinness world records to modify this constant. Hₘₐₓ=44724

Aₘᵢₙ is the minimum age required to signup for our mail service. The value should be in Days. This value is a constant too. At this moment a person should be 13 years old to signup for our mail service. Although the minimum age requirement may vary based on the user's country, we are gonna stick with the US standard for this one. To calculate the Days, we use the first 13 years of Jeanne Louise Calment. So it would be treated like she joined our mail service when she turned 13 and used it till her death. The number of days from 21 Feb. 1875 to 21 Feb. 1888 is used to calculate this value. So the value is 4,748 days. i.e The first 13 years of her age. This value cannot be changed until our mail service minimum age requirement for the US get changed. Aₘᵢₙ=4748

Lₘₐₓ=39976. Maximum Possible Contract Length in Days: 39976 Days. Maximum Possible Contract Length in Years: ˜109.5 Years. Both Absolute end date 1852 and Relative end duration 1845 must comply with “Maximum Possible Contract Length”. The relative end duration 1845 can be in Days, Weeks, Months and Years 1846. If the relative end duration is in days, the maximum value is 39976 Days. If the relative end duration is in weeks, the maximum value is 5710 weeks. If the relative end duration is in months, the maximum value is 1314 months. If the relative end duration is in years, the maximum value is 109 years. The “Absolute end date” 1852 must be an exact date. When the website owner set this date while creating a Portal, the end date 1852 cannot be a date that is greater than 39976 days from the current date.

8.15. Initial Duration

There are websites out there that goes out of business within a year of their launch date. Now, What would happen to those people who had signed up in such websites if they were actually under a contract? The website is gone, but the users are still locked in their contracts. Right? If we tell the users that they have to wait 109 years to delete the box, they are gonna be furious. On the other hand, If we let them delete their box, and if the website owner put his website back online, say 15 years later, then our company will be in trouble. Because users are gone but 109 years contract length has not over yet. To solve this problem, whether its a “Flexible Contract” or “Fixed Contract”, all contracts comes only with an Initial Duration and the website need to earn the remaining duration by renewing them (by sending a mail that passes all 5 layers). Two types of Initial Duration available. Initial Duration for “Good Standing”=>5 years. Initial Duration for “Combox”=>5 years

8.16. Renewal

All Contracts must be renewed by the domain and not by the user. Two types of renewal required for all contracts. (1) Global Renewal (2) Local Renewal

8.16.1. Global Renewal

The business must send at least one “5 layers passed mail” from the “Dombox Domain” every five years to any mail account in our mail system to keep the “Good Standing” status. This is called “Global Renewal”. All renewals come with a 5-year extension. If a domain gets “Good Standing” status for the first time in Jan. 1, 2020, its valid till Jan. 1, 2025. To get a 5-year extension (i.e Till Jan. 1, 2030), at least one 5 layers passed mail must be sent between Jan. 1, 2020 to Jan 1, 2025. The point of “Global Renewal” is to make sure the website is an active one and not out of business. Note: The value “5 years” used here as an example.

8.16.2. Local Renewal

When a contract is signed by the consumer, the “Combox” comes with a 5-year duration. The business must send at least one “5 layers passed mail” every five years to the “Combox” to extend the contract by 5 more years. This is called “Local Renewal”. e.g. If a contract is signed by the consumer on Jan. 1, 2020 it's valid till Jan. 1, 2025. If the business sends at least one “5 layers passed mail” between Jan. 1, 2020 to Jan. 1, 2025 then the contract is renewed till Jan. 1, 2030. The point of “Local Renewal” is that, to make sure the user doesn't have any stalled (inactive) boxes for a long time. Note: For Global Renewal “5 layers passed mail” must be from the “Dombox Domain” to be considered as valid. But for “Local Renewal” mail from “SAD Domains” are considered valid too. Also note, “Local Renewal” depends on “Global Renewal”. i.e. If the business is not in “Good Standing” status, then the “Local Renewal” won't happen

8.17. Duration vs Renewal

The “Duration” part and the “Renewal” part may cause some confusion. Let us clarify them here. The maximum possible contract length is 39976 Days. When we use the term “Flexible Contract”, we are actually referring to a contract that expires 39976 days from the signup date. i.e. The full possible duration. If you are website owner and you have no idea whether you should pick “Flexible Contract” or “Fixed Contract” for contract type, you should always pick the “Flexible Contract” type. You should pick “Fixed contract” type only on special cases like Student course, Music concert etc. In a nutshell pick “Fixed Contracts” only for short-term contracts. Again . . . When in doubt, Always go with “Flexible Contract” type. Although “Flexible Contracts” have full possible duration, it only comes with an initial duration. The website needs to keep on renewing them by sending emails. That's why its called Flexible contact. In a way, Fixed Contracts also same as Flexible contracts. What makes them “Fixed” is the end date. For the sake of our example, Let's say both the Initial Term and the Renewal Term is 10 years. That means the flexible contract needs at least 10 renewals in the 109 years. e.g. Contract Signed in the year 2000. The flexible contract is valid until the year 2109. But the initial term comes with only 10 years. If the website sends at least one mail in between 2000 to 2010, then its renewed till 2020. If the website sends at least one mail in between 2010 to 2020, then its renewed till 2030 and so on. Same rules apply to “Fixed Contracts” but the renewal happens until the “end date” set by the website owner.

8.18. Deadlock

Once you create your first Portal, you are officially our “Portal Partner”. When a site becomes our “Portal Partner” that usually means they are displaying the “Teleport” button and that site requires a contract to create a Combox. In such cases, Consumers cannot add a Dombox via “Add Dombox” page. If they enter a “Portal Partner” domain in the “Add Dombox” page, they will get a message like this. “buyfruits.in is our Portal Partner. Please use the Teleport button to signup” 3702. So “Dombox (D)” box type is disabled for the “Portal Partner” domains. If you remove the “Teleport” button from your website, you are creating a deadlock since we already disabled the Dombox (D) box type. So make sure you are not breaching our “Partner” terms. Otherwise, all your existing contract will be terminated. Terminating all your contracts will be the final straw. We will keep in touch with you via email if there is an issue. Don't get us wrong. You are welcome to remove our “Teleport” button as long as you don't allow signup/Login via any other methods. e.g. Signup Forms, Login Forms, Facebook connect, Google connect etc. If you allow only “Login” via other methods, then we expect you to put the “Portal” in “Login Only” mode. This way we don't allow new contracts, but our existing users can use your website without any issues. From the “Teleport” button perspective, we consider those websites and apps that supports our “Teleport” button as being part of our “Parallel Internet”. Again . . . That's because our “Parallel Internet” revolves around “i-mail address/Isolated Mailboxes” as opposed to traditional “e-mail address/Normal Mailboxes”. So we are expecting the same thing what the “Traditional Internet/Normal Mailbox” Users get from you. So In simple words, we are looking for “Equal Treatment”. In complex legal terms, this is called Most Favoured Nation (MFN) Clause. Although the term “Most Favoured Nation (MFN)” may sound like giving special treatment to a particular nation, it's actually about Non-Discrimination

8.19. Termination

Contracts may get terminated in one of the following conditions. (a) if the business breaches the “Partner” terms and conditions. e.g. Deadlock. (b) if the business is not in “Good Standing” status. (c) If the contract gets automatically expired. (d) If the user is banned/deleted either by our website or the business website. (e) If the user's account becomes inactive. e.g. User has not logged in for 10 years. When a contract gets terminated, the box will be downgraded from “Combox” to “Hybrid”. Note: When a contract get terminated it only means, the user gets the freedom to delete the box whenever they want. It doesn't mean your business lost a customer.

Also note, Combox (C) box type revokes the deletion and “make offline” privileges from the user. From the user perspective both Dombox (D) and Hybrid (H) boxes are better than Combox (C). So if a third-party authentication service like Google or Facebook starts to provide disposable email address based authentication service in the future and if the business displays such buttons, then Combox (C) box type won't be available to such businesses. I.e. Businesses can go for only Dombox (D) and Hybrid (H). This is because users will prefer third-party disposable email address based auth buttons over our Teleport because third-party disposable email address based auth buttons not tied to any contract. It offers the freedom user wants. Which means Teleport button loses its shine. So the only way business can go for Combox (C) box is that they have to ditch third-party disposable email address based authentication services. E.g. if acme.com wants Combox (C), then they must not support any third-party disposable email address based authentication services for their domain acme.com. All contracts related to acme.com will be terminated when acme.com breach this condition. In other words, acme.com can only go for Non-Contracting Portal 1831 when a third-party disposable email address based auth button displayed.

8.20. Portal ID & Secret

FIG. 18I illustrates the “All Portals” page layout. “All Portals” page lists all the portals created by the business owner. Business owner can view the portal by clicking the Portal Name 1881

FIG. 18J illustrates the “View Portal” page layout. The “View Portal” page contains portal info like Portal Name 1891, Portal Type 1892, Portal Domain 1894, Portal ID 1895 and Portal Secret 1896. Once the portal is created, the business owner can able to copy the Portal ID 1895 and Portal Secret 1896. The Info tab 1893 contains portal info. The contracts tab lists contracts associated with the portal. In OAuth2 specification (RFC 6749) terminology Portal ID is called “Client ID” and Portal Secret is called “Client Secret”. We mentioned OAuth2 protocol here because it's the most widely used protocol as of now. There are other protocol available too. OAuth1, OpenID, SAML, WSFed etc. One can even build a custom protocol.

8.21. Configure Portal

FIG. 19A illustrates the “Portal Settings” page layout on a third party website. In our case buyfruits.in. Only the 3rd party site admin (website owner) has access to this settings page. The settings found on this page are intended for Portal Client. The business owner pastes/enters the Portal ID 1901 and Portal Secret 1902 and then saves the settings. The business owner now displays the “Teleport” button in the website register 2001 and login pages. Teleport button is now ready for consumers. If any consumer clicks the “Teleport” button from your website that would initiate the “Teleportation” process.

8.22. Teleport Process

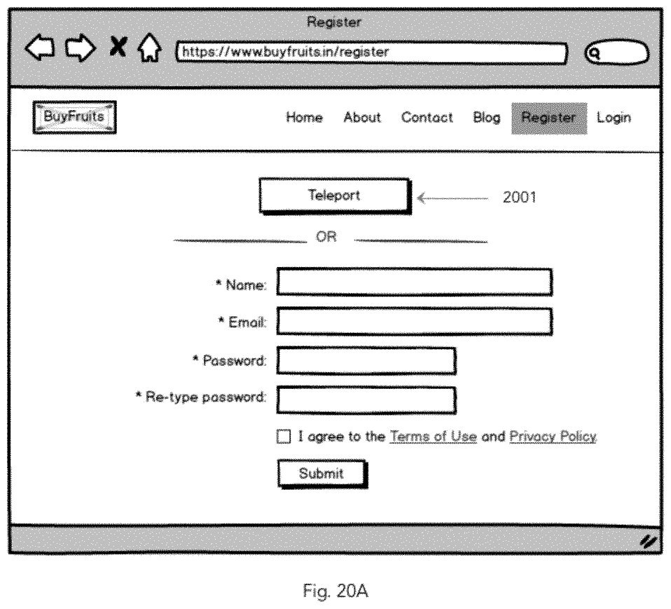

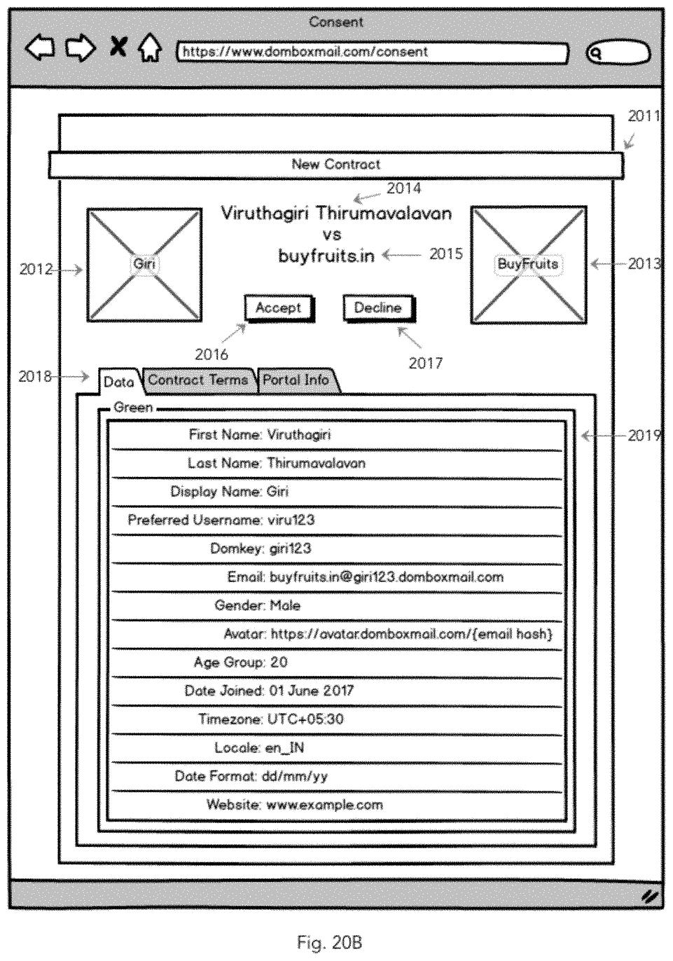

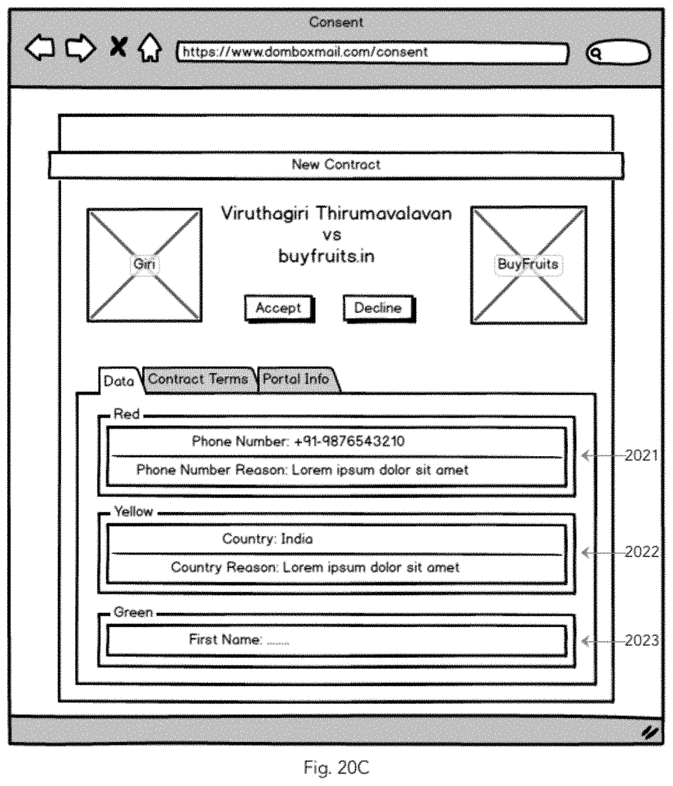

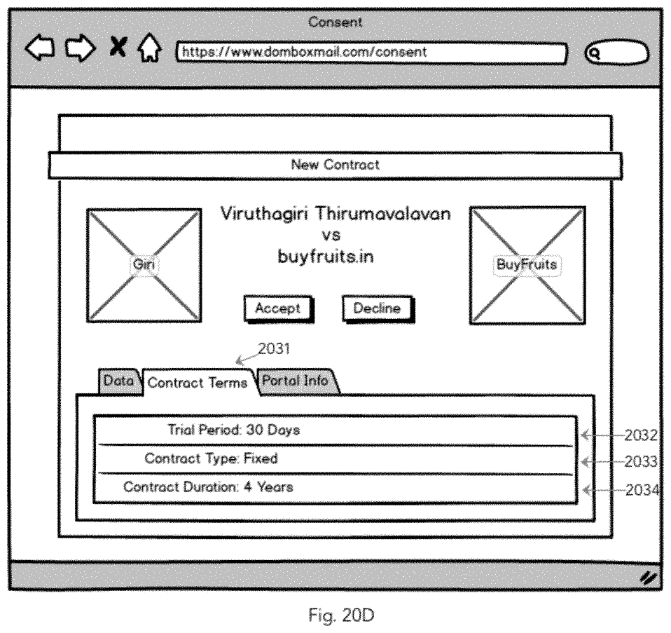

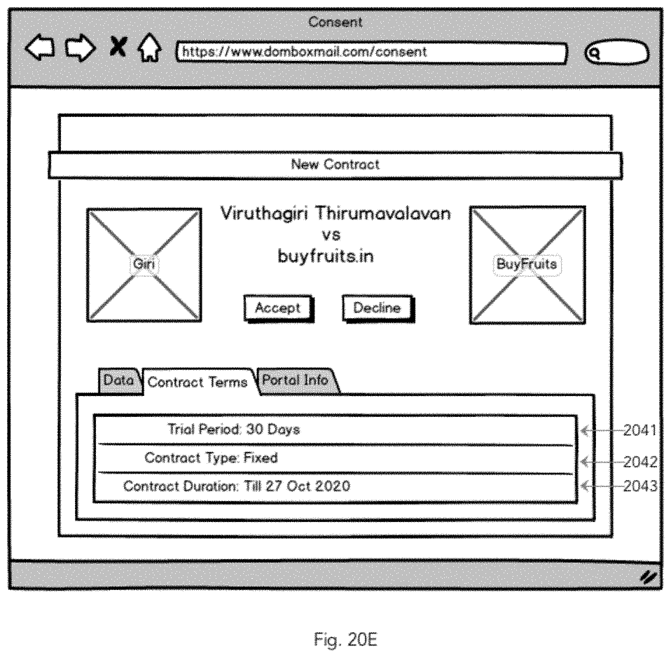

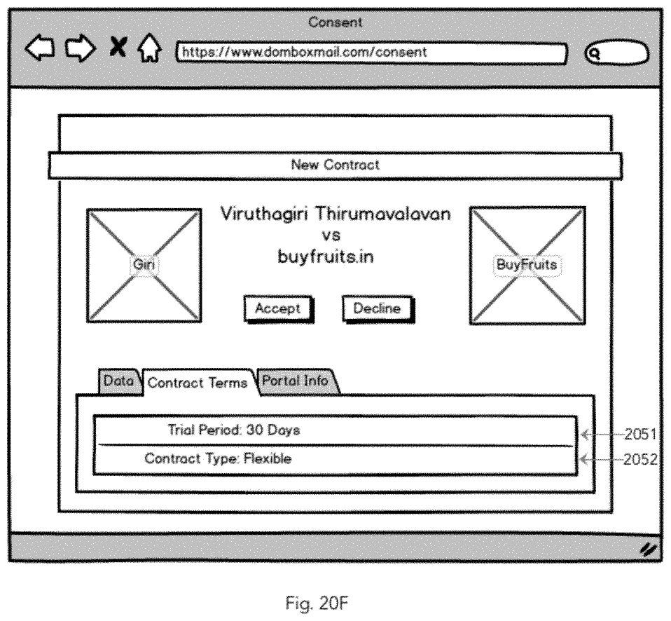

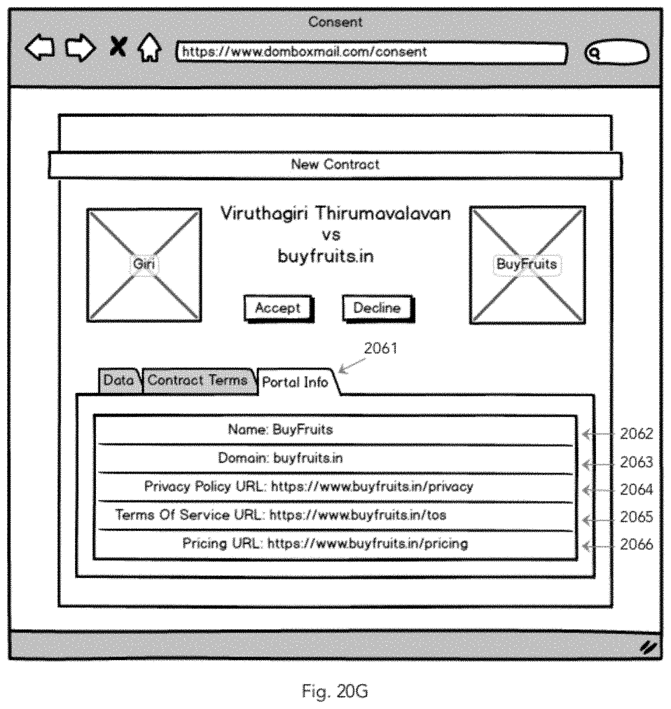

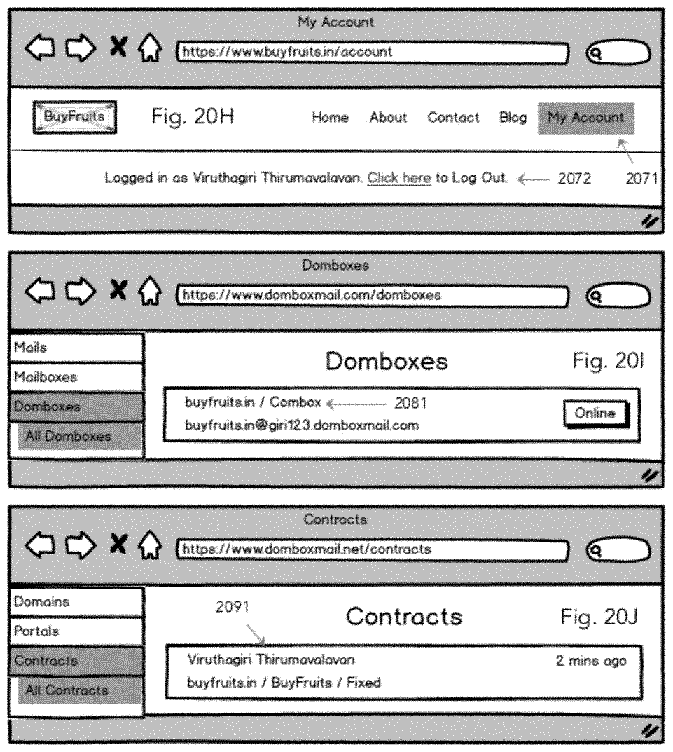

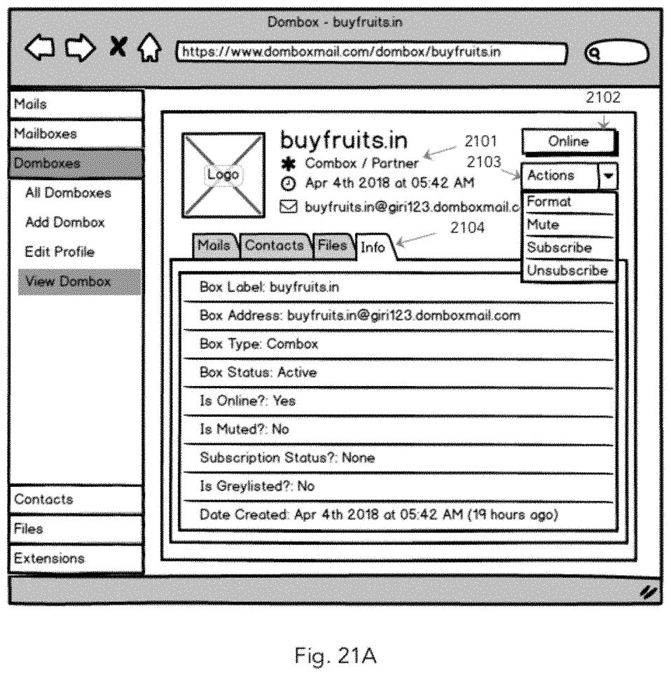

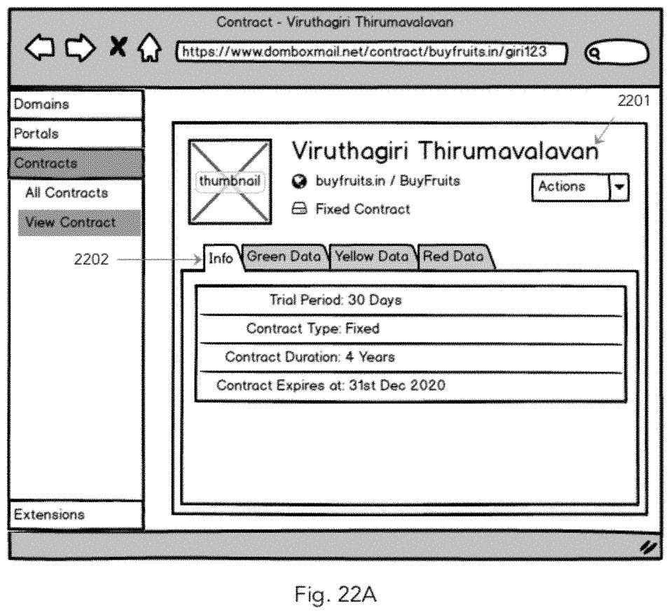

FIG. 20A illustrates the “Register” page layout on a 3rd party website where “Teleport” button 2001 is displayed. FIG. 20B illustrates the “Consent” page layout. When the “Teleport” button 2001 is clicked by the consumer, it redirects to the consent page. The consumer has to either accept 2016 or decline 2017 the contract. The title “New Contract” 2011 background colour depends on the data requested by portal. If the portal asks permission for at least one “Red” data 1863 then the background colour will be in red colour. If the portal asks permission for at least one “Yellow” data 1862 then the background colour will be in yellow colour. If the portal asks permission only for “Green” data 1861 then the background colour will be in green colour. The consent page displays Consumer name 2014, Consumer avatar 2012, Business name 2015 and Business avatar 2013. The consumer avatar 2012 can be changed or removed (set to none) by the consumer while signing the contract for privacy reasons. The data tab 2018 will be displayed by default on the consent page. The Data tab shows the green data information 2019. FIG. 20C illustrates the alternate version of “Consent” page with red and yellow data. The green data 2023 is trimmed for brevity. Both red data 2021 and yellow data 2022 is displayed with reason here. FIG. 20D illustrates the “Consent—Contract Terms—Relative End Date” page layout. Consumer can view the contract terms by clicking the “Contract Terms” 2031 tab. The Contract is a 4 years 2034 relative fixed contract 2033 and it has a 30 days trial 2032 period. FIG. 20E illustrates the “Consent—Contract Terms—Absolute End Date” page layout. The Contract is an absolute fixed contract 2042 with 30 days trial 2041 period that ends on 27 Oct. 2020 2043. FIG. 20F illustrates the “Consent—Contract Terms—Flexible End Type” page layout. The Contract is a flexible contract 2052 with 30 days trial 2051 period. FIG. 20G illustrates the “Consent—Contract Terms—Portal Info” page layout. Consumers can view the portal info by clicking the “Portal Info” 2061 tab. This page contains portal information like portal name 2062, portal domain 2063, privacy policy url 2064, terms of service url 2065 and pricing page url 2066. If the consumer clicks the Decline button 2017, no data will be transferred to the 3rd party website. If the consumer clicks the Accept button 2016, the user will be redirected to the 3rd party website's redirect url 1812 and the requested data will be transferred to the 3rd party website. The website creates a new account for the consumer if the consumer is a new user of 3rd party website. If the consumer is an existing user, then the consumer will be logged in. FIG. 20H illustrates the “My Account” 2071 page layout on a 3rd party website. The consumer Viruthagiri Thirumavalavan 2072 is connected to the 3rd party website buyfruits.in using Teleport button 2001. When the consumer accepts the contract for the first time, a Combox (C) 215 will be created for that domain if the portal is a Contracting Portal 1841. If the portal is a Non-Contracting Portal 1831 either Dombox (D) 213 or Hybrid (H) 214 box will be created.

8.23. Combox via Teleport

FIG. 20I illustrates the “All Domboxes” page layout after buyfruits.in “Combox” creation. You can see the buyfruits.in Combox (C) with address buyfruits.in@giri123.domboxmail.com 2081. Since this is a Combox (C), it always will be “Online” and it cannot be deleted until the contract get expired or terminated. When the contract expires it automatically downgrades to Hybrid (H) box type where user can make the box “Offline” or delete it. FIG. 21A illustrates the “View Dombox” page for buyfruits.in “Combox”. buyfruits.in combox will always be “Online” 2102. The “Actions” button 2103 in Combox (C) 215 doesn't have the some of the options found in Dombox (D) 213 and Hybrid (H) 214 box type “Actions” button 1531. Make Offline 1532, Delete 1533 and Upgrade 1535 options are not available in Combox (C) 215. Since the Combox (C) is under contract, Make Offline and Delete options are not available. Combox (C) is the highest possible box type. So no Upgrade 1535 option is available. Since the Combox (C) is under contract, it cannot be downgraded manually by the user. The info tab 2104 can have box info as well as contract info.

8.24. Contract via Teleport

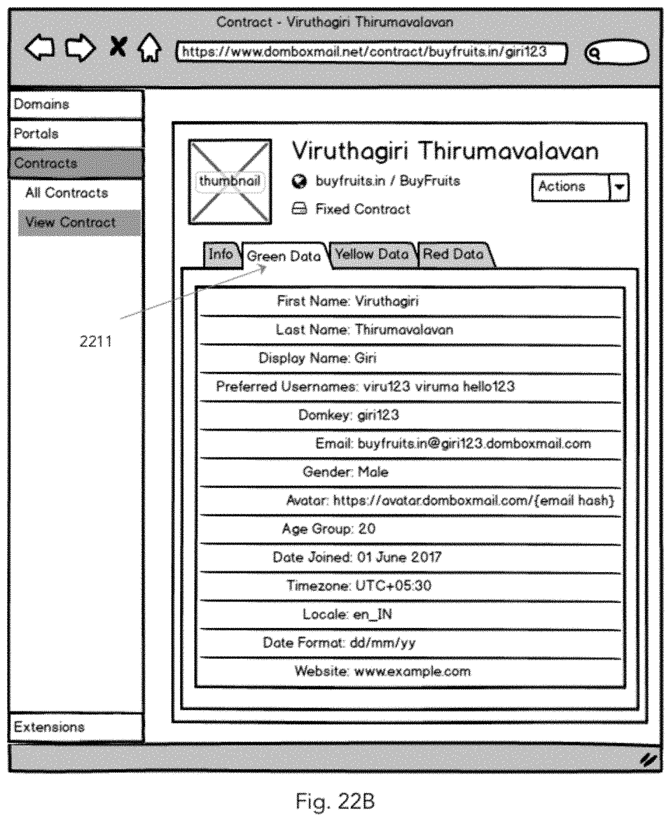

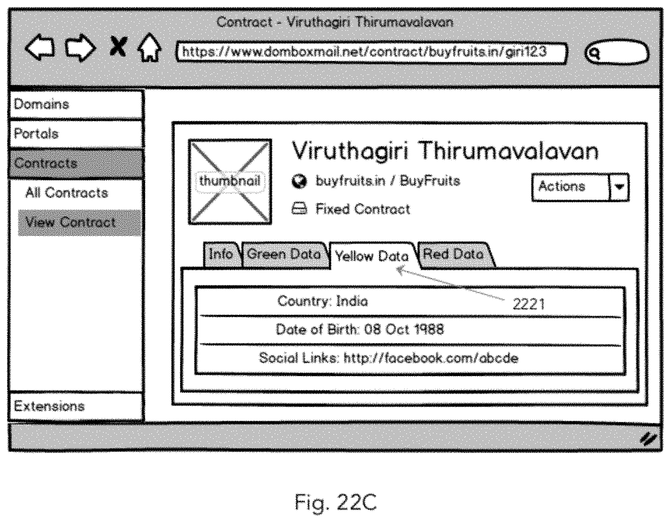

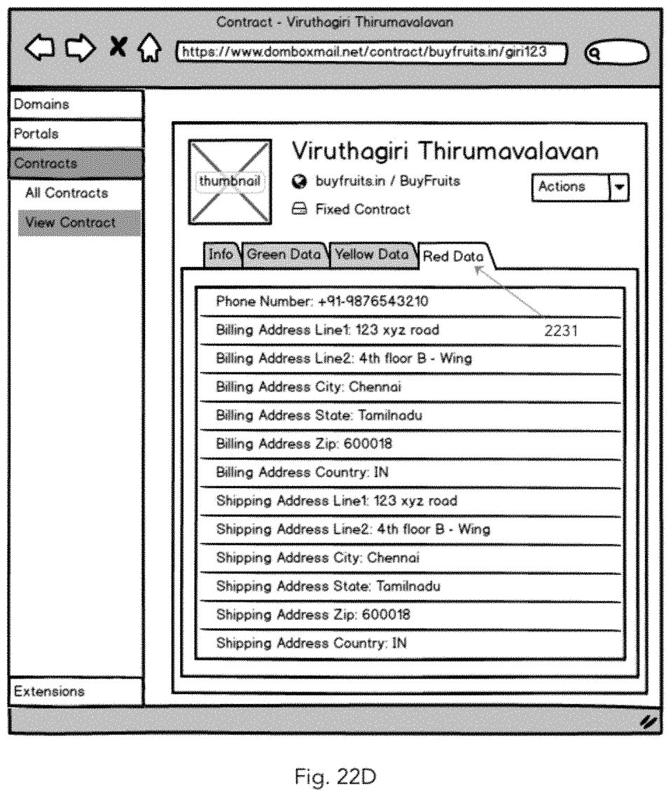

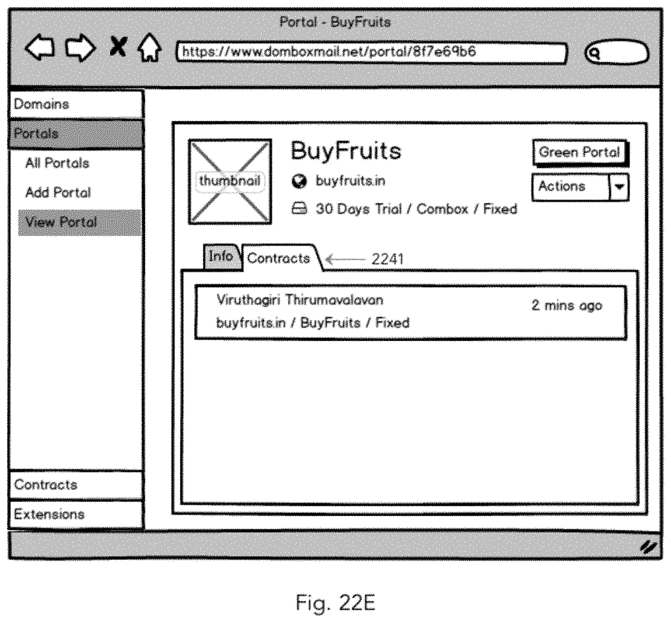

The contract can be viewed by the website owner from the dashboard. FIG. 20J illustrates the “All Contracts” page layout. When a Combox (C) is created for a Consumer, a contract related to that Combox (C) is created for Business. So the Business owner can view the contract or pull the contract related data via API. “All Contracts” page shows the contract 2091 between the consumer “Viruthagiri Thirumavalavan” and the business “buyfruits.in” which is created via the Portal “BuyFruits”. FIG. 22A illustrates the “View Contract—Info” page layout. The “View Contract” page, shows the Contract signed by “Viruthagiri Thirumavalavan” 2201. The contract details can be found under the “Info” 2202 tab. FIG. 22B illustrates the “View Contract—Green Data” page layout. The Green Data provided by the consumer can be found under “Green Data” 2211 tab. FIG. 22C illustrates the “View Contract—Yellow Data” page layout. The Yellow Data provided by the consumer can be found under “Yellow Data” 2221 tab. FIG. 22D illustrates the “View Contract—Red Data” page layout. The Red Data provided by the consumer can be found under “Red Data” 2231 tab. FIG. 22E illustrates the “View Portal—Contracts” page layout. In FIG. 22E, The contracts tab 2241 shows the contracts created via the BuyFruits portal.

8.25. Partner Policies

When a domain become our portal partner, they need to comply with certain policies. If they don't comply, then they may lose the contracts.

8.25.1. Fair Mailing Policy

In our system, we classify the mails into three categories. Conversational Mails, Transactional Mails and Promotional Mails. If you are Amazon, all your customer support mails are falling under the “Conversational Mails” category. All purchase receipts are falling under the “Transactional Mails” category. We have no restriction on the Conversational Mails and Transactional Mails. But for “Promotional Mails”, you must respect the user's subscription preference. If a user is unsubscribed, it means the user is not interested in receiving any “Promotional Mails” from you. However, you can send them “News-Letters” anytime you want. HeadsUp! It's “News-Letters”. Not “Newsletters”.

The term “Newsletter” heavily misused these days. Sometimes, when you click a random link found in the Google search results, you will get a popup saying “Subscribe to our Newsletter”.

Once you Opt-In, you are gonna get non-stop mails from that website. We are not talking about that kind of “Newsletters” here. In our terminology, The term “News-Letters” refers to “Newsworthy-Letters”. Pay attention to the “Hyphen”. So, the real question is “What exactly is a Newsworthy-Letter?”

Well . . . That depends on your industry. If your news can be termed as “big news”, “breaking news” etc. by your recipients, then those mails are definitely falling under “Newsworthy-Letters” category. e.g. We have been acquired by Microsoft, We have been Hacked, We introduced a new product etc. You are about to send this mail to all your users even to the people who unsubscribed. You don't want to annoy them. So just ask yourself this question.

If I were a Journalist in “[insert a well respected magazine name in your industry]”, would I report the news “[insert your mail subject here]” to the readers?

Examples=>If I were a Journalist in “Techcrunch”, would I report the news “We have been acquired by Microsoft” to the readers? If I were a Journalist in “Techcrunch”, would I report the news “20 reasons why our product is awesome” to the readers?

8.25.2. Fair Migration Policy

We have a “Fair Migration Policy” where you can rename the Combox mail address without consumer permission. However, you still need to notify the users about the domain change. For example, The consumer signed the contract on example.com and you would like to rename the domain to example.net. This would fall under our fair migration policy.

giri123$example.com@domboxmail.com=>giri123$example.net@domboxmail.com.

test123$example.com@domboxmail.com=>test123$example.net@domboxmail.com.

hello123$example.com@domboxmail.com=>hello123$example.net@domboxmail.com

But you cannot migrate a domain, contrary to its name. Consumer signed up to ILoveDonaldTrump.com. You cannot rename it to IHateDonaldTrump.com. Also, there will be a limitation in the migration feature. This is because we don't want the website owners to keep on renaming their domains.

Note: If you pivot your product to something else with a completely irrelevant domain, you cannot use our “Fair Migration” feature. You have to either ask your users to signup to your new product OR add a SAD record in your old domain by whitelisting the new domain. If you are going for the latter option, never lose access to your old domain.

9. Data

User Data is classified into three categories based on sensitivity. (i) Green Data—Low Sensitivity (ii) Yellow Data—Medium Sensitivity (iii) Red Data—High Sensitivity

Data access is a three-step process. (i) Consumers—Fills their personal data by editing the profile (ii) Business Owners—Request Consumer Data via Portal (iii) Consumers—Give permission to business to access their data via “Teleport”

Data entered in Green Data 2301, Yellow Data 2311 and Red Data 2321 will be given to third party websites with user permission via “Portals”

9.1. Green Data

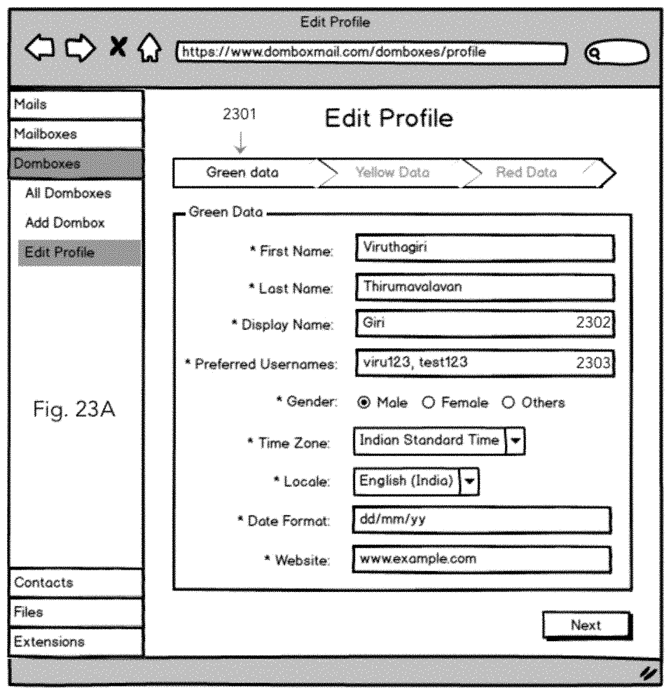

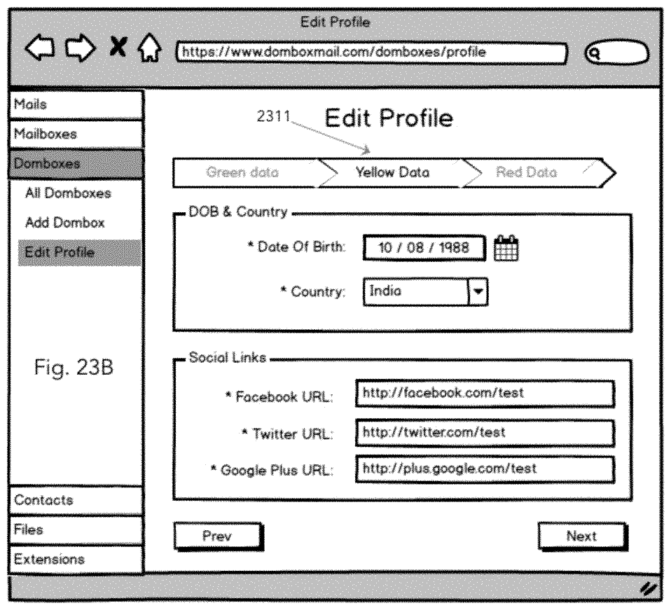

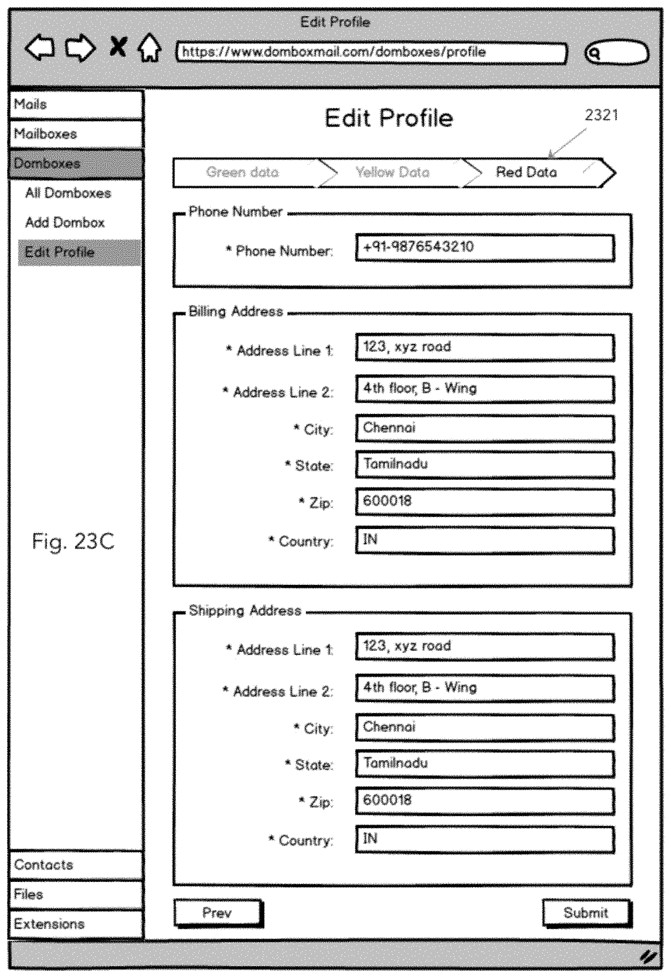

FIG. 23A illustrates the “Edit Profile—Green Data” page layout. If a third party website gets hacked, the damage is nearly null in this category. This is because all the data found in this category are Insensitive ones (including the user's email address). e.g. Back in 2013, 150 million Adobe accounts were hacked. If Adobe had only our green data, they can contact our consumers without any issues, on the other hand, this data is useless in the spammers hands. Because hacking this data is nothing more than crawling Facebook profiles. For most websites, only Green Data is enough. If you are a website owner, keep in mind you are discouraging user signups if you request “Yellow Data” and “Red Data” without a sensible reason.

“Green Data” 2301 contains the following fields. First Name, Last Name, Display Name, Preferred Usernames, Domkey, Email, Gender, Avatar, Age Group, Date Joined, Time Zone, Locale, Date Format, Website

(1) First Name—Self-Explanatory (2) Last Name—Self-Explanatory (3) Display Name 2302—Display name provided by the Consumer. If provided websites are advised to use this name in profile display instead of consumer's full name. (4) Preferred Usernames 2303—Some websites requires a username to create “Vanity URL”. This is a comma separated value. The website can use the usernames if available (5) Domkey—Explained already (6) Email—Isolated Email Address. Not the primary email (7) Gender—Consumer's Gender. It can be one of the following values. Male (M), Female (F), Others (O) (8) Avatar—Avatar URL (9) Age Group—Consumer's age group. If the consumer is in his/her twenties, then this value would be 20. If the consumer is in his/her thirties, then this value would be 30 and so on. The possible value would be from 10 to 120 (10) Date Joined—Consumer's signup date to the Dombox mail service. (11) TimeZone—Timezone value set by the Consumer. So the website can display date and time based on the consumer's time zone. (12) Locale—Preferred Language Locale value set by the Consumer. If the website supports the locale, then the website user interface would use that locale. e.g The value “en_US” means US English. The value “en_GB” means UK English (13) Date Format—Date format value set by the Consumer. So the website can display date based on the consumer's date format. (14) Website—Website value set by the Consumer. So the business can display the website URL in profile if provided.

9.2. Yellow Data

FIG. 23B illustrates the “Edit Profile—Yellow Data” page layout. If a third party website that contains the yellow data get hacked, then the damage is minimal. “Yellow Data” 2311 contains the following fields. Date of Birth, Country, Social Links. Keep in mind, the consumer has the option to decline Yellow Data and Red Data requests. Yellow Data and Red Data require a valid reason for each field. For instance, Yellow Data contains “Date Of Birth” field. If some website needs to access that data, then a valid reason is required from them. e.g. “Adult website. For age verification” is a valid reason. But “To send birthday wishes” is not.

(1) Date of Birth—We put the “DOB” field in the “Yellow” category because it requires moderate privacy. e.g. Search results for “Name: John Smith”=>10,000 results. Search results for “Name: John Smith and DOB: 05/05/1985”=>2 results. (2) Country—We put the “Country” field in the “Yellow” category because it also requires moderate privacy. e.g. Some websites may block users from a certain country. Users usually bypass that by faking the IP address with a “Proxy”. So giving country data to the website in “Green Data” is not a good idea (3) Social Links—Social Links are put in “Yellow” category because social profiles are prone to stalking.

9.3. Red Data

FIG. 23C illustrates the “Edit Profile—Red Data” page layout. Red Data 2321 contains highly sensitive fields. Phone Number, Billing Address, Shipping Address. These data will be helpful when signing up for e-commerce websites Again . . . the consumer has the option to decline the Red Data request. And Red Data requires a valid reason for each field. A portal that requests access for at least one “Red Data” field is called “Red Portal”. A portal that requests access for at least one “Yellow Data” data but not “Red Data” fields is called “Yellow Portal”. A portal that requests access for only “Green Data” fields is called “Green Portal”. By default, all portals have full access to this data.

9.4. Teleport Vs Others

Our “Teleport” button is created for a different purpose. You can put Facebook Connect and Google Connect buttons in the same bucket. But not the Teleport button. Our button has some novelty. All other buttons are like “Hello website owners, we have plenty of user data. Use our button and get access to everything”. But Teleport button is like “Hello website owners, User privacy is Important. Use our button. Get limited data access that's essential for signup and login. We can kill spam and you can take control of your users”. Besides, all other buttons have overcomplicated permissions. Take Google as an example. Their button can give access to the whole account. A few years back, “Pokemon Go” app had the “Full account access”. That means they have access to your Gmail, Contacts, Search History, Documents etc.. Why would a gaming app need all those permissions? If you are reading this document up to this point, then you are not an average user. So you are one of the few people who are capable of going through the app permissions before allowing access. But an average user who is going to play the game, don't have much patience in checking the App permissions. As for Facebook, their “Cambridge Analytica” situation says everything. “Teleport” button doesn't have these overcomplicated permissions. These are the Unique Selling Points of Teleport. (1) Spamless (2) Better Privacy (3) Transparency (4) Simplicity

Spamless—Teleport button creates an Isolated Mailbox and only 5 layer passed mail will be accepted. Better Privacy—Our Teleport button fixes one of the major privacy issues created by Gravatar. Gravatar privacy issue will be explained in a later section. Transparency—You can clearly see the data you provided to the third party website from your Combox page. Simplicity—The purpose of Teleport button is Signup and Login. Nothing more. No other data access other than the fields you see in the traditional Signup, Login and edit profile forms.

Teleport button is designed to attract “Minimal Attention” from the user. (i) Green Data—Looks Good (ii) Yellow Data—Pay Attention (iii) Red Data—Pay Strict Attention

Our “Teleport” consent screen interface is designed based on the Data Type. If the Portal is “Red Portal”, then the interface will be in Red Colour. If it is a “Green Portal”, then the portal will be in “Green Colour”. So our “Teleport” button offers clarity.

Does that mean, developers cannot access any other data via API? The answer is No. We may allow developers to access other user data in the future. However, we will definitely brand the API differently. In other words, If you see the term “Portal” and “Teleport”, then only those limited Green, Yellow and Red data fields can be accessed. Nothing more. Because 99% of the time, when people click the “Signup with Google” or “Signup with Facebook” kind of button, they are there to “Signup”. Not to give access to their entire data. Also, note that we are not a social networking website and we have no plans to become one. So there is no need for a website to put a message like “We don't share anything without your permission”. So our button is “Less Scary”. Since the “Teleport” button only offers access to rarely changing data, there is no need for a “Revoke Access” button.

10. Telescribe

10.1. Box Type—Hybrid (H)

Hybrid (H) box is the same as Combox (C) except it can be put offline and deleted. Or you could say Hybrid (H) box is the same as Dombox (D) except it needs to pass all 5 layers. Hybrid (H) box offers both Dombox (D) features as well as Combox (C) features. So it's the love child of Dombox (D) and Combox (C). Hybrid (H) box type can be helpful in three situations. (1) Telescribe—Our “One-Click” newsletter subscription service (2) Upgrade—Consumers can voluntarily upgrade from “Dombox” to “Hybrid” if they are absolutely sure that the website “Pass” all 5 layers (3) Downgrade—When a contract gets terminated, the box will be downgraded from “Combox” to “Hybrid”.

10.2. Dombox vs Hybrid vs Combox

Dombox (D)=>Make Offline?: Yes, Delete?: Yes, All 5 layers must be passed?: No

Combox (C)=>Make Offline?: No, Delete?: No, All 5 layers must be passed?: Yes

Hybrid (H)=>Make Offline?: Yes, Delete?: Yes, All 5 layers must be passed?: Yes

10.3. Telescribe

As of now, To subscribe to 3rd party website newsletters, consumers need to fill a form 2502. It usually contains the following fields. A name field. An email field. And a Submit button 2502. Title of this form usually be “Subscribe to our Newsletter”. When you fill the form and submit, the process is called Single Opt-In. Now some newsletter services require a confirmation. So you will get a confirmation email. If you confirm by clicking the link, then you become a subscriber. This confirm process is called Double Opt-In. Think about it. What's stopping someone from submitting your email address in a newsletter subscription form. In order to prevent email misuse, a website requires the Double Opt-In process. Otherwise, the website may be spamming people. To make the subscription process easier, Dombox mail service introducing a button called “Telescribe” 2501. Think of it like a Facebook Like or Twitter Follow button you see on websites, but for email newsletter subscription. “Telescribe” is our one-click newsletter subscribe button. When the user clicks the “Telescribe” button, a Hybrid (H) box will be created for the domain.

Telescribe button is not an alternative to 3rd party newsletter services like mailchimp. The business still need to depend on 3rd party newsletter services to send newsletters. Telescribe button only make the subscription process easier. I.e. Telescribe button only help the website/domain to build a e-newsletter list. So Telescribe is only for generating leads. The 3rd party newsletter services can be notified when a consumer subscribe or unsubscribe via apis and webhooks. Keep in mind, if a box already exists for that domain, then only the subscription status will be changed. This button can be displayed in any website by anyone using javascript. The js library url structure would look like this https://js.domboxmail.com/telescribe.js

A website can even display other website's telescribe button. Only a user who is logged in to Dombox mail service can subscribe. In dombox terminology telescribe. When the user clicks “Telescribe” button 2501, it creates a Hybrid (H) box 2511. Remember, Hybrid (H) box can be deleted anytime. But must pass all 5 layer checks. In other words, anyone can display the button. But only the “Dombox Domain” and their “SAD domains” can send mails. A consumer can Unsubscribe via the same “Telescribe” button. If the consumer uses the same Telescribe button to unsubscribe, then the box will get deleted if it meets the following conditions. (1) The box is a Hybrid box (2) The box was created via Telescribe button (3) The box is a Virgin box. Meaning no emails ever received to that box. If those conditions are not met, then only the box subscription status will be changed to “unsubscribed”. A consumer can also “Subscribe” 1537 and “Unsubscribe” 1538 using the options found in the Dombox “Actions” 1531 button.

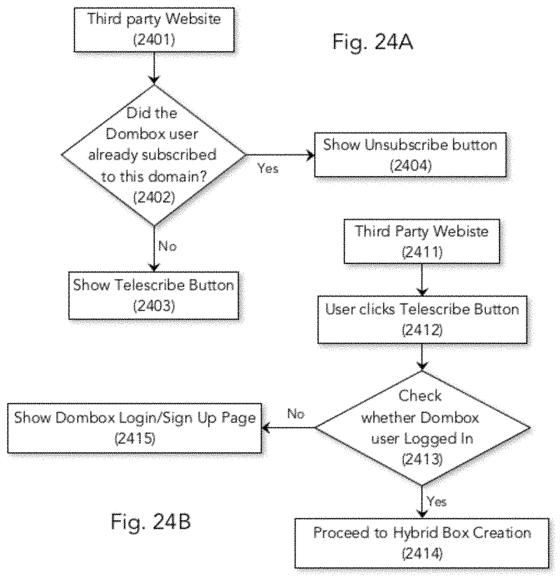

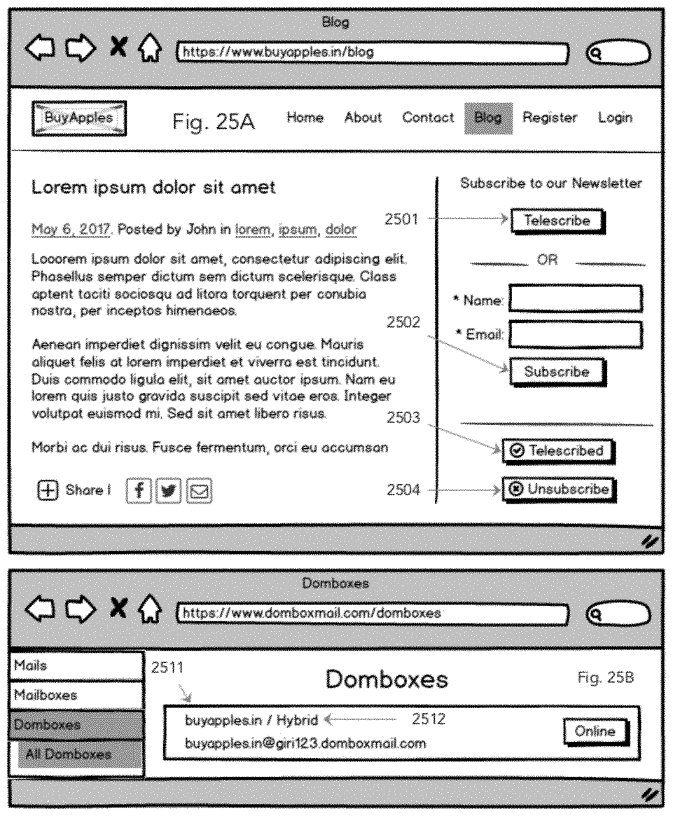

FIG. 24A illustrates the logical flow of Telescribe button display. A third party website 2401 has already added the telescribe.js. On page load, we check whether the consumer has already subscribed to the domain or not 2402. If the consumer has not already subscribed to the domain or if the consumer has not already logged-in to the dombox mail service, then we display the Telescribe button 2403. If the consumer has already subscribed to the domain, then we display the Unsubscribe button 2404.

FIG. 24B illustrates the logical flow of Dombox creation via Telescribe button. When a consumer clicks the Telescribe button 2412 on a third party website 2411, we check whether the user has already logged-in to the dombox mail service or not 2413. If the user has already logged-in, then we proceed to Hybrid box creation 2414. Otherwise we display the Login and Signup page of Dombox mail service 2415.

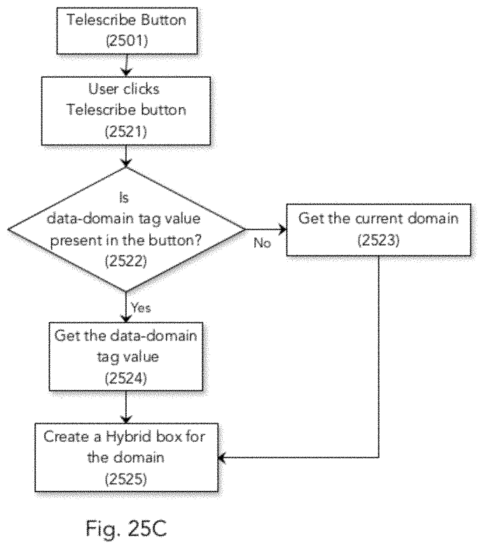

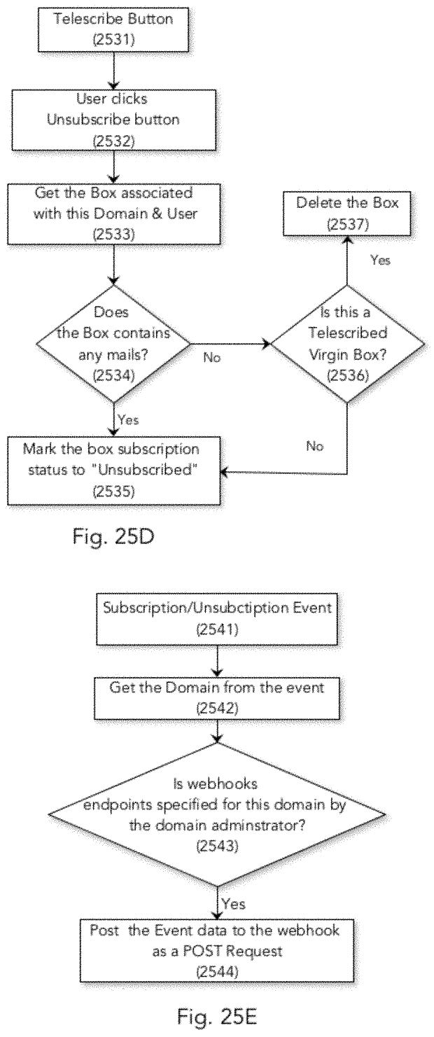

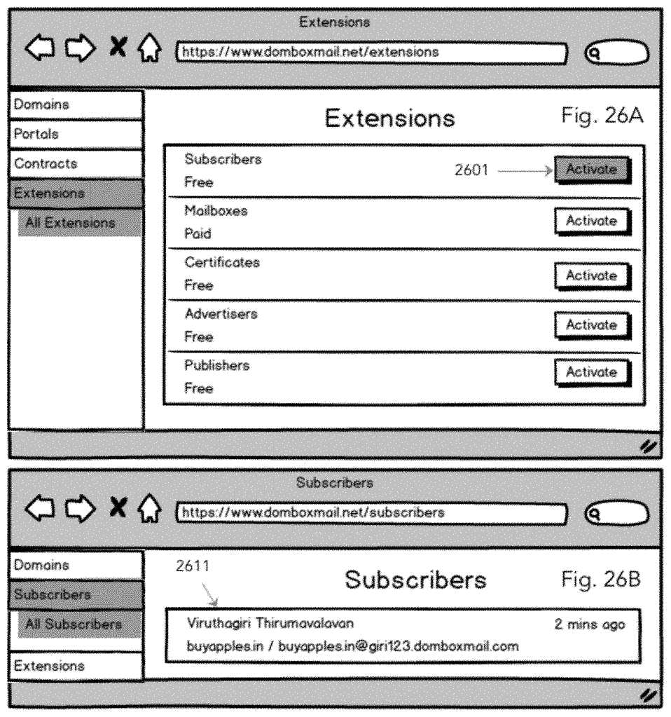

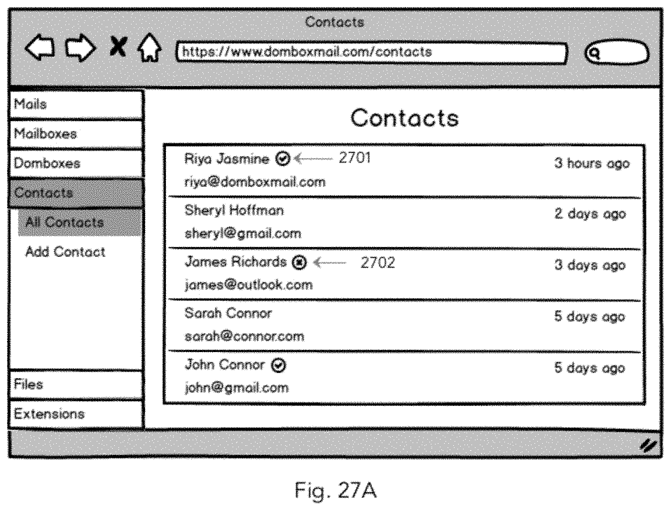

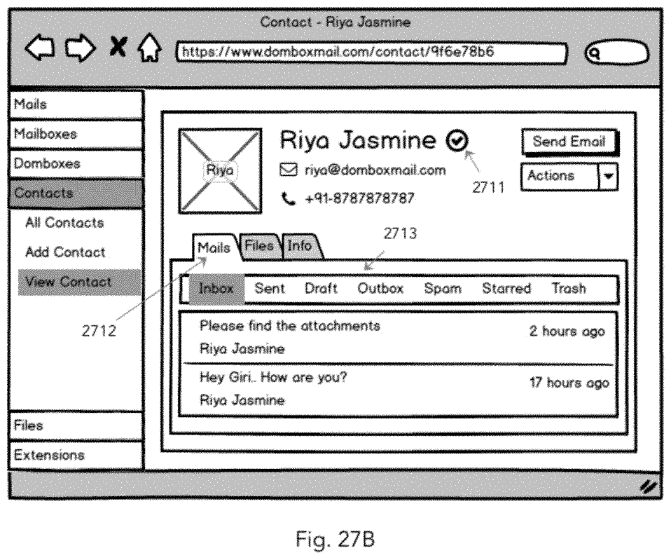

FIG. 25C illustrates the logical flow of Telescribe button domain selection. When a Telescribe button is added by the website owner, it is usually for the current domain. The website owner first add the following js code in the page head. <script type=‘text/javascript’src=‘https://js.domboxmail.com/telescribe.js’></script>. To display the Telescribe button for the current domain, then the website owner should add the following code. <div class=“telescribe”></div>. That code will display the button for the current domain. If the current domain is buyfruits.in then the Telescribe button is intended for buyfruits.in. However in some cases the website owner may display the Telescribe button for another domain. If the current domain is buyfruits.in and the website owner would like to display button for buyapples.in, then the website owner should use the data-domain tag to specify the domain. <div class=“telescribe”data-domain=“buyapples.in”></div>. When a user clicks the Telescribe button 2521, we check whether the data-domain attribute value is present in the button 2522. If present, then we extract the data-domain value 2524 and then create the Hybrid box for that domain 2525. If not present, then we get the current domain 2523 and create the Hybrid box for that domain 2525.

FIG. 25D illustrates the logical flow of Telescribe unsubscribe process. When a consumer clicks the Unsubscribe button 2532 on a third party website 2531, we pull the associated box 2533 for that consumer. We check whether the box contains any mails or not 2534. If the box contains any mail, then we just change the box subscription status to “Unsubscribed” 2535. If the box doesn't contain any mail, then we check whether the box is a “Telescribed virgin box” 2536. A “Telescribed virgin box” is a Hybrid box that never received any mails in its lifetime and created via the Telescribe button. If the box is a “Telescribed virgin box”, then we delete the box 2537 when the user clicks “Unsubscribe” button. If the box is not a “Telescribed virgin box”, then we just change the box subscription status to “Unsubscribed” 2535.

10.4. Managers

FIG. 25E illustrates the logical flow of Telescribe webhooks notification process. Some websites use third party newsletter services to send out newsletters. Third party newsletter services can sign up for a manager account in our system. In our system terminology these third party newsletter services who has manager account are called “Managers”. We will be providing API for 3rd party newsletter services with “Webhooks” support. When there is a subscription or unsubscription event 2541 from the button, we get the associated domain 2542 and then check whether webhooks are provided by the domain administrator or the manager 2543, then we post the event data 2541 as an HTTP POST request 2544. Just like a website become our “Portal Partner”, third party newsletter services can become our “Managing Partner” [Note: This term has nothing to do with our company Management]. You will be seeing a button like “Manage My Domain” or “Manage My Subscribers” in third party newsletter service websites. In “Teleport” button, the “consumer” is giving permission to “Dombox, Inc.” to let the “Business” access their personal data. In “Manage My Domain” button, the “Business Owner” is giving permission to “Dombox, Inc.” to let the “Manager” access their subscribers data. Keep in mind, “Managers” will have access to only limited data. Full Name, Email, Subscription Status and Date Subscribed [Or we may allow access to all “Green” Data since its insensitive]. For example, mailchimp.com has a manager account in our system. If buyfruits.in business owner give permission to the Mailchimp, then mailchimp can access the buyfruits.in subscribers info via API.

A subscriber is the main subject of a subscription. The subscription status can be “subscribed” or “unsubscribed”. The term “subscription-manager” refers to the third party application that has a “Manager” account in our system. Managers usually manage the e-subscription list of a service. The term “subscription-data” refers to the data accessed by the “subscription-manager”. The data access requires the “service owner” permission.

The term “subscription-data provider” refers to the entity that provides the “subscription-data” to the “subscription-data manager”. In our case, it's Dombox, Inc. The term “manager-client application” refers to the API application registered in our system by the manager. E.g. OAuth App. The term “manage-button” refers to the auth-button displayed on the application owned by the manager. e.g. “Manage My Domain”, “Manage My Subscribers” etc.

FIG. 25A illustrates the 3rd party website page where “Telescribe” button is displayed. When the telescribe.js added, the Telescribe 2501 button will be displayed. When a consumer is already subscribed to the domain, then the Telescribe button will be displayed with label “Telescribed” 2503. When the Telescribe button is displayed with label “Telescribed” 2503, then consumer have to hover over the button to see the “Unsubscribe” 2504 label. The consumer can unsubscribe using the Unsubscribe 2504 button. FIG. 25B illustrates the “All Domboxes” page where buyapples.in “Hybrid” Box can be viewed.

When a consumer clicks the Telescribe 2501 button, a Hybrid (H) 2512 box will be created as shown in FIG. 25B. FIG. 25B shows the Hybrid (H) 2512 box created via the Telescribe 2501 button for buyapples.in 2511

10.5. Subscribers

Telescribe button will be used for Subscribe/Unsubscribe. However, Consumers can also Subscribe/Unsubscribe from the box itself as shown in FIG. 15D. As for the domain owners, Domain verification is necessary to access the “Subscribers” data, but “Good Standing” is not a requirement unless your domain is a “Portal Partner”. Portal Partners are advised to respect the user's subscription preference. If a user is unsubscribed, that means he/she is not interested in receiving any “Promotional Mails” from the business. Please send only Conversational Mails and Transactional Mails. Domain owners can access the “Subscribers” data via API in the future. To view subscribers, website owner need to activate the “Subscribers” extension.

We will also have an Extension called “Subscriptions” for consumers. This will list all their subscriptions

FIG. 26A illustrates the “subscribers” extension activation process. To view and browse the subscribers, the website owner need to activate 2601 the “Subscribers” extension.

FIG. 26B illustrates the “All Subscribers” page layout. The “All Subscribers” page lists all the subscribers who are interested in receiving newsletters. FIG. 26B contains the subscriber “Viruthagiri Thirumavalavan” 2611 who subscribed via buyapples.in Telescribe button 2501

11. Contacts

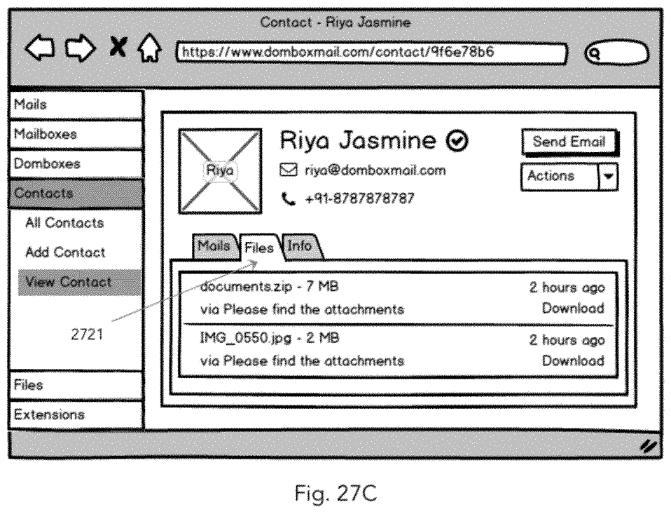

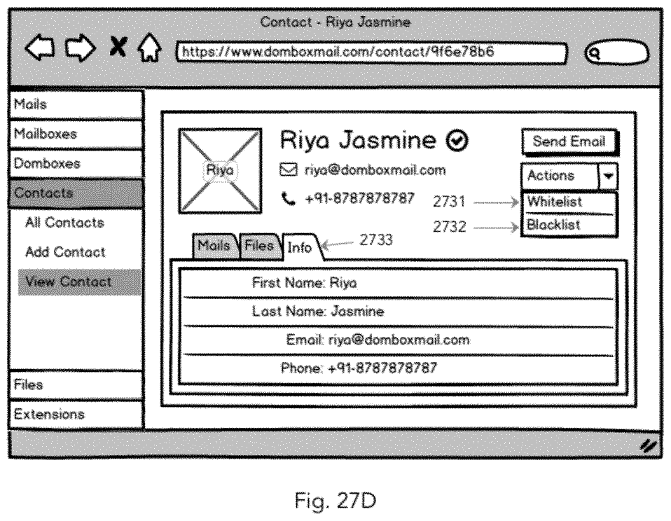

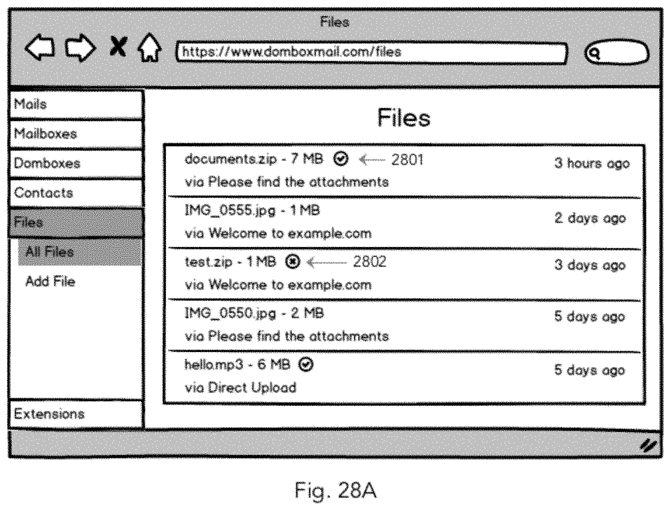

FIG. 27A illustrates the “All Contacts” page layout. The contacts can be imported or can be added manually by the user. By default, all contacts in your “Address Book” will be considered as “Neutral” contacts. But a contact can be Whitelisted 2701 or Blacklisted 2702. Mails from Blacklisted 2702 contacts will be rejected immediately. If a contact is whitelisted, you will see a “Green Checkmark” right next to the contact name. If a contact is blacklisted, you will see a “Red X mark” right next to the contact name.

FIG. 27B illustrates the “View Contact” page layout. The green check icon 2711 next to the contact name says that it is a Whitelisted contact. The “View Contact” page usually contains contact info like Name, Avatar, Email address and Phone number. All the mails 2713 related to that contact can be viewed from the Mails 2712 tab.

FIG. 27C illustrates the “View Contact—Files” page layout. Files tab 2721 lists the files related to that Contact. It lists the mail attachments and files found related to that contact. e.g. Sent to that contact, Received from that contact, shared by that contact etc.

FIG. 27D illustrates the “View Contact—Info” page layout. User can view the detailed info 2733 about the contact in this page. User can Whitelist 2731 or Blacklist 2732 the contact using the Actions button.

12. Files

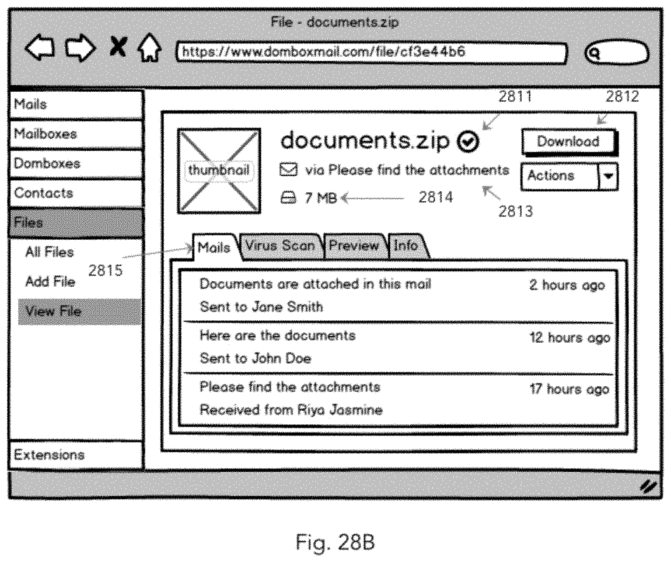

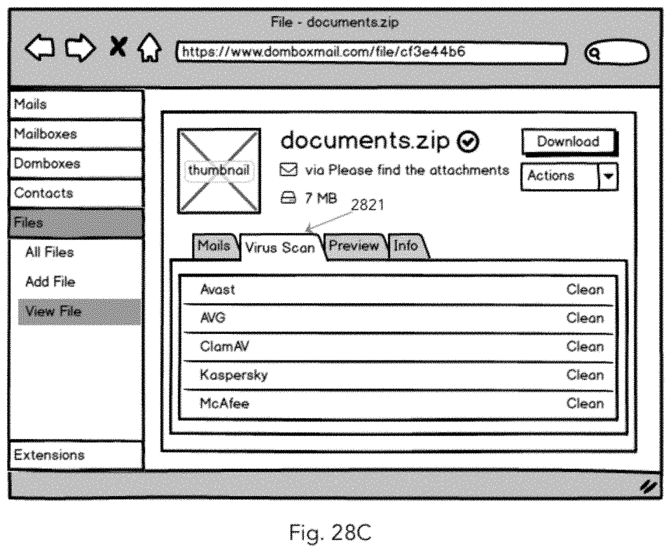

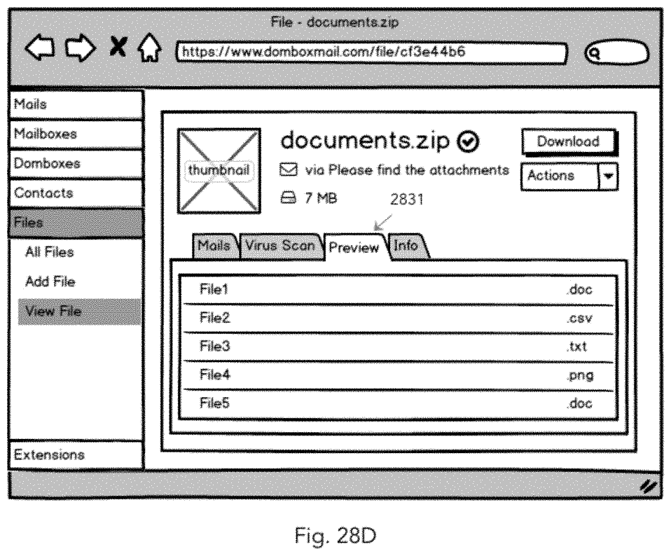

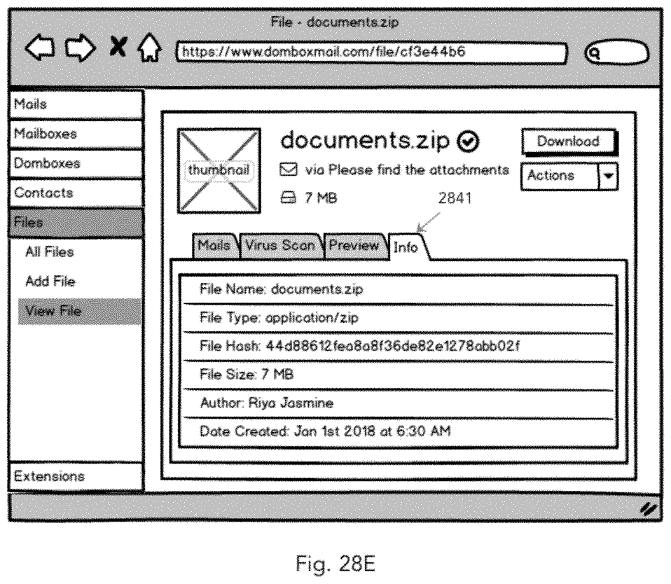

FIG. 28A illustrates the “All Files” page layout. The files can be attachment from mails or can be uploaded directly by the user. When a file is uploaded or received, it will be scanned for viruses.

If the file is clean, a green check mark icon 2801 will be displayed. If the file contains a virus, a red “x” icon 2802 will be displayed right next to the file name.

FIG. 28B illustrates the “View File” page layout. The green check icon 2811 next to the file name says that the file is clean and safe for download. The page contains File name, File Size 2814, File thumbnail and Download button 2812. If the file is uploaded directly by the user, then the text “via Direct Upload” will be displayed. If the file is received as an email attachment then the text “via {mail subject}” 2813 will be displayed. If the original mail is deleted then the “via {mail subject}” part will be displayed in strikethrough text. If the file is attached in mails, it can be viewed from the mails 2815 tab.

FIG. 28C illustrates the “View File—Virus Scan” page layout. The virus scan tab 2821 lists the virus scan results of that file for each engine.

FIG. 28D illustrates the “View File—Preview” page layout. The preview tab 2831 displays the file contents if it is a compressed file, image preview if its an image like jpg, png, gif. Media player if its a video or audio. Document preview if it is a document etc.

FIG. 28E illustrates the “View File—Info” page layout. The info tab 2841 contains file info like file name, file type, file hash, file size, author and date.

FIG. 1B illustrates the end result after completing the Isolation phase. Note: “Normal Mailboxes” 201 still can be able to accept mails from websites and apps at this stage. That's why Mailboxes part contains website and app icons in the last figure.

13. Restriction

“Domboxes” 202 definitely gonna protect the consumer from spammers because each dombox can receive mails only from the “Dombox Domain” and its “SAD Domains”. But what about “Mailboxes”? They can receive mail from anyone, right? For instance, What happens when the consumer's Primary (P) mail address is in a spammer's hand? For the record, Mailboxes 201 allows mail from anyone. So it's hard to differentiate the spammers in Mailboxes 201 group. There are ways a spammer can acquire your primary email address. e.g. These days every app ask you to invite your friends. We have friends who sell us out by giving full access to their “Google Contacts” and “Facebook Contacts” for some extra life in games. Most likely you have such friends too. So a hacker can hack those app servers and get your contact from there. A hacker can also post the data dump in public forums. The trick is not in preventing spammers from getting your primary email address. It's in making your primary email address useless in the spammer's hands. We are gonna make it restricted. Its like hanging a sign “Restricted Area. Do not Enter. Authorized Personnel Only.” These “authorized personnel” are the Whitelisted and Neutral contacts found in your “Address Book”. Restriction Phase actually contains two modes. (A) Restricted Mode (B) Greylisted Mode

13.1. Restricted Mode

To prevent spam in Mailboxes, we have an option called “Restricted Mode” for the boxes found in Mailboxes 201. This mode applicable only for the boxes found in “Mailboxes” 201 group. But a user can use this mode only when the user has “Domboxes” extension enabled. So “Restricted Mode” option is for “Mailboxes”, but the user need “Domboxes” 202 to use this feature. “Restriction” is a subprocess of “Isolation”. The idea is that you are actually offloading all website related mails (i.e. Promotional Mails and Transactional Mails) to the Domboxes 202. So only Conversational mails are what's left in Mailboxes. You can find most of your “Conversational Mails” contacts in your “Address Book”. So when you enable “Restricted Mode”, you are asking us to allow emails only from the contacts found in your “Address Book”. {Refer FIG. 27A}. Restricted Mode is an optional feature. By default, it's turned off. You need to enable it to use that feature. When you enable “Restricted Mode” for the first time, you must agree to our “Restricted Mode” terms. e.g. You must use that box only for “Conversational Mails” after you enable “Restricted Mode”. You can turn on/turn off this mode anytime. When it's turned off, it allows emails from everyone. But not from the “Blacklisted” contacts 2702. When it's turned on, it allows emails only from the “Whitelisted” and “Neutral” contacts. For all others “Injection” rules apply. If you send an email to a new contact, it will be automatically whitelisted. If you ever deactivate the Domboxes extension, then the restricted mode will be deactivated too.

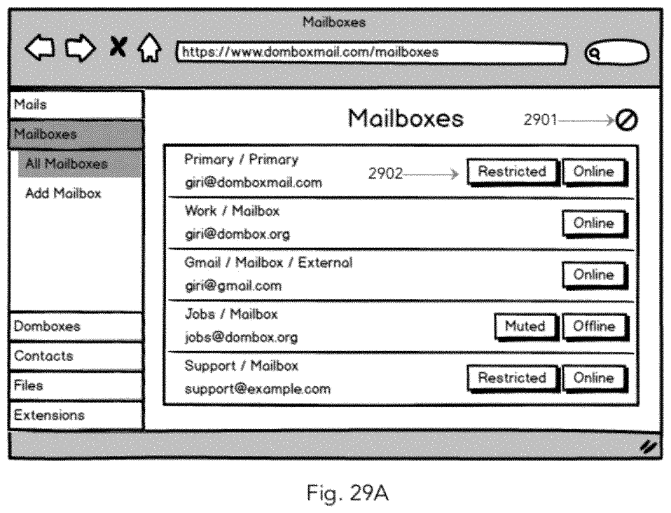

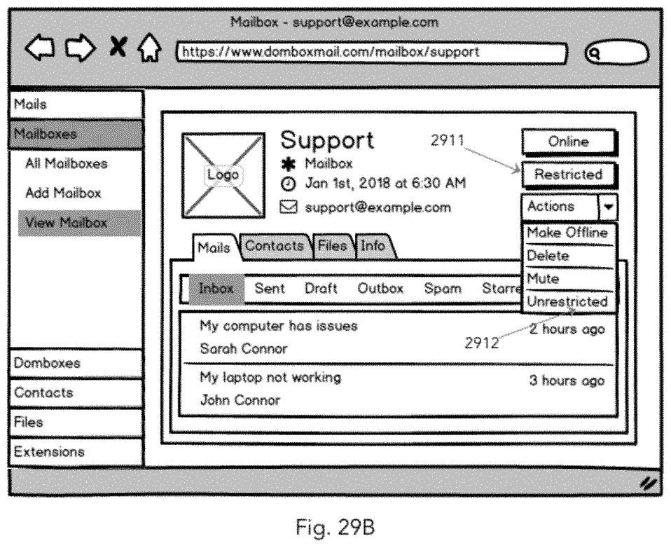

FIG. 29A illustrates the “All Mailboxes” page with “Restricted” mode enabled. “Restricted Mode” can be globally active 2901 for all Mailboxes or Locally active 2902 for individual Mailbox. If Globally active 2901, then all boxes found in Mailboxes group will be restricted. If Globally not active, then only the locally active 2902 mailboxes will be restricted.

The global setting 2901 overrides the Local setting. In FIG. 29A “Work/Mailbox” doesn't have “Restricted Mode” enabled. But since the “Restricted Mode” is globally active 2901, “Work/Mailbox” also restricted now.

FIG. 29B illustrates the “View Mailbox” page with “Restricted” mode enabled. The consumer can enable or disable 2912 the “Restricted Mode” 2911 mode for the box using the options found under the “Actions” button.

13.2. Warning Text

When you enable “Restricted Mode”, the warning text would look something like this.

Caution: You are about to enter a sensitive zone. “Restricted Mode” is intended for the boxes that deals with only conversational mails. So offload all website related mails to the Domboxes before you enable this mode. When the Restricted Mode is ON, we will send a challenge mail to the Sender if the sender is not found in your “Address Book”. Real users can respond to those challenges. e.g. CAPTCHA. But automated and bulk mailers cannot. So their mails never gonna reach your inbox when the box is Restricted. Do you understand what you are signing up for? (a) Yes, I know what I'm doing (b) No, Get me out of here.

Users need to accept our “Restricted Mode” terms and condition before enabling that. They have to agree that the box will be used only for “Conversational Mails” and our company takes no responsibility if “website related mails” missing when sent to a Restricted box.

13.3. Greylisted Mode

This mode applicable only for the boxes found in “Domboxes” 202 group. This mode applicable only for certain boxes in “Domboxes” group. Same “Restricted Mode” rules apply with few exceptions. Domboxes are Domain-based isolated mailboxes and it usually verifies whether the “Envelope Domain and Message Domain” is authorized to send emails for the “Dombox Domain”. Since we are verifying “only the domain” and not its users, there is a possibility where spammers use free mail services like gmail.com to send out spam. For example, the consumer “Giri” creates a Dombox for gmail.com and give it to the user John Doe who has email address john@gmail.com. Jane Smith is a spammer who also has a free Gmail account jane@gmail.com. Jane Smith can now send spam to Giri's gmail.com Dombox. “Greylisted” mode is similar to “Restricted” mode. Except the “Greylisted” mode is applicable only to Domboxes 202 whereas the “Restricted” mode applicable only to Mailboxes 201. Just like “Restricted” mode, all incoming emails are restricted to “Address Book” in “Greylisted” mode too. Only the people found in the “Address Book” are allowed to send emails to the consumer. However, for “Greylisted” mode, only the Dombox Domain's contacts (i.e. @gmail.com in this case) are allowed whereas in “Restricted” mode all contacts are allowed. “Greylisted” mode applicable only for the popular mail services where anyone can signup and send emails. “Greylisted” mode automatically enabled when the consumer creates a “Dombox” for free mail service domains like @gmail.com, @yahoo.com, @outlook.com, @domboxmail.com etc. Note for website owners: If a greylisted domain is found in your SAD record, then we won't consider that as valid SAD domain. e.g “v=sad1 gmail.com:r+b example.com:s-all”. In this case, only example.com is considered as a valid SAD domain. Mails from gmail.com will be rejected in your domain's dombox. Restricted and Greylisted Mode works better for the domains, that has “Pass” result for “Alignment Layer”. So if the user received a mail from matt@example.com, and the mail info shows “Pass” for “Alignment Layer” in “Mailboxes”, that means that domain is safe from spammers. Spammers cannot spoof that domain. So most likely the mail the user received is a “Genuine” one.

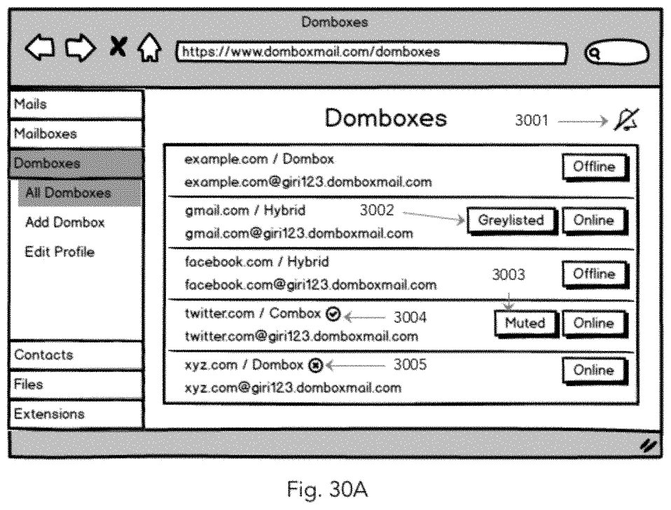

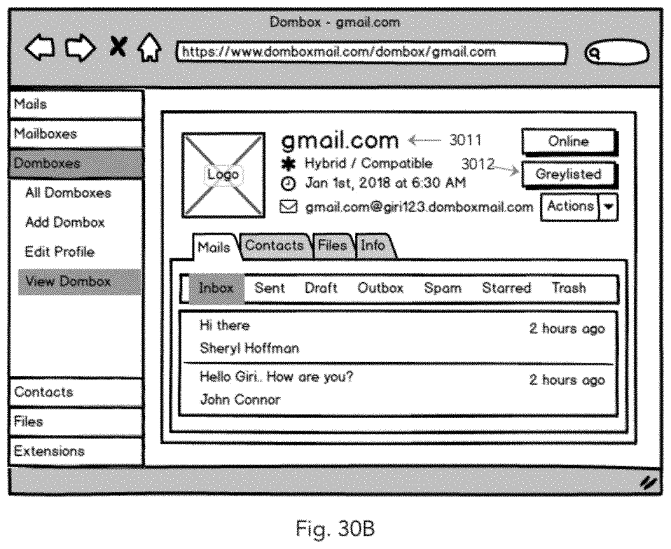

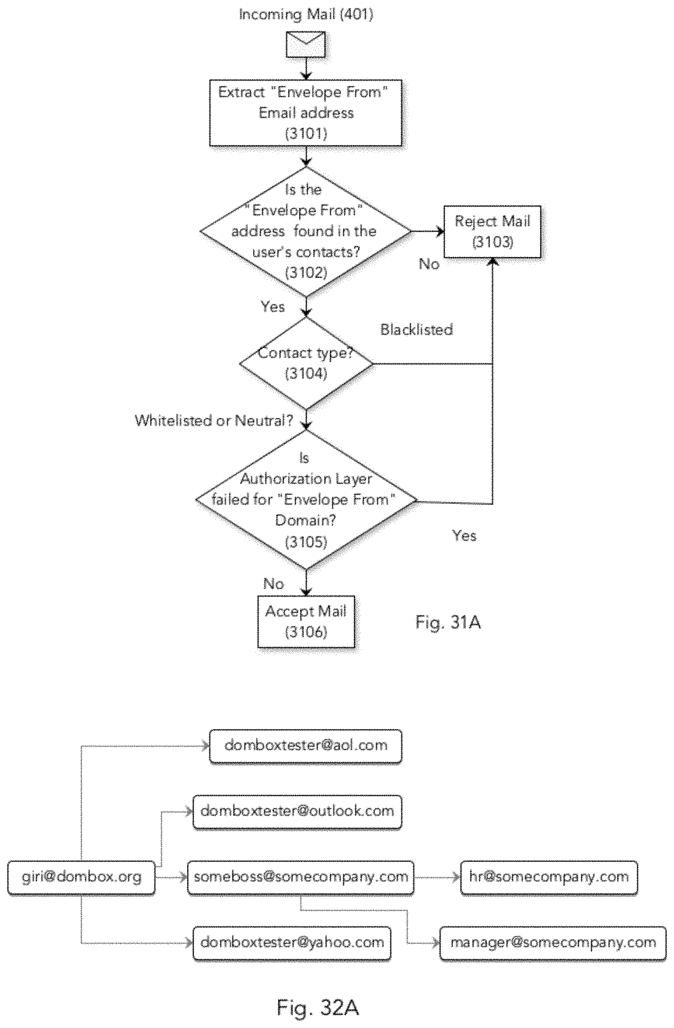

FIG. 30A illustrates the “All Domboxes” page with “Greylisted” domains. There is no setting for enabling “Greylisted” 3002 mode. Its automatically enabled when the consumer create a box for free mail domains like @gmail.com, @yahoo.com, @outlook.com, @domboxmail.com etc. “Mute” mode can be Globally active 3001 and/or Locally active 3003. In FIG. 30A, the Mute mode is “Globally” active 3001. Except Primary (P) box, all boxes can be Muted. When a box is “Muted”, notifications are disabled for that box. e.g. browser notifications, mobile notifications, etc.

FIG. 30B illustrates the “View Dombox” page with “Greylisted” mode enabled. In FIG. 30B gmail.com 3011 has the “Greylisted” 3012 mode and it's automatically enabled. Both “Restricted” 2911 mode and “Greylisted” 3012 mode allows the user to send mail to anyone from that box. So there is no restriction when sending mail. The restriction is applied only when receiving mail. When a consumer send an email to a person who is not on the “Address Book”, while “Restricted” and “Greylisted” mode enabled, then that email address will be “whitelisted” automatically. So the consumer can receive replies from that contact anytime in the future.

FIG. 31A illustrates the logical flow of mail delivery when “Restricted” and “Greylisted” mode enabled. We extract the “Envelope From” email address 3101 from the Incoming Mail 401 We check whether the “Envelope From” email address exists in the consumer's Address Book 3102 {FIG. 27A}. Note: For “Restricted” boxes, we check for all contacts, but for “Greylisted” boxes, we check only for that particular “Dombox Domain” contacts. If the contact does not exist, then we reject the mail immediately 3103. If found, then we get the contact type from the contact 3104. If the contact type is “Blacklisted”, then we reject the mail immediately 3103. If the contact type is “Whitelisted” or “Neutral”, then we check the Authorization Layer 422 result for the “Envelope From” domain 3105. If the Authorization Layer result is “Fail”, then we reject the mail immediately 3103. If the Authorization Layer result is “Pass” or “Neutral”, then we accept the mail. 3106

FIG. 1C illustrates the system before enabling Restricted Mode. Pay attention to the Mailboxes part. No website and app icons there. Only human icons available now [Which means Conversational Mails]. FIG. 1D illustrates the system after enabling Restricted Mode.

14. Injection

Although we made our system bulletproof from spammers via “Isolation” and “Restriction”, we also made our system bulletproof from “Genuine Unknown Senders”. So we need to improve the system. This phase only deals with “Strangers” and rely on methods like Spam Filters, Challenge/Response mechanism etc. to detect spam mails. There are many methods available in this phase. E.g. CAPTCHA method.

We are gonna send an email back asking the sender to fill CAPTCHA. This type of system is known as Challenge/Response mechanism and it was first introduced in 1997. The reason C/R mechanism is not popular even after two decades is because, (1) All other solution sends challenge mails even to bulk mailers like MailChimp. So bulk mailers cannot respond to challenges. [We solved this issue with Domboxes. Domboxes provides exclusive unrestricted privilege for domains to send mails to their Dombox.] (2) Challenge mails are heavily suffering from backscatter attacks. i.e. Bad guy forge the mail like it's coming from president@whitehouse.gov. Challenge mails are being sent to president@whitehouse.gov

Injection phase applicable only for Conversational Mails. Conversational Mails can be termed as Human-to-Human, Mailbox-to-Mailbox and MX-to-MX mails. We primarily check whether the incoming mail is coming from one of the MX Record IP addresses or the SPF record IP addresses. If Yes, then we are going to send our challenge mails back. If not, we are gonna reject the mails immediately.

The crystal clear way of knowing “conversational mails” from “website related mails” is what makes our system click. To summarise, Isolation for apps and websites. Restriction for friends, family, colleagues and acquaintances (i.e. People found in your Address Book aka. Authorized Personnel) and Injection for Strangers.

Let's look at the available methods.

14.1. Spam Filters

We apply the typical spam filters mechanism here. Please note our system accepts mails only from “Verified Strangers”. The term “Verified Strangers” will be explained later.

14.2. Ping

Injection phase deals with only conversational mails. Conversational mail means mailbox on both sides. We can use a ping mechanism to check whether the sender address is really exists. For example, FIG. 5B illustrates an incoming mail from john@example.com. Once we accept this mail, we are gonna put the accepted mail in a “Pending” folder. We check whether john@example.com is valid mailbox by connecting to one of example.com MX servers.

mail.domboxmail.com Connecting to mx1.example.com with its IP address

example.com=>220 mx1.example.com Example.com SMTP Service Ready

domboxmail.com=>HELO mail.domboxmail.com

example.com=>250 Hello, nice to meet you, mail.domboxmail.com

domboxmail.com=>MAIL FROM: <example.com@giri123.domboxmail.com>

example.com=>250 OK

domboxmail.com=>RCPT TO: <john@example.com>

example.com=>250 OK

domboxmail.com=>QUIT

example.com=>221 Bye

If example.com returns 250 code for the RCPT TO command, then it's a valid mailbox. We move the mail from “Pending” folder to “Inbox”. We can also perform additional checks by passing into a spam filter before moving the mail to inbox.

14.3. Intro via a Mutual Contact

Task Performed By: Mutual Contact, Estimated Burden: ˜1 Minute/Automatic during a conversation.

From: giri@dombox.org; To: domboxtester@gmail.com, domboxtester@outlook.com, domboxtester@yahoo.com, domboxtester@aol.com; CC: someboss@somecompany.com; BCC: someotherboss@somecompany.com

Just think of domboxtester@gmail.com as a “Restricted Box” and giri@dombox.org is a whitelisted contact in that box. So giri@dombox.org can mail to domboxtester@gmail.com without any issues. Because that contact is trusted by the receiver.

14.3.1. Chain of Trust

From the domboxtester@gmail.com perspective, the following 4 contacts are “never before seen” contacts. domboxtester@outlook.com, domboxtester@yahoo.com, domboxtester@aol.com, someboss@somecompany.com. But since they are actually introduced via a trusted contact giri@dombox.org, we are gonna trust these 4 email addresses. Let's say someboss@somecompany.com introduces two more “never before seen” contacts. manager@somecompany.com, hr@somecompany.com

FIG. 32A illustrates the chain of trust. We cannot keep going forever on the chain. So we should have a maximum limit for the depth. e.g. 5 {Think of it like a nested comment system. There should be a limit in the depth.} In FIG. 32A, giri@dombox.org is a trusted contact. But domboxtester@outlook.com, domboxtester@yahoo.com, domboxtester@aol.com and someboss@somecompany.com are nothing but “Level 1 Guests” until those contacts moved to the “Address Book” by the receiver/owner. manager@somecompany.com and hr@somecompany.com are “Level 2 Guests”. We should have a list called “Guest List”. Contacts found in the “Guest List” should have limited privileges. e.g. Limit the number of mails that can be accepted from that contact in a day, Limit the number of contacts that can be introduced via that contact etc. The receiver/owner should be able to move the contact from “Guest List” to the “Address Book”. The system automatically detects and whitelist the Guests when “Restricted Mode” enabled. So if you are already participating in a mail conversation via a mutual contact, you don't have to ask the “mutual contact” to introduce you again. But if you never participated in any conversation and you know a mutual contact, then ask that person to send a mail like this from his account.

From: mutualcontact@gmail.com; To: giri@dombox.org; CC: johndoe@gmail.com; Sub: Introduction; Message: Hey Giri, John is a good friend of mine and he would like to connect with you. Regards, Mutual Contact.

14.4. CAPTCHA

Task Performed By: Sender, Estimated Burden: ˜1 Minute. This method works exactly like Google reCAPTCHA. The idea is that spammers usually send millions of mails. They don't have enough time to manually enter the CAPTCHA. Since we already isolated the website mails, websites don't have to worry about entering the CAPTCHA. Note: All Injection methods are applicable only for “Normal Mailboxes i.e. Conversational Mails”. Bulk mailers gonna have problems. But Genuine Unknown Senders not gonna have any problem in entering those CAPTCHA. If your business relies on sending bulk mails, make sure to force your users to create an “Isolated Mailbox” for your domain instead of just accepting “Normal Mailbox”. This is the primary reason why we have “Domboxes”.

14.5. Phone Number Validation

Task Performed By: Sender, Estimated Burden: ˜1 Minute. In this method, the sender needs to enter your phone number correctly. People who have your “Phone Number” could be the people you once met and gave your business card. The phone number acts like a PIN number here. A spammer may have your email address but probably not your phone number.

14.6. Proof-of-Work (PoW)

Hashcash is the first Proof-Of-Work (PoW) method and it was invented by Adam Back in 1997. Put it this way, What CAPTCHA is for humans, Proof-of-Work is for computers. The idea is that a computer needs to solve a puzzle by giving up some computer processing power. Let's just say it takes 10 seconds to solve this puzzle. This is perfectly fine for Genuine senders who send few mails a day. But not for spammers who send millions of spam mails. This is how a hashcash header would look like in an email.

From: test@example.com; To: adam@cypherspace.org; Subject: test hashcash; Date: Thu, 26 Jun 2003 11:59:59 +0000; X-Hashcash: 0:030626:adam@cypherspace.org:6470e06d773e05a8; Message: blah blah

The receiving server need to extract the X-Hashcash Message header and then verify the Hashcash. Today we have a much better decentralized and distributed Proof-of-Work system like Blockchain. In fact, Blockchain is the successor of Hashcash. Bitcoin is one of the most famous applications written on top of Blockchain. In our solution, Proof-of-Work is just a replacement for the Challenge/Response mechanism like CAPTCHA. You still need to be a verified stranger for the mail to be accepted in Mailboxes (i.e. Conversational Mail). The term “Verified Stranger” will be explained in a later section.

For CAPTCHA method, (1) we receive a mail from verified stranger (2) We send a challenge mail back (3) We receive a response for the challenge. So three steps Receive, Send and Receive. In Proof-of-Work, the challenge is already completed by the sender before even sending the mail. So it's only one step.

PoW methods like Hashcash are vulnerable to BotNets since the botmaster doesn't care about wasting their victim computer processing power. In our system PoW methods are safe from BotNets. Refer to the section “Verified Strangers” for more info.

Please note that, it's also possible to use Challenge/Response mechanism for Proof-of-Work method. I.e. (1) we receive a mail from verified stranger (2) We send a challenge mail back (3) We receive a response for the challenge. The challenge mail will have a “computational puzzle”.

14.7. Attention Fee

Tasks Performed By: Sender. Estimated Burden: ˜3 Minutes. When it comes to the Internet, it's all about getting your attention. Spammers are no different from them. They are here for your attention too. They succeed even if you open an email and read it for a couple of seconds. The way we see it, if you receive 1000 emails in a year, 900 (90%) of them will be Transactional and Promotional Mails. 100 (10%) of them will be Conversational Mails. If we dissect those 100 Conversational Mails, 90 of them would be from known people and 10 of them would be from unknown people (Note: We are assuming you are an average internet user here.). 90 (90%) of them would be from known people (We fixed this with Restricted Mode). 10 (10%) of them would be from Unknown people (This is where we need injection methods like CAPTCHA). The “Attention Fee” will be set by the “Receiver”. The money can be from 1 cent to $1000. The default will be 1 cent. If you are not a busy person like Bill Gates, you should go with a low value. If you set a very high value, then even genuine people can't able to contact you. You are trying to fight spammers here. Not scare genuine people. The “Attention Fee” will be charged from the sender, before sending it to the receiver. If the mail is marked as “Genuine” by the receiver, then the money will be returned back to the sender and the contact will be whitelisted.

Our “Attention Fee” model is similar to the system Bill Gates and his team designed back in 2004 to fight spammers. It didn't work for them at that time. But it will definitely work in ours. This is because Mr. Gates applied “Payment Model” for all mails including Transactional and Promotional mails. In our system “Payment Model” is applicable only for Conversational Mails and that too only for “Strangers”. Payment mode was their “Primary” line of defense. In our case it's “Tertiary” i.e. Isolation=>Restriction=>Injection. Note: Injection is a sub phase of Restriction. And Restriction is a sub phase of Isolation. In other words, You can't have “Injection” without “Isolation and Restriction”. And all three phases are optional. Meaning you can only use the Normal Mailboxes just like Gmail. i.e. The traditional way

14.7.1. Attention Fee Calculation

The default value is 1 cent. But the default value is not an optimal value if you are a busy person. For example, If you are Bill Gates or Jeff Bezos then 1 cent is definitely not an Optimal value. So, here are the steps to calculate your attention fee.

Step 1: Take your annual salary (e.g. Dave is a Software Engineer in San Francisco who makes $200,000 USD annually). Step 2: Divide your salary by 2000. That's your hourly pay. In Dave's case, it's $100. Step 3: Multiply your hourly rate by 100 to get the value in cents. In Dave's case, it's 10,000. Step 4: Divide “Cents” value by 3600. That's how much you make per second. In Dave's case it's 10000/3600=2.77. Step 5: So Dave's 1 second is worth 3 cents. Step 6: You are going to spend at least 5 seconds in opening, reading and deleting the spam mail. So multiply by 5. In Dave's case its 15 cents. That should be the minimum suggested value you should charge for attention fee. Of course, you are welcome to multiply that value by any number or you can just leave it to the default value “1 cent”. It's up to you.

14.8. Bounce Address

When an email cannot be delivered, the MTA will create a bounce message and send it to the address given by the MAIL FROM command. The email address provided by the MAIL FROM command is also known as Envelope From, Envelope Sender, Return Path, Reverse Path, RFC.5321 From and Bounce Address. This specification heavily uses the terms MAIL FROM and “Envelope From”. Both refers to the same thing.

14.8.1. Bulk Mailers Bounce Address

When a website sends you promotional emails they are running a campaign. They need to know whether it's delivered or not. So the Bounce Address (i.e. Envelope From Email Address) will be uniquely generated for that campaign and user when bulk mailer mailing you.

Example: DigitalOcean

Bounce Address (aka. Envelope From)=>bounce-md_30039865.5b4fba9d.v1-c350d739e302497090f1b86169e7f63f@mda.digitalocean.com

Message From=>support@support.digitalocean.com

Example: CloudFlare

Bounce Address (aka. Envelope From)=>bounce-mc .us5_10559331.590349-giri=dombox.org@mail61.atl91.mcsv.net

Message From=>cfmarketing@cloudflare.com

As you can see, it's quite normal to have different email addresses for “Envelope From” and “Message From” when websites send you bulk mails.

14.8.2. Conversational Mails Bounce Address

In Bulk Mailers case, there is gonna be millions of users like you. So they have a unique bounce address for each user. In our Cloudflare example, it uses MailChimp to send out those bulk mails. So MailChimp uses their domain mcsv.net for the “Envelope From”. So even a completely different domain is normal here. When we mean Conversational Mails we are talking about Mailboxes on both sides. In Conversational Mails, when a mail not gets delivered, you want the non-delivery report gets delivered to the person who mailed you. So both “Envelope From” and “Message From” gonna be the same for Conversational Mails most of the times.

Bounce Address (aka. Envelope From) =>giri@dombox.org;

Message From=>giri@dombox.org

14.9. Display Address

In some cases “Envelope From” and “Message From” will be different in Conversational Mails. e.g. When you use “Send mail as” feature found in Gmail, your “Message From” address will be the value you set, but “Envelope From” will be your original gmail address. Gmail=>Settings=>Accounts=>Send mail as

Original Mail address: domboxtester@gmail.com; Send Mail as: giri@dombox.org

Bounce Address (aka. Envelope From)=>domboxtester@gmail.com; Message From=>giri@dombox.org

The most important point you have to note here is that “Envelope From” will always be an email address that can “accept” replies and read by a “Human” in “Conversational Mails”. So this human can able to respond to our challenge mails.

14.10. Challenge Mail

This is how our challenge mail would look like.

From: challenge@dombox.org; To: someuser@gmail.com; Sub: Mail Delivery Pending; Message: The following recipients enabled Restricted Mode. john@domboxmail.com, jane@domboxmail.com, test@domboxmail.com. And your contact not found in the recipient Address Book. Please verify that you are human by filling the CAPTCHA in the following link to deliver the mail. https://www.domboxmail.com/challenge/abcde/fghij. Our apologies for the inconvenience.

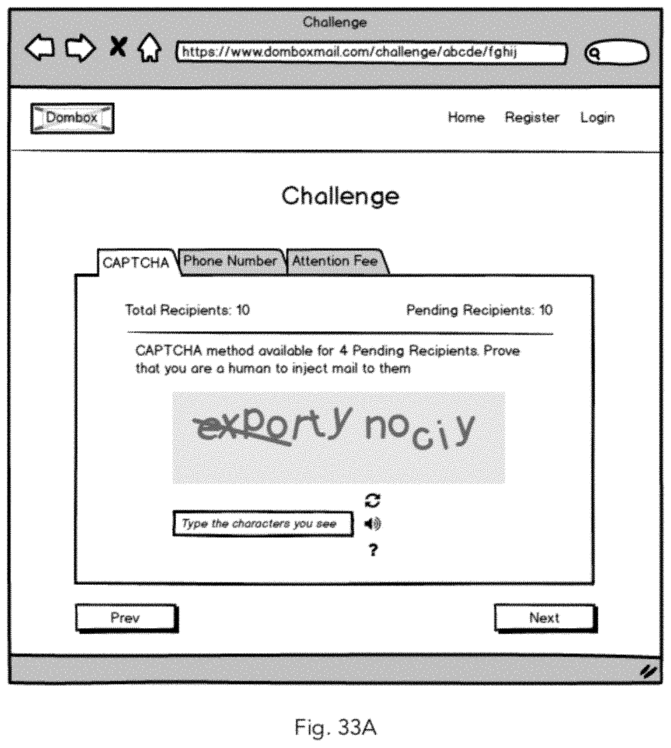

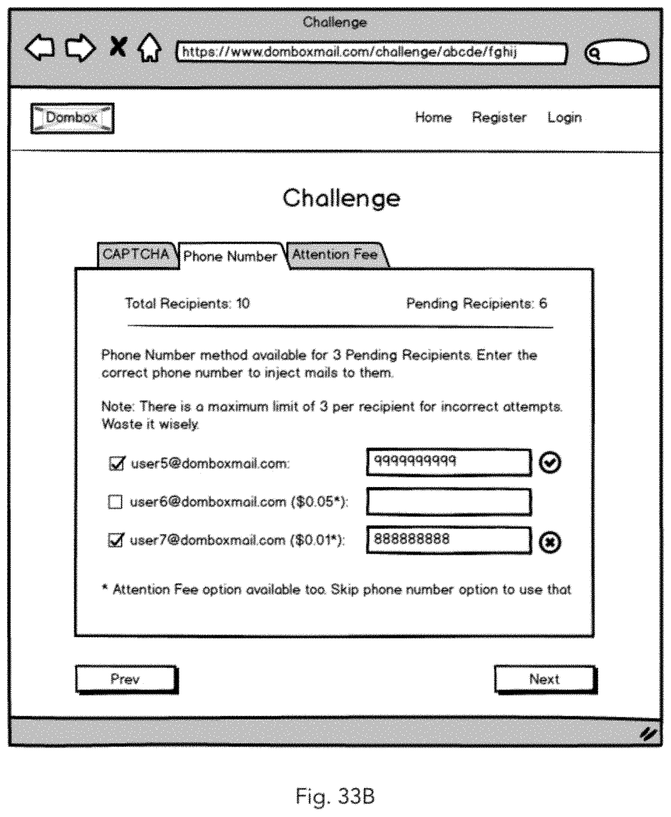

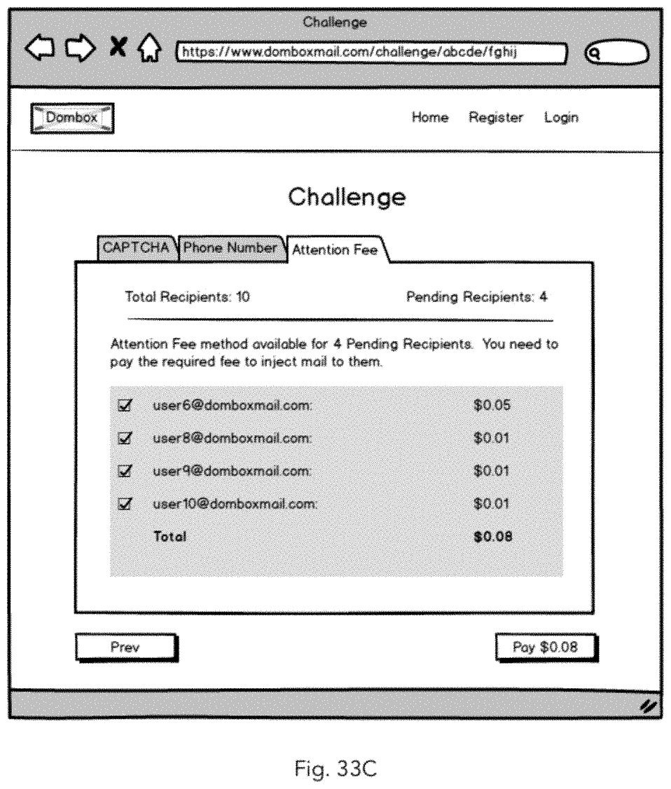

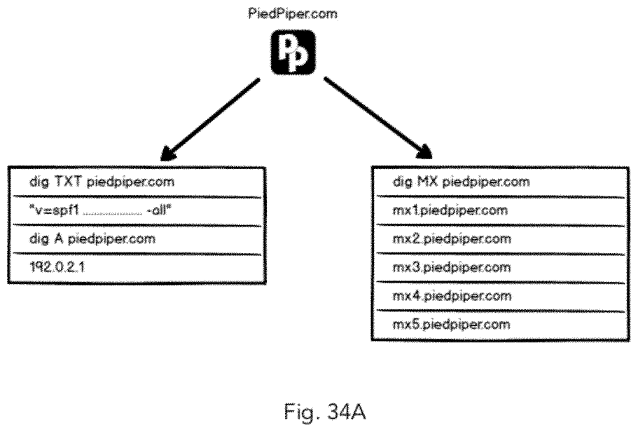

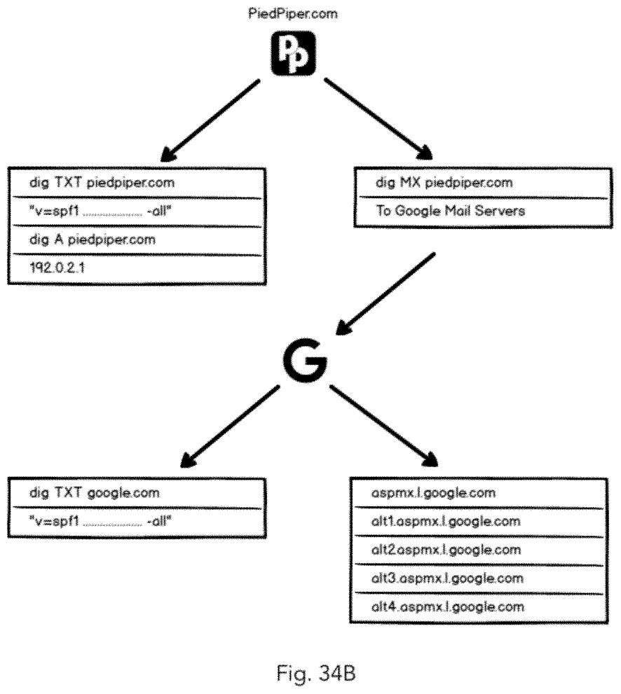

FIG. 33A illustrates the “CAPTCHA Challenge” Interface. FIG. 33B illustrates the “Phone Number Validation” Interface. FIG. 33C illustrates the “Attention Fee” Interface

14.11. Non-Delivery Reports

For each RCPT TO command, we have to make sure the recipient address exists on our system. If the recipient address has no issues we are gonna respond with 250 code. If there is an issue, we are gonna respond with an error code saying we can't accept mail for that user. If we get past RCPT TO without rejecting the mail and if there is an issue, then we have to either reject the mail for all recipients or send an email back to the sender saying there is an issue with particular recipients. This is known as bounce message.

14.12. Backscatter Attacks

Email can be easily forged. If a mail we receive says it's from “president@whitehouse.gov”, that's not always gonna be true. If we keep sending bounce messages or challenge mails to “president@whitehouse.gov”, then we have a far more serious problem. So non-delivery reports during the SMTP conversation are much more safe than sending bounce mails. As for Challenge Mails, we need to make sure mails from “Strangers i.e. unknown senders” are not forged.

14.13. Sender Policy Framework

SPF is one of the best mechanisms we have for email to detect “Envelope Domain” spoofing. We compare the “Incoming mail IP address i.e. Client IP” with the whitelisted IP addresses found in the SPF records. FIG. 5D shows sample SPF record query 521. But there is one bigger problem with SPF. It's an optional mechanism. i.e. There is no internet standard that says, a domain MUST configure SPF. The popularity of SPF record fades away once we get past the alexa top 1 million domains. So if we rely only on SPF record, then the solution may work for the 100th domain, but not gonna work for the 100 millionth domain.

14.14. Hot Gates Strategy

Have you ever watched the Gerard Butler starred movie 300? If yes, let us ask you a question? In that movie, King Leonidas and his soldiers battle against 300,000 Persian soldiers, near a narrow pass called “Thermopylae aka. Hot Gates.” Our question is, Why Hot Gates? Why not battle in an open ground? That's because these spartans strength not only lies in their superior fighting skills, but also lies on their tactical advantage. Without “Hot Gates”, the whole battle would have been an instant massacre. Challenge/Response mechanism is a weapon that should be used in a narrow battle like “Hot Gates”. But every C/R based spam solution out there, trying to use the C/R mechanism in an open ground battle. That is the main reason why C/R mechanism is flawed and not popular even though it got patented 20 years back. Email is ubiquitous. You know what else is ubiquitous? MX Records. They were introduced in 1986.

Let's refresh our memories. We classified the mails into three categories. Conversational Mails, Transactional Mails and Promotional Mails. We offloaded Transactional Mails and Promotional Mails to Domboxes. Users agree that they are gonna use the Mailboxes only for “Conversational Mails” when “Restricted Mode” is ON. So, In “Injection” phase, we are dealing with only “Strangers”. Not just any strangers. We are talking about “Conversational Mail Strangers”. Context really matters here. We already gave unrestricted access to websites and apps in Domboxes via “Isolation”. So, there is no such thing as “Transactional Mail Strangers” or “Promotional Mail Strangers” in our system. The term “Conversational Mails” can be termed as MX-to-MX Mails. e.g. When john@example.com sends an email to jane@gmail.com, Gmail.com MX record is queried and then mail will be transferred to one of the Gmail MX servers. When Jane reply to that mail, example.com MX record is queried and then mail will be transferred to one of the example.com MX servers. So Conversational Mails requires MX record on both sides in order to work. So “MX Records” will be the “Hot Gates” of our Challenge/Response based email system. i.e. We actually diverted the spammers to the injection phase by Isolating and Restricting the genuine senders. Our primary clue for verifying mail genuineness now is “MX Records”. Let's verify these stranger mails.

14.15. MX Records

This MX Record check is part of our Authorization Layer check and applicable for the boxes found in Mailboxes group.

14.15.1. Self-Hosted

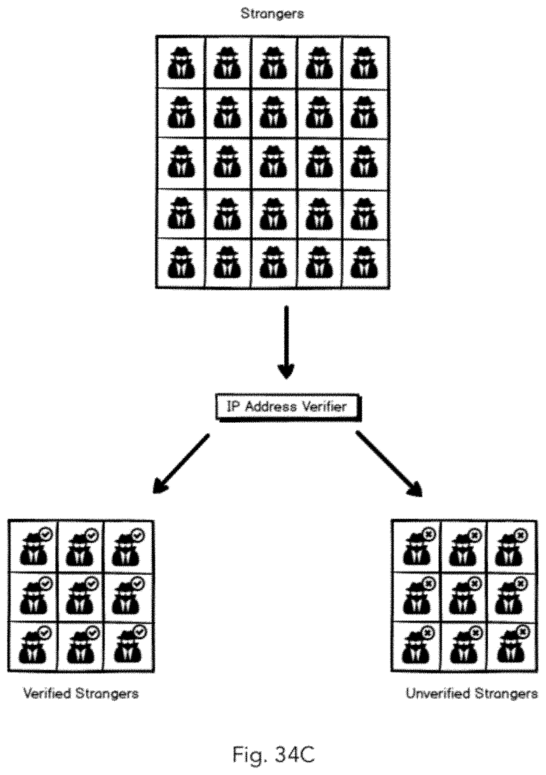

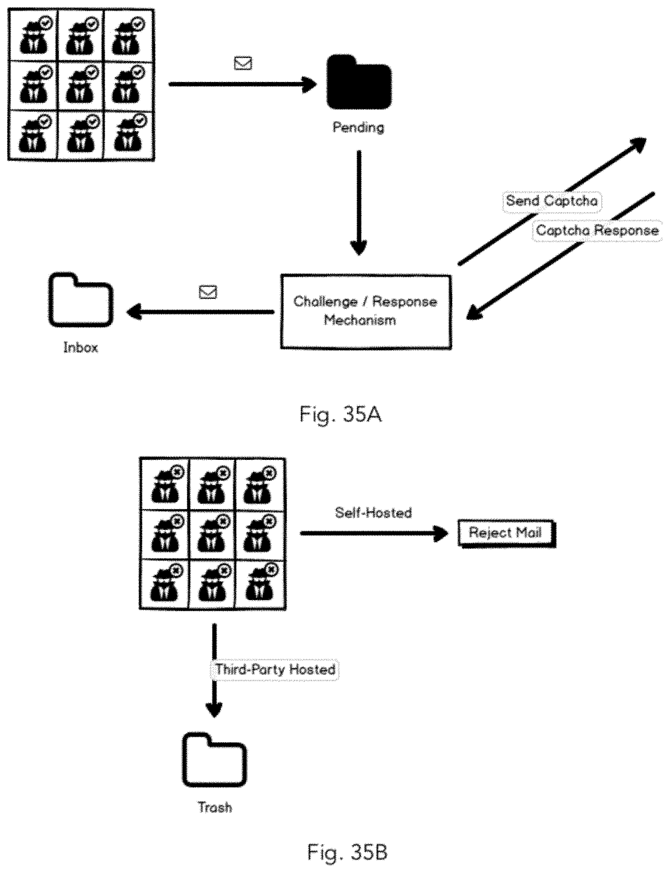

FIG. 34A illustrates the MX Record IP check for Self-Hosted mails. When a mail coming from richard@piedpiper.com, we are gonna compare the “Incoming mail IP i.e. Client IP” address with the IP addresses extracted from the following records. dig MX piedpiper.com (MX Records), dig TXT piedpiper.com (SPF Record), dig A piedpiper.com (A Record)

14.15.2. Third-Party Hosted

When MX server domains (i.e. mail server found in the MX record) of the “Envelope Domain” not ends with the same “Envelope Domain”, then that domain will be considered as a third-party hosted domain.

FIG. 34B illustrates the MX Record IP check for Third-Party Hosted mails. In this case, piedpiper.com hosting their mails in Google servers. So we are going to compare the “Incoming mail IP i.e. Client IP” address with the IP addresses extracted from the following records. dig MX piedpiper.com (MX Records Points to google.com), dig TXT piedpiper.com (PiedPiper SPF Record), dig TXT google.com (Google SPF Record—The base domain of MX host), dig A piedpiper.com (A Record)

Note: An envelope domain can have more than one MX record. Each MX record can point to a different domain. We check whether the MX server is self-hosted or third-party hosted for each and every MX record.

14.16. Strangers

Isolation phase for websites. Restriction phase for friends, family, colleagues and acquaintances (aka Authorized Personnel). Injection phase for Strangers. So the whole Injection phase applicable only for Strangers. Also keep in mind, the term “Injection” comes into play only when “Restricted Mode” is ON. Isolation=>Restriction=>Injection. We can classify the Strangers into two categories based on the MX Record check we performed in the last section. Verified Strangers and Unverified Strangers. FIG. 34C illustrates the Strangers Classifications

14.16.1. Verified Strangers

Challenge/Response mechanism applicable only for verified strangers. FIG. 35A illustrates the process for Verified Strangers. Here are the steps. Accept the mails from “Verified Stranger” as usual. Put the accepted mail in the “Pending” folder. Note: Users never can access the “Pending” folder. If we allow access to “Pending” folder, then it beats the purpose of the system since our “Pending” folder is a replacement for “Spam” folder. Send the challenge mail to the “MAIL FROM” address. If the sender complete the challenge and the response is valid, move the mail from “Pending” folder to the “Inbox” folder. Discard the mail if it is “Pending” for more than 30 days. Most likely it is a spam mail since no one is ready to accept the challenge on the other side.

14.16.2. Unverified Strangers

FIG. 35B illustrates the process for Unverified Strangers. Let's go over the Sample SMTP chat one more time.

mail.example.com Connecting to mail.domboxmail.com with its IP address

domboxmail.com=>220 mail.domboxmail.com Dombox SMTP Service Ready

example.com=>HELO mail.example.com

domboxmail.com=>250 Hello, nice to meet you, mail.example.com

example.com=>MAIL FROM: <john@example.com>

domboxmail.com=>250 OK

example.com=>RCPT TO: <user1@domboxmail.com>

domboxmail.com=>250 OK

example.com=>RCPT TO: <user2@domboxmail.com>

domboxmail.com=>550 Restricted Box. Unauthorized and Unverified Sender. Please Send this mail from one of your MX server IP addresses or Configure SPF

example.com=>RCPT TO: <user3@domboxmail.com>

domboxmail.com=>250 OK

example.com=>RCPT TO: <user4@domboxmail.com>

domboxmail.com=>550 Restricted Box. Unauthorized and Unverified Sender. Please Send this mail from one of your MX server IP addresses or Configure SPF

example.com=>RCPT TO: <user5@domboxmail.com>

domboxmail.com=>250 OK

example.com=>DATA

domboxmail.com=>354 End data with <CRLF>.<CRLF>

{Message Part goes here}

domboxmail.com=>250 OK, message accepted for delivery: queued as 12345

example.com=>QUIT

domboxmail.com=>221 Bye

As you can see, we rejected mails for user2 and user4 with an error like this. “550 Restricted Box. Unauthorized and Unverified Sender. Please Send this mail from one of your MX server IP addresses or Configure SPF”

If the receiving domain is Third-Party Hosted (e.g. forwarded mails from @gmail.com), then the mails will be moved to “Trash” folder instantly. {Refer next section for more info }.

99.99% of the “Unverified Stranger” mails are from either spammers or probably the websites you didn't want to isolate. Genuine Senders rarely get caught here. If a genuine sender get caught here, then it's actually their mistake. Put it this way, they have an address in America for incoming mails, but outgoing mails are originating from Japan. That's abnormal since we are talking about “Conversational Mails” here. Small businesses usually don't go for such abnormal setup. Anyone who go for such abnormal setup probably doing that for better networking policies. These networking professionals most likely knew what is an SPF record. Besides we are giving crystal clear error message when rejecting the mail.

14.17. Forwarded Mails

It's much easier to classify the sender as either “Verified Stranger” or “Unverified Stranger” when the mail is hosted on our server. If the sender is an “Unverified Stranger” then we can reject the mail immediately. But it's getting complicated when the mail is hosted on third party servers. e.g. gmail.com. We don't have control over Gmail servers. So we can't reject the mail. When a mail is hosted on third party servers, we will provide a unique mail forwarding address.

Email address structure: Domkey+LocalPart=HostPart@ReceiverDomain e.g. If we create a box for third party mail account “johndoe@gmail.com” the mail forwarding address would be “giri123+johndoe=gmail.com@domboxmail.com”

Also Note, We extract the domain found in between = and @ symbol (gmail.com in this case), Fetch SPF record of that domain to make sure that the sending IP address is authorized to forward mails to that box. Only gmail.com SPF record IP addresses authorized to forward mail to the box giri123+johndoe=gmail.com@domboxmail.com.

When a forwarded mail received in our server, the “Sending IP aka. Client IP” will be the Forwarding Server IP address (e.g. Gmail). Not the original Sender IP address. But the good news is that Gmail, Outlook and YahooMail adds the “Received-SPF” header. So we are gonna rely on that information to extract the original sender IP address. We are gonna perform our “Authorization Layer” check based on the information found in the “Received-SPF” header.

When the mail get forwarded, our system gonna work exactly like it works for our hosted mail accounts, but when the sender is “Unverified Stranger”, then the mail will be moved to “Trash” folder instantly. It will be kept there for 30 days and then it will be deleted automatically.

14.17.1. Reputation

Gmail, Outlook and YahooMail are reputed mail services. We can trust them. But we cannot trust every forwarding server. A forwarding server can lie by forging the Received-SPF header info. For example, you buy a domain called “xyz.com”, setup mail forwarding in your server, forge “Received-SPF” header and then forward the mail to our server. We cannot send challenge mails since we cannot trust xyz.com “Received-SPF” header. Our domain reputation will be at risk when we send challenge mails to the wrong people. {Refer backscatter attacks}. So when the forwarding server is not in our “Trusted List”, we will send the Challenge mail via the POP or IMAP instead of using our domain. i.e. Envelope From and Message From for the challenge mails will be ending with @xyz.com instead of @domboxmail.com when viewed by the receiver.

14.18. Private Mailing System

All of those “Injection” phase methods like CAPTCHA, Phone Number, PoW etc. are Optional. You can disable those methods. In fact, you can disable the whole “Injection” phase itself. In such case, the system will be treated as “Private Mailing System”. Via “Isolation” you allow only certain “Websites” to mail you and via “Restriction” you allow only certain “Individuals” to mail you. Since there is no “Injection” phase, mail from the “Strangers” will be rejected. By default, Injection phase will be active when you enable Restricted Mode. When a mail is coming from a “Unverified Stranger”, the mail will be rejected with the following error message. “550 Restricted Box. Unauthorized and Unverified Sender. Please Send this mail from one of your MX server IP addresses or Configure SPF”. But if Injection phase is disabled, mail will be rejected from all type of “Strangers”. i.e. No mail will be accepted from “Strangers”. Even the mails from “Verified Strangers” will be rejected with the following error message. “550 Restricted Box. Unauthorized Sender”. In Private Mailing System, the receiver needs to whitelist the contact either manually adding it in the Address Book or Sending an email to that contact. i.e. All outgoing mail contacts will be automatically whitelisted. When both sender and receiver use their mail system as Private Mailing System, then contacts need to be whitelisted on both sides.

14.19. Phishing Prevention

Phishing is not possible in both “Isolation” and “Restriction”. In Isolation, If you sign up to “facebookmail.com” using a Dombox mail address, the box won't accept any emails from facebookemail.com unless it got whitelisted via SAD. So you cannot be deceived. In Restriction, you are gonna add only the people you know in the “Address Book”. So Phishing can only be possible via “Injection” phase. Because that phase, accepts mail from strangers. Whenever a stranger mail get injected via “Injection” phase, the mail would look like this.

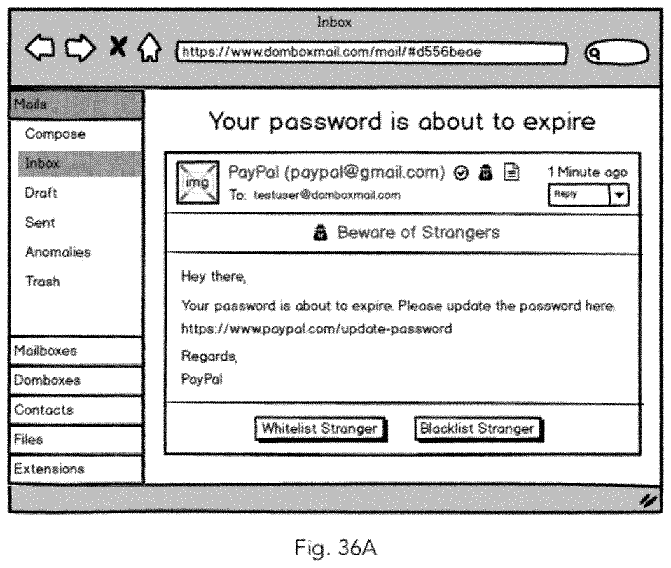

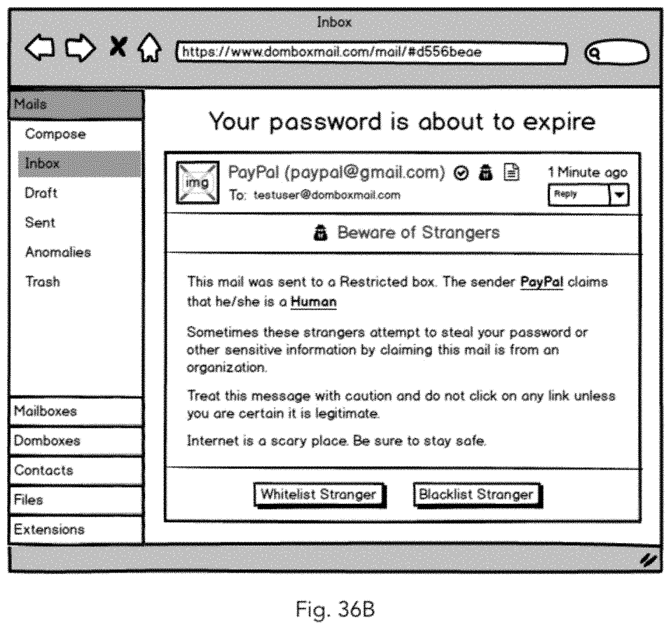

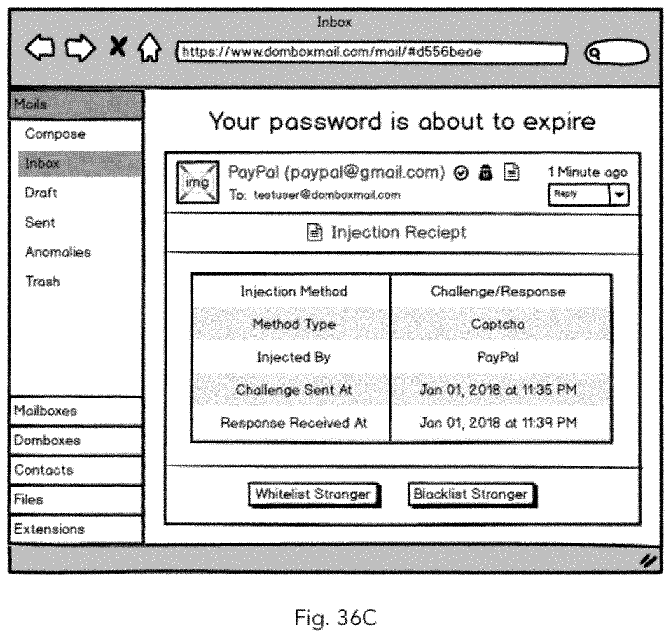

FIG. 36A illustrates the Injected Mail. (1) Whitelist Stranger—Adds the sender to the whitelisted contacts in the “Address Book”. Note: If you reply to the mail, the sender will be automatically whitelisted. This is because no one would respond to spam mails. (2) Blacklist Stranger —Adds the sender to the blacklisted contacts in the “Address Book”. (3) Ignore Stranger—If you don't take any action, then the Stranger need to go through the “Injection” phase again next time. The “Beware of Strangers” nag always appear in the Injected mails. If the user clicks the “Beware of Strangers” link, the warning message would look like this. FIG. 36B illustrates the “Beware of Strangers” warning message. “Injection Receipt” can be viewed in the Stranger mails by clicking the “Receipt” icon. FIG. 36C illustrates the “Injection Receipt”. Thus, our system can solve the “Phishing” problem.

14.20. Domain Reputation

In Email 1.0, stranger reputation is tied to the IP address. Emails can be easily forged. If a spam mail says it's coming from “president@whitehouse.gov”, we can't just block the whole whitehouse.gov domain. We can only block or rate limit the IP address. But In Email 2.0, only mails from “Verified Strangers” will be accepted. That means, mail is REALLY coming from the said domain since the domain is either whitelisted the IP address via SPF or mail received from one of their MX servers. So, stranger reputation not only tied to the IP address, but also tied to the domain. So if you send spam mails via our “Injection Phase”, you are converting yourself from “Verified Stranger” to “Verified Spammer”. In such cases, we not only block your domain and IP address, but also build a block list similar to “Spamhaus Block List (SBL)” and then publish your domain and IP address there to help others.

Since our mail system only allows mails from verified domains, we can rate limit the mails using the domain registration date. I.e. If the envelope domain is newly registered, we should allow only few mails. If there's too much mail from that envelope domain, then we should reject the mail with an error message like “550 Limit exceeded. Your envelope domain is a newly registered domain and it's reached our hourly limit. Please try after an hour.”

Since we allowed only verified mails, we can even use the regular spam filter in the injection phase. Our system will be far better while compared to a typical mail system that primarily rely on spam filter for filtering mails.

15. Site Classifications

Sites are classified into three major categories. Partners, Compatibles and Incompatibles. Incompatible Sites are further classified into two categories. Auto Incompatibles and Manual Incompatibles.

Partners (aka. Portal Partners) are the sites that display our “Teleport” 2001 button. buyfruits.in box in FIG. 21A is a “Partner” 2101 type box. Compatibles are the sites that accept the Dombox mail address 1451. example.com box in FIG. 15A is a “Compatible” type box. 99.99% of the domains in the world are compatible with Dombox mail address. Incompatibles are the sites that are unable to accept the Dombox mail address. Auto Incompatibles are the sites that are unable to accept the Dombox mail address because the dombox email address local part exceeds 64 characters. i.e. Not compatible with the email standards. Manual Incompatibles are the sites that block the Dombox mail addresses intentionally by hardcoding it. e.g. A site that sells your data won't be interested in Dombox addresses. So they usually force the users to provide other email address.

In Domboxes when a domain is a “Partner”, a green check icon 3004 will be displayed right next to the domain. When a site is “Incompatible” red “x” icon will be displayed right next to the domain 3005.

15.1. Partner Notice

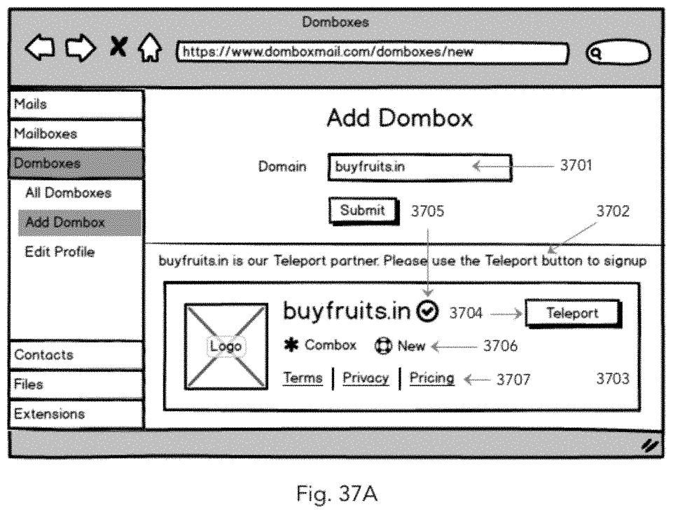

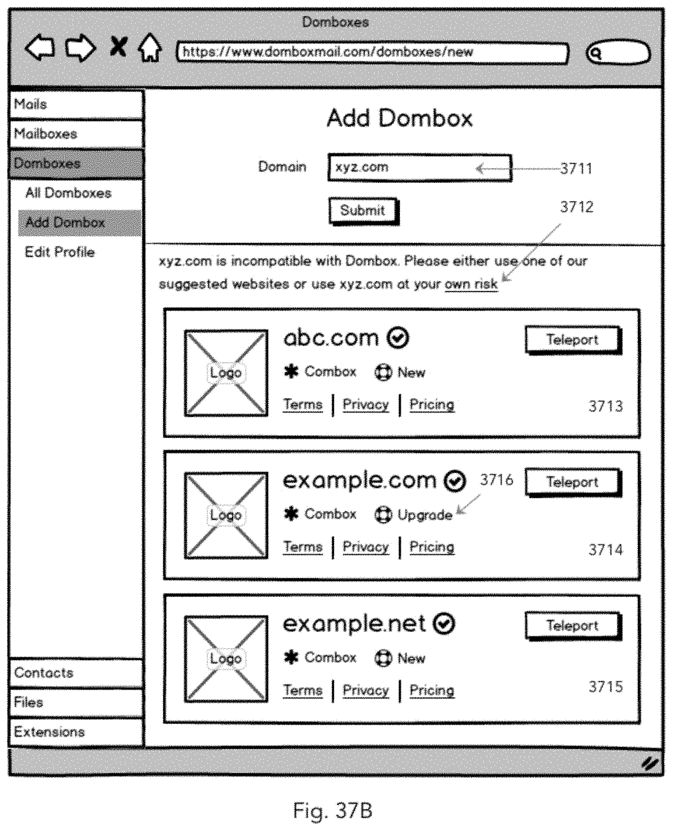

FIG. 37A illustrates the dombox creation for a “Partner” website. When a site becomes a “Portal Partner” that means they are displaying the “Teleport” button. If the site only allows Combox (C) then it requires a contract. In Such cases Users cannot add a Dombox via “Add Dombox” page. In FIG. 37A buyfruits.in is a Portal Partner 3701. In such cases we display a message saying “buyfruits.in is our Portal partner. Please use the Teleport button to signup” 3702 and then display the Partner site details 3703 with “Teleport” 3704 button. The green check icon 3705 says that buyfruits.in is a “Portal Partner”. The “New” 3706 status says that this is a fresh Dombox and the user never created a box for that domain via other methods. The consumer can also view the site links like Terms, Privacy and Pricing 3707. These info already provided by the service owner when creating the portal. When a site is “Portal Partner”, then that site must display the “Teleport” 2001 button when they allow registration and/or login. If they remove the “Teleport” 2001 button but allowing registration via traditional methods like forms, then that would create a “Deadlock” situation since we are already not allowing users to create Dombox via “Add Dombox” page 1421. In such situations the contracts may get terminated since the partner is breaching the terms.

15.2. Incompatible Warning

FIG. 37B illustrates the dombox creation for a “Incompatible” site. Users will be warned if they try to create a Dombox for incompatible site. In FIG. 37B, xyz.com is a incompatible site 3711. So the user will be warned with message like “xyz.com is incompatible with Dombox. Please either use one of our suggested websites or use xyz.com at your own risk” 3712. Incompatible dombox has a red x icon right next to domain 3005. If the user decided to proceed even after the warning 3712, then we let the user to create the Incompatible Dombox. If not, the user can use one of our suggested websites. In FIG. 37B, abc.com 3713, example.com 3714 and example.net 3715 are the suggested websites for xyz.com. example.com 3714 status shows “Upgrade” 3716 text. This is because the consumer created example.com via “Add Dombox” page before example.com become our portal partner. Now the consumer can upgrade the box to “Combox” via Teleport button.

15.3. Rogue Sites

Some rogue websites, usually make a living by selling your data. They are not gonna be happy with “Dombox mail addresses”. Because “Dombox mail address” pose a different threat to them. i.e. “They can't sell your data anymore”. Only the Dombox Domain and its SAD domains can send mail to the dombox. If they allow a data buyer's domain via SAD, then they will be caught red-handed. So they would go for one of the following two things. Block Dombox email addresses. i.e. Manual Incompatible. When they choose this option, they are creating a problem what we call “Hogwarts Problem”. Their second option would be forcibly asking your primary box address since Primary box can accept mail from anyone. When they choose this option, they are creating another problem what we call “Hourglass Problem”

15.4. Hogwarts Problem

Hogwarts is a Wizardry school in the Harry Potter series. In the first part, Harry Potter receives the “Acceptance Letter” mail from “Hogwarts” via owl post. Due to “Man-In-The-Middle” attacks, delivery get failed and then Hagrid later deliver the mail to Harry Potter in person. Now here comes our question. What would have happened if Harry Potter never received the mail OR received the mail but read it after 6 months? Most likely he would have joined some other school instead of Hogwarts. Right? Same here. When a website becomes an “Incompatible” website, that means they are forcing their users to provide some other mail service address.

When you force your users to use other mail services, you are delaying the user's attention. If your site becomes an “Incompatible” website, then we believe, you may have issues with these two things. (1) Teleport button (2) 5 layers passed emails. Without the Teleport button, it's hard to establish a contract. Without a contract, we cannot revoke the offline and delete privileges from the user. So that explains it. As for “5 layers passed emails” if we accept emails even when layers are failed, then the box is vulnerable to email forgery. A user can send a spoofed spam mail to themselves, but blame it on you by saying you are breaching the terms. So the “5 layers passed emails” not only protect the users from receiving spam, but also protect your business from breaching the terms.

15.5. Hourglass Problem

When a website forcibly ask the user to provide their Primary (P) box address, they are creating the “Hourglass Problem”. Some websites would do that to collect email addresses and sell it to third parties. Websites should also take the “Restricted Mode” into account when forcibly asking for user's “Primary” box address. Boxes found under Domboxes group give the websites exclusive unrestricted access to their box, whereas the primary box is not. For “Restricted Mode”, we are planning to bring a “Scan for new Contacts” feature. Every time you turn on the “Restricted Mode”, a scan will be initiated since the time you turned off “Restricted Mode” mode. The new contacts found during the scan will be marked as “Recognized” contacts upon user confirmation. e.g. A user signed up for example.com with his Primary (P) box address. The website sends the welcome email from “no-reply@example.com”. A week later the user decided to use the “Restricted Mode” option. This time, we will be scanning for the new contacts during the time “Restricted Mode” turned off. Now, example.com is completely locked out from Primary (P) box except this one contact. no-reply@example.com This is what we call “Hourglass Problem”. i.e. The path is narrow here just like you see in the hourglass. Only the early contacts who mailed the user before activating the “Restricted Mode” can able to mail the user in the future.

16. Miscellaneous

16.1. Anomalies

What is spam? In simple terms, it's the emails that are sent by a spammer. Right? This spammer is most likely someone you are not familiar with. Now think about from the “Isolated Mailboxes” perspective. Those boxes are created with your knowledge. So you know exactly what you are signing up for. You know the website. Mail passes all 5 layers. Everything seems fine. But just because a mail passes all those 5 layers, doesn't mean it's always going to be a genuine mail. There are legitimate reasons for mail not to be genuine. For example, you signed up for a website. However, that website got hacked at some point. The hacker uses the website servers to send out emails. In such situations, you are not the only victim here. The website too. If the website recovers from the hacker, then everything goes back to normal. Because your email address is valuable only when the hacker can use the original website servers. If the hacker uses some other servers to send out emails, then some layers gonna fail due to the DNS settings. So we cannot blindly trust the mail even if they are our “Portal Partners”. After passing the 5 layers, emails coming to Domboxes will be passed again to a filter called “Anomalies Filter”. (Note: Mailboxes mails will be passed to “Anomalies Filter” only when Restricted Mode active). Anomalies filter would scan all the links found in the mail and make sure they are ok. For example, a link that linking to some unknown third party website would seem more fishy, than the link that links to the Dombox domain or the domains found in the SAD record. If the emails are caught by Anomalies Filter, then the emails will be put in Anomalies folder. Keep in mind, emails found in Anomalies folder might be more dangerous than your typical spam mail. If you are a website owner, link to third party websites only when it's absolutely necessary. Of course, you are welcome to link to popular websites like Facebook, Twitter, Youtube etc. Anomalies Filter and Anomalies Folder applicable for all boxes found under Domboxes. And “Restricted” Mailboxes. Here is the definition of Anomaly from Oxford dictionary. “Something that deviates from what is standard, normal, or expected”

16.2. Mailing List/Discussion List

A mailing list is a collection of names and addresses used by an individual or an organization to send material to multiple recipients. The term is often extended to include the people subscribed to such a list, so the group of subscribers is referred to as “the mailing list”, or simply “the list”. A mailing list is usually created for sharing views on specific topics. e.g. Computers, Politics etc. In a mailing list, there are usually thousands of subscribers like you. There will be an address for posting the message. Let's say, politics@listserver.com is the mailing list post address. When you post a message, listserver.com forwards the message to all the subscribers. For example, when the user Giri post a message, the message would look like this when viewed by others. Envelope From: politics@listserver.com, Message From: giri@dombox.org. The point here is that the “Message From” domain can be any of those 332 million domains. But “Envelope From” domain is gonna be listserver.com. listserver.com is the mediator here. So, create an “Isolated Mailbox” for listserver.com. e.g. test123$1istserver.com@domboxmail.com. Use that address when posting a message to listserver.com. There is one problem while receiving mails. Our Alias Layer has two sub-layers. Envelope Layer and Message Layer. Both Layer needs to be passed to accept mails. However, we need to have an exception for the mailing list. We should accept mails even when the “Message Layer” result is Fail. There are three ways we can achieve that.

(1) We should let the users mark the box as “Mailing List” box. We should provide an option like “Mark as Listbox”. When a box is marked as “Listbox”, we are gonna accept mails even when the “Message Domain” related check result in “Fail”. Applicable only for Domboxes {Dombox, Hybrid and Combox}

(2) Let the “Dombox Domain” explicitly states that the domain is a Mailing List domain. So we should have an option in the SAD record to mark the domain as a mailing list domain. e.g. _sad.listserver.com=>“v=sad1 list:yes-all” The last sad record says, treat the current domain as a “Mailing List” domain. If only one subdomain used, then the domain can explicitly state that like this. e.g. _sad.listserver.com=>“v=sad1 list:discussion.listserver.com-all”. The last sad record says, treat only the “discussion.listserver.com” as a “Mailing List” domain. For all others, regular SAD rules apply. If more than one subdomain used, then the domain can explicitly state that by separating with a comma. e.g. _sad.listserver.com=>“v=sad1 list:politics.listserver.com,movies.listserver.com-all”. In the last example, listserver.com asks us to treat only the following subdomains as “Mailing List” domains. politics.listserver.com and movies.listserver.com. For all others, regular SAD rules apply. Note: In mailing lists, Message SAD and DMARC always gonna fail. So we have to rely on SPF for detecting forged mail.

(3) Provide special box type called “Listbox” only to deal with mailing lists. So Domboxes group will have 4 box types. Dombox (D), Combox (C), Hybrid (H) and Listbox (L).

16.3. STRIPTLS Attacks

SMTP encryption is an Opportunistic Encryption. A man-in-the-middle attack can be initiated in the Opportunistic TLS that's known as “STRIPTLS” attack. In STRIPTLS attack, the attacker gonna strip the STARTTLS command. An experienced attacker may make the command unrecognized by replacing the characters to make it compatible with the Packet Size. e.g. STARTTLS=>STARTXXX. Here is an Example

mail.example.com connecting to mail.yahoo.com with its IP address

220 mail.yahoo.com Yahoo ESMTP Service Ready

EHLO mail.example.com

250-Hello, nice to meet you, mail.example.com

250-SIZE 1000000

250-8BITMIME

250 STARTXXX

In the last example, the client (sender) is asking “Hello, What are the extensions do you support?” and the receiver (server) responds with the list of extensions. The attacker replaced the STARTTLS command in the last example. Since the client (sender) doesn't recognize the STARTXXX command, the whole mail will be transferred in “Plain Text”. Some ISPs in the US and Thailand performed this attack on their customers back in 2014. STRIPTLS attack is a serious issue. An attacker can hijack your social media account with the help of STRIPTLS attacks. e.g. Attacker Initiate forgot password request in Facebook, perform STRIPTLS attack. Now the attacker has your password reset confirmation link. We are using Facebook as an example. It can be applicable for any sites that lets you reset your password with a confirmation link. We can fix that problem in Domboxes. If the following record found in the Dombox Domain, then all the mails coming to that Dombox must use the Encryption. Or the mail will be rejected.

e.g. _sad.example.com=>“v=sad1 tls:yes-all”. Note: DNS by itself is not secure. There are issues like cache-poisoning. DNS can be made secure with the help of DNSSEC.

16.4. SMTP VRFY Support

VRFY is one of the SMTP commands introduced in RFC 821. VRFY command asks the server to verify an address. Most mail servers do not support VRFY command in order to prevent abuse. For example, spammers can use the VRFY command and scrap valid email addresses and send spam mails later. Although we don't advertise VRFY command in our supported SMTP commands list, we implicitly support VRFY command only for i-mail addresses when the following conditions are met. (1) The VRFY address is a valid “Isolated Mailbox” address (2) Authorization Layer Passed for “Envelope Domain” (3) Alias Layer Passed for the “Dombox Domain” found in the VRFY command. E.g. A user created a Dombox for quora.com. Quora.com can verify whether the Dombox exists or not without sending a verification email to the user.

mail.quora.com Connecting to mail.domboxmail.com with its IP address

220 mail.domboxmail.com Dombox SMTP Service Ready

HELO mail.quora.com

250 Hello, nice to meet you, mail.quora.com

MAIL FROM: <noreply@quora.com>

250 OK

VRFY: <test123$quora.com@domboxmail.com>

250 OK

VRFY: <hello123$twitter.com@domboxmail.com>

550 Unauthorized verification request. Decline to answer

QUIT

221 Bye

SMTP VRFY support will be useful for email address verifications. No need to send an email and ask the user to click.

16.5. Better Performance

Our system can offer better performance than traditional mail system. The whole system is designed to reject mails selectively during the RCPT TO command in both Domboxes and Mailboxes. Thus, it can provide better performance.

A mail system that relies on spam filters need everything found after the DATA 514 command. But our system is designed to deal with the spam mails before the DATA 514 command. An incoming mail can be up to 25 MB in most mail servers. Sp plenty of bandwidth get wasted in dealing with 60 Trillion spam mails. There are few other issues too. Wasting time and computing power in spam and virus checks. Sending bounce mails etc. If we can reject the mail before the DATA command, then the bandwidth wastage will be so tiny when compared to the traditional email system. 1 KB can hold 1024 ASCII characters. So the bandwidth wastage will be in bytes rather than MegaBytes.

This is how we deal with mail coming to Domboxes.

mail.example.com Connecting to mail.domboxmail.com with its IP address

220 mail.domboxmail.com Dombox SMTP Service Ready

HELO mail.example.com

250 Hello, nice to meet you, mail.example.com

MAIL FROM: <spammer@example.com>

250 OK

RCPT TO: <giri123$twitter.com@domboxmail.com>

550 Alias Layer Failure

So the mail got rejected before the DATA command.

As for Mailboxes, when a mailbox is in “Restricted Mode” that says, it can accept only “Conversational Mails”. So when comparing email address in the address book, we are looking at whether the MAIL FROM address is whitelisted or not. [Restriction Phase]. And the challenge mails will actually be sent to the same MAIL FROM address. [Injection Phase—Verified Stranger]. If the MAIL FROM address is not a “Verified Stranger”, then the mail will get rejected before the DATA command itself. [Injection Phase—Unverified Stranger]

mail.example.com Connecting to mail.domboxmail.com with its IP address

220 mail.domboxmail.com Dombox SMTP Service Ready

HELO mail.example.com

250 Hello, nice to meet you, mail.example.com

MAIL FROM: <spammer@example.com>

250 OK

RCPT TO: <testuser@domboxmail.com>

550 Restricted Box. Unauthorized and Unverified Sender. Please Send this mail from one of your MX server IP addresses or Configure SPF

So spam mails to both Domboxes and Mailboxes actually gets rejected before the DATA command itself. If an average mail size is 100 KB, that means our system is 100× more efficient than Email 1.0. i.e. No bandwidth wastage, No storage wastage, No spam checks, No virus checks, No bounce mails, No False Positives, No False Negatives, No Backscatter Attacks, No Backscatter Relay, No Botnet Spam

Note: We reject mails during the RCPT TO command to save bandwidth. Instead of rejecting the mail, we can also silently Trash it or quarantine it.

16.6. Isolation Tools

Our system strength lies on the Isolation phase. If our solution is hard to adopt, then it will result in failure even if our system solves the spam problem. So, we need to make this process easier for consumers as much as we can. It's a very tedious job for the users to manually update their old email address with the new i-mail address in those websites. To make this process easier, we will provide automation tools. iMacros is one of the well known browser automation tools. We will build such browser extensions only for the “Dombox Isolation” job. We will collect the automation formula from the first few users and automate it for the rest of the users. The users only have to intervene in cases like captcha filling, Teleport consent screen etc. When users import their old mails, we will analyse it and provide the results. We actually scan for the “Message Domain” in all your mails and sort the unique domains by alexa rankings. Higher alexa rank means important domain. This is also your chance to start over. Delete the domains you don't need and keep only the domains you consider as important. Our mail system is not compatible with the traditional mail clients. So we have to build our own mail clients. Today we have projects like Chromium Embedded Framework (CEF) for embedding browser within another application. We probably use such framework in our mail client. Ever heard of password managers like 1Password, Dashlane, LastPass? Most likely we will build similar tools for non portal partner domains. Password managers are taking care of the “password” field. We are gonna take care of the “email” field. Note: We will be primarily focusing on the automation formula for the alexa top 1 million domains.

16.7. Box Comparison

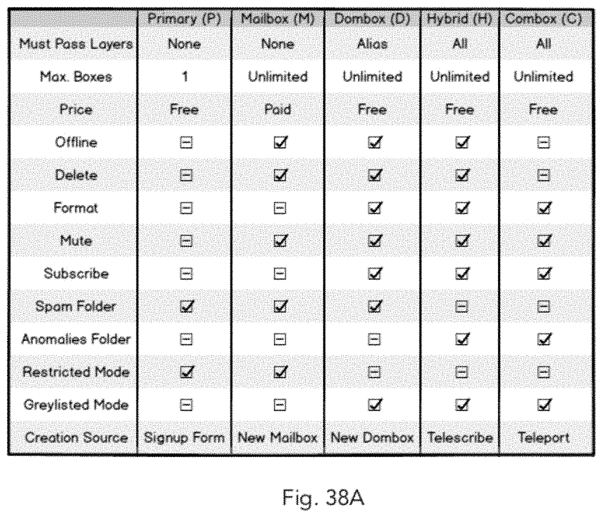

FIG. 38A illustrates the box comparison. When “Restricted Mode” active, the value will be inverse in Primary (P) and Mailbox (M) box types for the row “Spam Folder” and “Anomalies Folder”

16.8. Mail hosting Flexibility

Since our I-mail addresses offers a sub-domain based structure, it is possible to host Domboxes and it's mails in a different server. For example, the domain acme.com can host normal @acme.com mails in Gmail and isolated @domkey.acme.com mails in Domboxmail by configuring MX records separately.

| ; Mailboxes | | |
|---|---|---|
| acme.com. | MX | 5 aspmx.l.google.com. |
| acme.com. | MX | 10 alt1.aspmx.l.google.com. |
| acme.com. | MX | 20 alt2.aspmx.l.google.com. |
| acme.com. | MX | 20 alt3.aspmx.l.google.com. |
| acme.com. | MX | 40 alt4.aspmx.l.google.com. |
| ; Domboxes | | |
| *.acme.com. | MX | 5 mx1.domboxmail.net. |
| *.acme.com. | MX | 10 mx2.domboxmail.net. |
| *.acme.com. | MX | 20 mx3.domboxmail.net. |
| *.acme.com. | MX | 20 mx4.domboxmail.net. |
| *.acme.com. | MX | 40 mx5.domboxmail.net. |

Sometimes to avoid conflict with other subdomain based mails (e.g. support@payments.acme.com), it is recommended to host domboxes under the subdomain “dombox”. So the i-mail addresses would look like twitter.com@domkey.dombox.acme.com

| ; Domboxes | | |
|---|---|---|
| *.dombox.acme.com. | MX | 5 mx1.domboxmail.net. |
| *.dombox.acme.com. | MX | 10 mx2.domboxmail.net. |
| *.dombox.acme.com. | MX | 20 mx3.domboxmail.net. |
| *.dombox.acme.com. | MX | 20 mx4.domboxmail.net. |
| *.dombox.acme.com. | MX | 40 mx5.domboxmail.net. |

Now acme has the flexibility. Acme can set up mail forwarding in gmail to forward all Gmail hosted @acme.com mails to the domboxmail system. Or Acme can configure forwarding in domboxmail to forward all @domkey.dombox.acme.com mails to Gmail hosted @acme.com address.

16.9. Relaxing of Requirements

We mentioned service owners need to prove that their mails must pass all five layers to become our portal partner. Some layers are complicated to configure for non tech-savvy users. So the requirements can be relaxed. For example, the system can work only with Authorization Layer (SPF) and Alias Layer (SAD) or even with Alias Layer alone when combined with Receiver Policy Framework (RPF). There is no need to mandate the other layers. However, it is highly recommended to configure other layers, so the incoming mails can get full 5 marks for Mail Score and looks trustworthy in front of reader's eyes.

16.10. Proxying Isolated Mails

Our system provides an Isolated Mailbox for each and every domain. The address would look like quora.com@giri123.domboxmail.com for the service quora.com. Sometimes, the users would like to forward our isolated mails to their old mail addresses.

The user John Doe has an email address johndoe@gmail.com. He can import all old gmail mails into our system. He can setup a mail forwarding in Gmail and ask gmail to forward all johndoe@gmail.com incoming mails to a unique email address provided by our service. E.g. giri123+johndoe=gmail.com@domboxmail.com In this case domboxmail.com act as the storage for John Doe's gmail mails.

Sometimes users may be interested in our isolated mail service, but don't want to switch their old mail service. E.g. Gmail. In this case, we can forward each and every dombox mails to a single address provided by John Doe. Usually it's the primary address johndoe@gmail.com. This kind of process is known as proxying and it's introduced in the late nineties.

16.10.1. Rewriting Headers.

Domboxes deal with service related mails. Most of them are Promotional and Transactional mails. But in rare cases there can be conversational mails as well. E.g. The user conversing with an address like support@quora.com

Since we are proxying mails, user is gonna reply from the Gmail address. Quora can recognize the address quora.com@giri123.domboxmail.com, but can't able to recognize johndoe@gmail.com.

So when the user reply from the Gmail account, we need to make sure it's actually replied to quora.com@giri123.domboxmail.com, and then we proxy that mail to the original destination. I.e. support@quora.com. So we have to rewrite the Reply-To header before proxying mail to johndoe@gmail.com. We may also have to rewrite additional headers. e.g. “Message From” address to avoid DMARC failures.

16.10.2. Dombox Creation via SMTP

Users don't have the patience to log into our service to create a new proxy address. I.e. isolated mail address. Proxy addresses should be easy to create. It should be created from user's original mail account. E.g. Gmail. So we should let the user to create a new dombox address via SMTP. In other words, the user is gonna send an email from the original mail account to a dombox mail address. We are going to create a dombox address by scanning the email.

The mail will be accepted only if the mail sent from one of the recognized mail addresses. Usually this is the Primary (P) address. The mail must pass the “Authorization Layer” check in order to be accepted. I.e. We will pull the SPF, MX, A or AAAA record and compare the extracted IP addresses with the Client IP. If there is no match, then we will reject the mail.

We can also mandate Encryption Layer, Authentication layer and Alignment Layer. We have to make the Alias layer to accept mail when it comes from the user's primary email address since we are dealing with the proxy feature here.

Here are the ways to create a new dombox address via SMTP

16.10.2.1. Send a mail to the isolated mail address

From: johndoe@gmail.com

To: quora.com@giri123.domboxmail.com

Sub:

Message:

Since we are using a standardized email address structure, it's very easy for user to guess the service mail address. For example, acme.com mail address gonna be acme.com@giri123.domboxmail.com. So if the user send an email to this address, the system will automatically create a dombox address if not exists for domain acme.com during the RCPT TO command as long as the MAIL FROM command contains a recognized mail address (e.g. johndoe@gmail.com) and passes Authorization Layer check.

16.10.2.1. Single Point of Contact.

In our last example, the “To” address will be unique for each and every service. We can have a single point of contact which is easy to remember. E.g. proxy @dombox.org

From: johndoe@gmail.com

To: proxy@dombox.org

Sub: acme.com

Message: acme.com

Either Subject or Message Body must have the domain. It can be in one of the formats.acme.com, [acme.com], +acme.com

The user can also create proxy addresses on the fly. I.e. While sending an email to the service.

From: johndoe@gmail.com

To: proxy@dombox.org

Sub: [support@ebay.com] Need help regarding my order #12345

Message:

[support@ebay.com]

I need help regarding my order #12345. Please help.

In the last example, our system will create a dombox address for the domain found after the “@” symbol, strip the email address and then forward the mail to the original recipient by changing the “Reply-To” and “From” headers. The destination email address must be specified either in the subject or message body.

We can build mail client extensions, browser extensions, gmail extensions etc to make the above job easier.

17. Benefits

(1) Spam—There will be less spam on the Internet. (2) Phishing—phishing emails will be reduced a lot. Because if you sign up to facebookmail.com using a Dombox mail address, the box won't accept any emails from facebookemail.com unless it got whitelisted via SAD. So you cannot be deceived. (3) Homograph Attacks—This attack can deceive even highly technical people. Let us give you an example. Can you tell us what's wrong with this domain?=>paypal.com. The character “a” is replaced with the Cyrillic character “a”. If you need proof, copy those characters, go to google.com and then paste it into the search box. See the search suggestions. Unfortunately, Cyrillic characters are allowed in domain names. Our Domboxes are safe from homograph attacks. Refer the last point why dombox is safe from homograph attacks. By the way, you can find Cyrillic characters in the Russian text. e.g. [symbol] (4) Malware—Since there won't be any spam emails, there won't be any malware emails too. (5) Organized—Your mails will be well organized. Each dombox acts as a dedicated folder for its domain. If you wanna fetch medium.com mails, you know where to go. (6) Relevant Search—You can get more relevant search results. If you wanna search some work related mails, just exclude “Domboxes” by unchecking it in the search field. Now, you will get search results only from the mails found under “Mailboxes” group. (7) Productivity—The world is gonna be at least a little bit more productive than what you have today. (8) Scamming—Innocent people will be saved from Lottery scam, Employment scam, Nigerian scam, Romance scam etc. (9) Control—In mail service like Gmail, others have control over you. In our mail service, you have the full control. You can decide who can mail you and who can't. (10) Rogue Websites—Some rogue websites that make a living by selling your data can't sell your data anymore. (11) Teleport—Teleport gives you quick signup and sign in. If we succeed, then that's gonna be everyone's preferred mode of signup and login. So the traditional signup and login forms will become an option. (12) Privacy—Unlike other services, our “Teleport” button gives you full privacy on the internet. (13) Hacker Resistant—Hundreds of thousands of websites are getting hacked every year. But you would find only the popular sites on the news if they get hacked. Our Teleport button solves this issue. Even if your “Green Data” get stolen from a third party website, you are still safe. Because hacking this data is nothing more than crawling facebook profiles. (14) Competitor Resistant—You have built a successful online business. You have a lot of high profile clients. If your competitor uses a hacker to hack your website, they can steal the data, contact your clients anytime and hijack your clients by persuading them. So our Teleport button can protect your business. When you use our “Teleport” button, You are the only one who can reap the benefits. (15) Telescribe—Our “One-Click” subscribe button gonna save you some time since its “Double Opt-In” by default. (16) Pre-Signups—Budding entrepreneurs usually don't have enough money until they bring investors on-board. While building their product, they can now accept pre-signups via our Telescribe button without spending a dime. (17) Passwordless—“Teleport” button doesn't require a password. But if you have a highly sensitive website (e.g. Banking) you are welcome to ask your users for a password after successful authentication. In such cases, you can use “Teleport” as “Primary” authentication method for identifying user and “Password” as the secondary authentication method. You can also use an alternative method like Authenticator Apps, SMS OTP, Email OTP, Tokens etc for the secondary authentication method. (18) Security—We do have plans to issue free SSL certificates to all of our “Portal Partners”. So the internet will be more secure than what you have today. (19) Unsubscribe Requests—Unsubscribe Requests are gonna be more streamlined. Our unsubscribe button found in the Dombox can help you automate the unsubscription process. Just click the unsubscribe button and we take care of the rest. Unsubscribe button also helps us to keep track of offending sites. e.g. If a site is our portal partner and keep annoying even after multiple unsubscribe requests, then they are breaching our terms and conditions. So the contract may get terminated. You already have full control (“Delete” and “make Offline” privileges) for non-partner boxes. So there is no need to depend on third party services for unsubscriptions. e.g. unroll.me (20) Mailboxes—Google has a “Priority” inbox. Mails are decided by their algorithm. Outlook has a “Focused” inbox. Mails are decided by their algorithm. But we are giving you something better than that. The “Primary” box type. Mails are decided by you. Just use your primary box mail address only for conversational emails and all emails will be considered as “Priority” over the emails found in Domboxes. (21) Domboxes—We are also planning to bring a “Priority” tab feature for “Domboxes”. You can set priority for each and every dombox. The Priority value can be 1 to 1000. The default is 500. Let's say you have 5 domboxes. a.com, b.com, c.com, d.com and e.com. If you don't set any priority, then all boxes have the same priority 500. So the emails will be ordered as usual. Let's say you set the priority value “1” to “b.com” and “1000” to “d.com”. Now the emails will be ordered like this. b.com, a.com, c.com, e.com, d.com. (22) Email Misuse—No one can misuse your email address by submitting the form in third party websites. This is because a “Dombox” needs to be created first either via “New Dombox”, “Teleport” or “Telescribe” button with your knowledge to receive emails. (23) Confirmation Mails—There is no need for confirmation emails. Because “Isolated Mailboxes” should be considered as “Double Opt-In” by default. {Refer the last point for more info }. (24) Whitelist Request—Since a “Dombox” is owned by both consumer (Read & Delete Privileges) and business (Write Privilege), there is no need for whitelist request. In other mail services, a website owner usually requests their users like this. “Please add contact@example.com to your address book to ensure delivery into your inbox”. (25) Inboxing—Most businesses these days looking for an answer to this question. “How to get our emails delivered to the user inbox instead of ending up in the spam folder?”. “Dombox” is the perfect answer to that question. Dombox not only helping the consumer to achieve zero spam but also helping your business to reach the user inbox without any issues. When you send emails to an address like @gmail.com, your domain is actually 1 in a million. So there is gonna be trust issues. But when you send emails to the “Dombox” created for your domain, we were actually expecting your emails. You get exclusive privilege there. When a consumer creates a Dombox for your domain, that establishes your domain's credibility. If your domain passes all our 5 layer checks, then your emails will always get delivered to the user inbox unless your mail gets caught via our “Anomalies” filter. (26) Reversible—In other mail services, the spam you are getting always will be in ascending order. If you receive 10 spam emails today, 5 years from now you are gonna get at least 100. But in our mail service if you receive 100 spam emails in your “Primary” box, you can go back to “zero spam” easily by isolating the websites you already signed up and then restricting your primary box. (27) Mail Score—Since we bring transparency via Mail Score, that's gonna force the website owners to configure those layers. That means you are gonna have better mail experience than before even if you use other mail services like Gmail. i.e. We are helping other mail services indirectly. (28) BotNets—BotNets contribute a lot to our everyday spam. Some botnets are capable of sending spam up to 90 Billion spam emails per day. Our system is probably the only system that is safe from such BotNets since spammers need a verified domain to deliver mails. (29) Spam Laws—Spam laws are enforceable only within a country. If the spammer is from some other country, it's hard to get justice. But our system is a global system. If we succeed, there won't be a need for spam laws in the long run. (30) Bandwidth—Half of the Internet bandwidth is being used to carry spam emails. If we succeed, plenty of Internet bandwidth will be freed. (31) Storage—We are trying to remove the spam folder completely in the long run. So plenty of storage space will be saved. (32) Statistics—If you are a business owner, you probably would like to know how many people opened your mails. This is a privacy issue. For example, when someone sends you an email, they are implicitly saying “Reply me when you have time”. I.e. Email is designed for slow communication. Put it this way, If Gmail adds those read receipts like you see in whatsapp, that would create a massive backlash due to privacy concerns. But our system is dual-sided system. Mailboxes and Domboxes. Since dombox addresses will be used only for service related mails, we can offer crystal clear statistics to businesses directly. However, you need to become our Portal Partner and accept few terms. e.g. You will not use our API for getting the “read status” of conversational mails found in your domain dombox. (33) STRIPTLS attacks—Domboxes can be protected from STRIPTLS attacks since they are isolated. So it can offer better security.

What is claimed is:

1. A method for providing isolated mail address via authentication, the method comprising:
under control of a system of an identity provider,
registering an auth-client application for a service by a service administrator of the service;
under control of a system of the service,
displaying an auth-button of the identity provider for the auth-client application on the service;
under control of a server of the identity provider,
receiving a request from the service to authorize a release of protected data of a user who has requested access to the service, the request initiated by the user by clicking the auth-button;
responsive to receiving the request, authenticating the user;
responsive to authenticating the user, receiving a permission from the user, the permission authorizing the release of protected data of the user;
responsive to authorizing the release, creating an email address;
associating the email address with the user;
associating the email address with at least one of:
the service;
a primary domain of the service; or
the auth-client application;
releasing the protected data of the user to the service, wherein the released data comprises the email address; and
under control of a mail handling server,
receiving an electronic mail from an external source to the email address; and
validating the electronic mail by performing one or more checks using information extracted from the electronic mail to determine whether or not the electronic mail is allowed for the email address;
wherein the information extracted from at least one of:
envelope part of the electronic mail; or
message part of the electronic mail;
wherein the validating step comprises loading a configuration for the email address using an information associated with the email address;
wherein the configuration comprises one or more domains authorized by an entity of the service to send one or more electronic mail to the email address;
wherein the entity is a human.

2. The method of claim 1, wherein performing one or more checks comprises:
extracting an envelope domain from the electronic mail; and
comparing at least a part of the envelope domain with the primary domain.

3. The method of claim 1, wherein performing one or more checks comprises:
extracting an envelope domain from the electronic mail; and
comparing at least a part of the envelope domain with said one or more domains.

4. The method of claim 1, wherein the validating step requires at least one of the following to allow the electronic mail:
at least a part of an envelope domain of the electronic mail to match the primary domain; or
at least a part of an envelope domain of the electronic mail to match at least one of the envelope domains.

5. The method of claim 1, wherein the validating step requires mandatory pass for Sender Policy Framework (SPF) to allow the electronic mail.

6. The method of claim 1, wherein the validating step requires mandatory pass for Sender Alias Domains (SAD) to allow the electronic mail.

7. The method of claim 1, wherein the identity provider forces said one or more domains to configure SPF record.

8. The method of claim 1, wherein the system of the identity provider performs an SPF record DNS lookup on a domain provided by the service administrator to check whether or not the domain is compatible with mandatory pass requirement.

9. The method of claim 8, wherein the SPF record DNS lookup performed after receiving an electronic mail from the domain to a randomly generated email address.

10. The method of claim 1, wherein the email address can be deleted by the user.

11. The method of claim 1, wherein the email address can be made inactive by the user without deleting the email address.

12. The method of claim 1, wherein the email address is associated with a plurality of auth-client applications.

13. The method of claim 1, wherein the email address accepts one or more email s from a plurality of domains, at least one domain of the plurality of domains is verified by the service administrator.

14. The method of claim 1, wherein the primary domain requires domain verification.

15. The method of claim 1, wherein the auth-client application is associated with the primary domain.

16. The method of claim 1, wherein the released data is a minimal insensitive data.

17. The method of claim 1, wherein the auth-button is displayed adjacent to a button that groups all other authentication methods.

18. The method of claim 1, wherein the auth-button is displayed in a first position.

19. The method of claim 1, wherein the displaying of the auth-button on the service is mandatory when at least one third-party identity provider auth-button is displayed on the service.

20. The method of claim 1, wherein said one or more domains comprises at least one domain not owned by the service.
